(19) United States
(12) Patent Application Publication
(10) Pub. No.: US 2024/0292413 A1
(43) Pub. Date: Aug. 29, 2024

(54) INFORMATION FEEDBACK METHOD AND APPARATUS

(71) Applicant: FUJITSU LIMITED, Kawasaki-shi Kanagawa (JP)

(72) Inventors: Qinyan JIANG, Beijing (CN); Xin WANG, Beijing (CN); Lei ZHANG, Beijing (CN)

(73) Assignee: FUJITSU LIMITED, Kawasaki-shi Kanagawa (JP)

(21) Appl. No.: 18/618,077

(22) Filed: Mar. 27, 2024

Related U.S. Application Data
(63) Continuation of application No. PCT/CN2021/122477, filed on Sep. 30, 2021.

(51) Int. Cl. H04W 72/1273; H04L 1/1812; H04W 72/232; H04W 76/20

(52) U.S. Cl. CPC H04W 72/1273; H04L 1/1812; H04W 72/232; H04W 76/20

(57) ABSTRACT

Embodiments of this disclosure provide an information feedback method and information reception method and apparatuses thereof. The information feedback method includes: receiving, by the terminal equipment, at least one downlink control information (DCI) used for scheduling a physical downlink shared channel (PDSCH), the DCI scheduling one or a plurality of PDSCHs, wherein the one or the plurality of PDSCHs include at least one PDSCH with a corresponding HARQ process that is feedback enabled or feedback disabled; and transmitting HARQ feedback information for the one or the plurality of PDSCHs by the terminal equipment.

### CROSS-REFERENCE TO RELATED APPLICATION

This application is a continuation application of International Application PCT/CN2021/122477 filed on Sep. 30, 2021, and designated the U.S., the entire contents of which are incorporated herein by reference.

### TECHNICAL FIELD

This disclosure relates to the field of communication technologies.

### BACKGROUND

A physical downlink shared channel (PDSCH) is one of physical downlink channels in a wireless communication system, and is used to carry downlink data. The PDSCH may be scheduled via downlink control information (DCI). The DCI used for scheduling the PDSCH at least includes information indicating resources of the PDSCH. In an existing New Radio (NR) system, a plurality of DCI formats for scheduling PDSCHs are defined, such as DCI format 1_0, DCI format 1_1, and DCI format 1_2. Specific information and/or sizes included in DCI in different DCI formats are different, so as to meet different demands for scheduling.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

Currently, a non-terrestrial network (NTN) is a topic being discussed by the International Organization for Standardization 3GPP. In this topic, in order to cope with relatively long propagation latency, how to support this HARQ mechanism of HARQ (hybrid automatic repeat request) feedback enabled/disabled is under discussion. However, there is currently no specific method to support this HARQ mechanism of HARQ (hybrid automatic repeat request) feedback enabled/disabled, nor is there a method for how/whether to transmit HARQ feedback information in some cases while supporting this HARQ mechanism.

In addition, how to expand an NR system to 71 GHz is under discussion in 3GPP. In this topic, in order to alleviate a burden of a terminal equipment for monitoring a physical downlink control channel (PDCCH), a scheduling mode for how to support scheduling a plurality of PDSCHs (i.e. multi-PDSCH scheduling) by one DCI is under discussion. At present, there is no discussion on whether/how to support both the above HARQ mechanism and scheduling mode, nor is there a method for how to supporting the above HARQ mechanism and scheduling mode, let alone a method for how/whether to transmit HARQ feedback information while supporting both the above HARQ mechanism and scheduling mode.

In order to solve at least one of the above problems, embodiments of this disclosure provide an information feedback method and apparatus.

According to an aspect of the embodiments of this disclosure, there is provided an information feedback apparatus, applicable to a terminal equipment, the apparatus including:
a first receiving unit configured to receive at least one downlink control information (DCI) used for scheduling a physical downlink shared channel (PDSCH), the DCI scheduling one or a plurality of PDSCHs, wherein the one or the plurality of PDSCHs comprise at least one PDSCH with a corresponding HARQ process that is feedback enabled or feedback disabled; and
a first transmitting unit configured to transmit HARQ feedback information for the one or the plurality of PDSCHs.

According to another aspect of the embodiments of this disclosure, there is provided an information feedback apparatus, applicable to a terminal equipment, the apparatus including:
a second receiving unit configured to receive fourth downlink control information (DCI), the fourth DCI including counter DAI information and/or total DAI information; and
a first determining unit configured to determine HARQ feedback information according to the counter DAI information and/or the total DAI information.

According to a further aspect of the embodiments of this disclosure, there is provided an information feedback apparatus, applicable to a terminal equipment, the apparatus including:
a fourth receiving unit configured to receive DCI for scheduling PDSCHs;
a third determining unit configured to, according to a time domain position where the last PDSCH scheduled by the DCI with the corresponding HARQ process that is HARQ feedback enabled is located, determine a time domain position of the HARQ feedback information of the PDSCH scheduled by the DCI; and
a second transmitting unit configured to transmit the HARQ feedback information of the PDSCH scheduled by the DCI at the determined time domain position.

An advantage of the embodiments of this disclosure exists in that the HARQ information is transmitted or not transmitted in the case where the HARQ mechanism of the HARQ feedback enabled/disabled is supported. Hence, uplink control signaling overhead may be lowered, and also, the network device may transmit new data without needing to wait for the terminal equipment to report the HARQ feedback information, thereby reducing data transmission latency.

Another advantage of the embodiments of this disclosure exists in that the HARQ information is transmitted or not transmitted in the case where the HARQ mechanism of the HARQ feedback enabled/disabled and the scheduling mode of scheduling a plurality of PDSCHs by one DCI are supported. Hence, not only the number of times of monitoring the PDCCHs by the terminal equipment may be reduced to lower complexity and power consumption of the terminal equipment in monitoring the PDCCHs, but also resource overhead for transmitting the downlink control information (DCI) may be lowered to improve the data throughput. And on the other hand, uplink control signaling overhead may be lowered, and also, the network device may transmit new data without needing to wait for the terminal equipment to report the HARQ feedback information, thereby reducing data transmission latency.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of an embodiment of this disclosure;

FIG. 2 is a schematic diagram of an information feedback method of an embodiment of this disclosure;

FIG. 3 is a schematic diagram of an information feedback method of an embodiment of this disclosure;

FIGS. 4-11 are schematic diagrams of a DAI counter of an embodiment of this disclosure;

FIGS. 12-13 are schematic diagrams of feedback slot positions of an embodiment of this disclosure;

FIG. 14 is a schematic diagram of an information feedback method of an embodiment of this disclosure;

FIGS. 15A-15C are schematic diagrams of a C-TAI and a T-DAI of an embodiment of this disclosure;

FIG. 16 is a schematic diagram of an information feedback method of an embodiment of this disclosure;

FIG. 17 is a schematic diagram of an information reception method of an embodiment of this disclosure;

FIG. 18 is a schematic diagram of an information reception method of an embodiment of this disclosure;

FIGS. 19-22 are schematic diagrams of an information feedback apparatus of an embodiment of this disclosure;

FIGS. 23-25 are schematic diagrams of an information reception apparatus of an embodiment of this disclosure;

FIG. 26 is a schematic diagram of a terminal equipment of an embodiment of this disclosure;

FIG. 27 is a schematic diagram of a network device of an embodiment of this disclosure;

FIGS. 28A-28D are schematic diagrams of a DAI counter of an embodiment of this disclosure;

FIGS. 29A-29C are schematic diagrams of a DAI counter of an embodiment of this disclosure;

FIGS. 30A-30C are schematic diagrams of a DAI counter of an embodiment of this disclosure;

FIGS. 31A-31C are schematic diagrams of a C-TAI and a T-DAI of an embodiment of this disclosure;

FIGS. 32A-32D are schematic diagrams of a C-TAI and a T-DAI of an embodiment of this disclosure;

FIGS. 33A-33B are schematic diagrams of a C-TAI and a T-DAI of an embodiment of this disclosure;

FIGS. 34A-34B are schematic diagrams of a C-TAI and a T-DAI of an embodiment of this disclosure;

FIGS. 35A-35C are schematic diagrams of a C-TAI and a T-DAI of an embodiment of this disclosure; and

FIGS. 36A-36D are schematic diagrams of a PDSCH scheduled by DCI of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and new radio (NR) in the future, etc., and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipment described above. “Device” may refer to a network device, or may refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable. “Receive(d)” and “detect(ed)” denote “successfully received” and are interchangeable, and “receive” and “detect” denote actions that are being executed, but do not denote “whether successfully received”, and they are interchangeable; however, they may denote a result of reception in some cases.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUSCH, transmitting or receiving a PRACH may be understood as transmitting or receiving a preamble carried by the PRACH, transmitting or receiving a PDSCH may be understood as transmitting or receiving downlink data carried by the PDSCH, and transmitting or receiving a PDCCH may be understood as transmitting or receiving downlink information (e.g. DCI) carried by the PDCCH. In the embodiments of this disclosure, higher-layer signaling may be, for example, radio resource control (RRC) signaling; for example, it is referred to an RRC message, which includes a master information block (MIB), system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

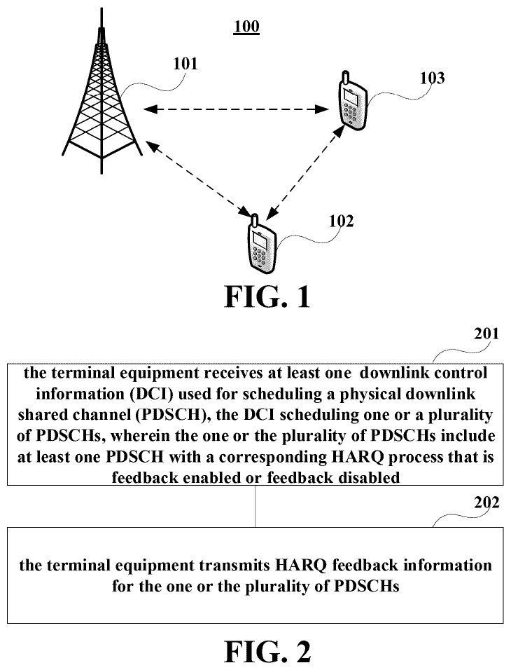

FIG. 1 is a schematic diagram of a communication system of an embodiment of this disclosure, in which a case where terminal equipment and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipment 102, 103. For example, such services may include but not limited to an enhanced mobile broadband (eMBB), massive machine type communication (mMTC), ultra-reliable and low-latency communication (URLLC), and related communications of reduced capability terminal equipment, etc.

It should be noted that FIG. 1 shows that two terminal equipment 102, 103 are both within coverage of the network device 101. However, this disclosure is not limited thereto, and the two terminal equipment 102, 103 may not be within the coverage of the network device 101, or one terminal equipment 102 is within the coverage of the network device 101 and the other terminal equipment 103 is outside the coverage of the network device 101.

In the embodiments of this disclosure, transport blocks carried by different PDSCHs are identical or different. Therefore, “a plurality of PDSCHs” or “at least two PDSCHs” below may refer to different PDSCHs carrying identical or different transport blocks. More specifically, transport blocks carried by different PDSCHs may correspond to identical or different HARQ processes, wherein different HARQ processes have different HARQ process identifiers.

In some embodiments, a PDSCH time domain resource allocation (TDRA) table (or a TDRA table in brief) includes at least one row, which is hereinafter referred to as a PDSCH TDRA configuration (or a TDRA configuration in brief) for ease of description, that is, the PDSCH TDRA table includes at least one PDSCH TDRA configuration. A PDSCH TDRA configuration includes at least one PDSCH time domain resource configuration (or referred to as a time domain resource configuration in brief), which at least includes a symbol position (starting symbol+length) configuration in a slot; in addition, a PDSCH TDRA configuration may further include at least one slot offset K0 configuration, K0 denoting a slot offset between a PDSCH and a PDCCH, and the K0 configuration being included or not included in the PDSCH time domain resource configuration; the PDSCH TDRA configuration may further include other information (such as mapping type), which is included or not included in a PDSCH time domain resource configuration, and the embodiment of this disclosure is not limited thereto. Regarding the symbol position configuration in the slot, it includes, for example, a start and length indicator SLIV, the SLIV corresponding to a valid combination of a starting symbol (S) and a length (L), or, for example, corresponding to a starting symbol configuration and a length configuration, the starting symbol configuration and a length configuration being a valid combination.

Hybrid automatic repeat request (HARQ) is a technique that combines forward error correction (FEC) and automatic repeat request (ARQ) methods. The FEC enables a receiver end to correct some errors by adding redundant information, thereby reducing the number of retransmissions. For errors that the FEC is unable to correct, the receiver end requests a transmitter end via the ARQ mechanism to retransmit data. The receiver end detects whether the received packet is incorrect by using error detection codes, which are usually cyclic redundancy check (CRC). If there is no error, the receiver end transmits acknowledgement (ACK) to the transmitter end. After receiving the ACK, the transmitter end proceeds with transmitting a next packet. If there is an error, the receiver end drops the packet and transmits non-acknowledgement (NACK) to the transmitter end. After receiving the NACK, the transmitter end retransmits the same data.

In NR, it is needed to perform HARQ-ACK feedback on (all or a part of) one or a plurality of PDSCHs scheduled by the DCI. For example, the terminal equipment may generate an HARQ-ACK codebook, which includes a semi-static codebook (type-1 HARQ-ACK codebook) and a dynamic codebook (type-2 HARQ-ACK codebook). And the terminal uses the type-1 HARQ-ACK codebook or the type-2 HARQ-ACK codebook according to RRC signaling configuration.

How to generate or whether to generate or how to transmit the above semi-static codebook and/or the dynamic codebook in a case where that HARQ feedback disabled or enabled is configured or indicated to an HARQ process is supported with reference to the embodiments.

### Embodiment of a First Aspect

The embodiment of this disclosure provides an information feedback method, which shall be described from a side of a terminal equipment.

FIG. 2 is a schematic diagram of the information feedback method of the embodiment of this disclosure. As shown in FIG. 2, the method includes:
201: the terminal equipment receives at least one downlink control information (DCI) used for scheduling a physical downlink shared channel (PDSCH), the DCI scheduling one or a plurality of PDSCHs, wherein the one or the plurality of PDSCHs include at least one PDSCH with a corresponding HARQ process that is feedback enabled or feedback disabled; and
202: the terminal equipment transmits HARQ feedback information for the one or the plurality of PDSCHs.

In some embodiments, the terminal equipment receives the downlink control information (DCI) scheduling one or a plurality of PDSCHs. The DCI may (is able to) schedule a plurality of PDSCHs, but may practically schedule one or a plurality of PDSCHs. Additionally, in the embodiment of this disclosure, a plurality of PDSCHs may be PDSCHs scheduled in the time domain or may be PDSCHs scheduled in the frequency domain, or may be PDSCHs scheduled in the time domain and the frequency domain. For example, when a plurality of PDSCHs are scheduled in the time domain, the PDSCH time domain resource allocation table applied by the DCI supports one DCI scheduling a plurality of PDSCHs; however, the embodiment of this disclosure is not limited thereto.

In some embodiments, in 201, the DCI and the PDSCH are transmitted on identical carriers (cells) or different carriers (cells), that is, the PDSCH may be scheduled by DCI on the same carrier (cell) or by DCI on different carriers (cells). In a case where the DCI and the PDSCH are on different carriers (cells), the PDSCH is scheduled according to configuration to which carriers (cells) being scheduled correspond (e.g. number of HARQ processes, HARQ feedback enable/disable configuration, and PDSCH time domain resource allocation table configuration, etc.).

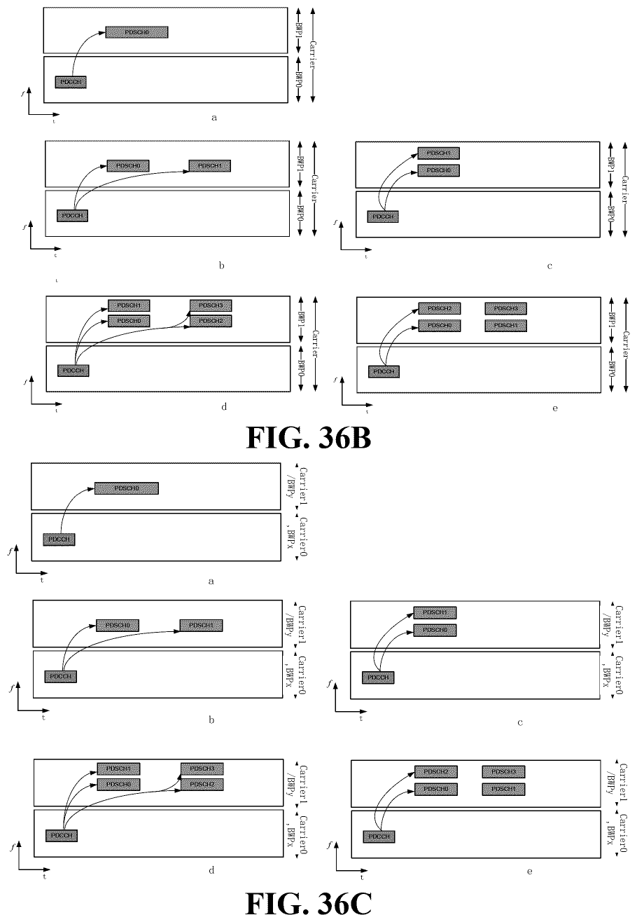

FIG. 36A is a schematic diagram of the DCI and the scheduled PDSCH on the same BWP of the same carrier/cell. As shown in FIG. 14, a) corresponds to scheduling one PDSCH (without limiting whether the DCI is able to schedule only one PDSCH or a plurality of PDSCHs); b) corresponds to scheduling a plurality of PDSCHs in the time domain, and the PDSCHs are indexed in an order of time domain; c) corresponds to scheduling a plurality of PDSCHs in the frequency domain, and the PDSCHs are indexed in an order of frequency domain; d) corresponds to scheduling a plurality of PDSCHs in the time domain and the frequency domain, and the PDSCHs are indexed in an order of frequency domain first and then time domain, and e) corresponds to scheduling a plurality of PDSCHs in the time domain and the frequency domain, and the PDSCHs are indexed in an order of time domain first and then frequency domain.

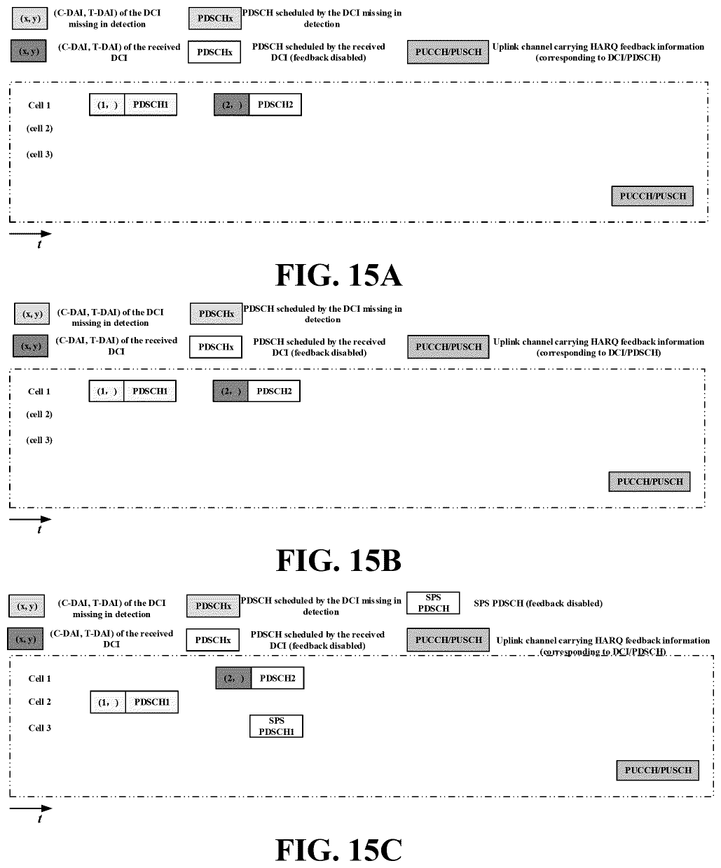

FIG. 36B is a schematic diagram of the DCI and the scheduled PDSCH on different BWPs of the same carrier/cell. As shown in FIG. 15, a) corresponds to scheduling one PDSCH (without limiting whether the DCI is able to schedule only one PDSCH or a plurality of PDSCHs); b) corresponds to scheduling a plurality of PDSCHs in the time domain, and the PDSCHs are indexed in an order of time domains c) corresponds to scheduling a plurality of PDSCHs in the frequency domain, and the PDSCHs are indexed in an order of frequency domain; d) corresponds to scheduling a plurality of PDSCHs in the time domain and the frequency domain, and the PDSCHs are indexed in an order of frequency domain first and then time domain; and e) corresponds to scheduling a plurality of PDSCHs in the time domain and the frequency domain, and the PDSCHs are indexed in an order of time domain first and then frequency domain.

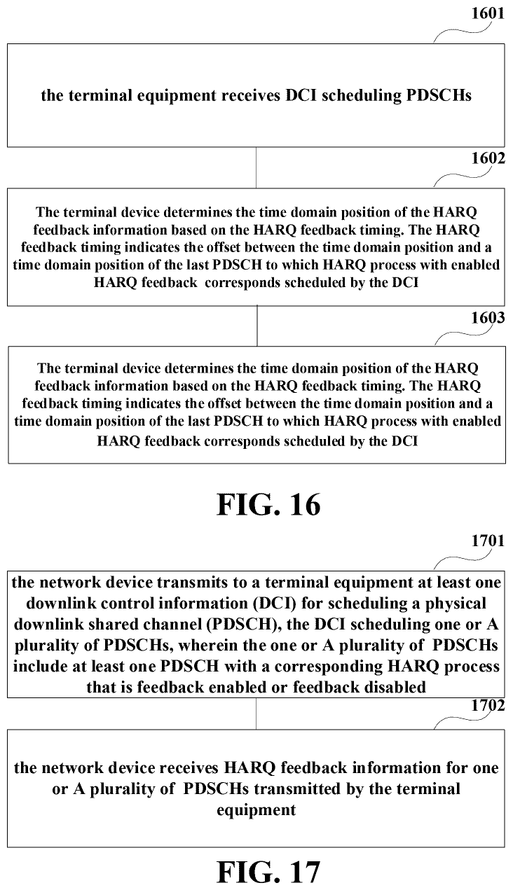

FIG. 36C is a schematic diagram of the DCI and the scheduled PDSCH on different carriers/cells (cross-carrier scheduling). As shown in FIG. 16, a) corresponds to scheduling one PDSCH (without limiting whether the DCI is able to schedule only one PDSCH or a plurality of PDSCHs); b) corresponds to scheduling a plurality of PDSCHs in the time domain, and the PDSCHs are indexed in an order of time domain; c) corresponds to scheduling a plurality of PDSCHs in the frequency domain, and the PDSCHs are indexed in an order of frequency domain; d) corresponds to scheduling a plurality of PDSCHs in the time domain and the frequency domain, and the PDSCHs are indexed in an order of frequency domain first and then time domain; and e) corresponds to scheduling a plurality of PDSCHs in the time domain and the frequency domain, and the PDSCHs are indexed in an order of time domain first and then frequency domain.

FIG. 36D is a schematic diagram of scheduling a plurality of PDSCHs by the DCI. As shown in FIG. 17, a) corresponds to scheduling two PDSCHs with different time domain, the two PDSCHs are on different BWPs of different carriers/cells, only one PDSCH is scheduled on the same BWP of the same carrier/cell, and the PDSCHs are indexed in an order of time domain; b) corresponds to scheduling two PDSCHs with different frequency domain, the two PDSCHs are on different BWPs of different carriers/cells, only one PDSCH is scheduled on the same BWP of the same carrier/cell, and the PDSCHs are indexed in an order of frequency domain; c) corresponds to scheduling four PDSCHs, wherein two PDSCHs are respectively scheduled on different BWPs of different carriers/cells, two PDSCHs are scheduled on the same BWP of the same carrier/cell, and the PDSCHs are indexed in an order of frequency domain first and then time domain; and d) corresponds to scheduling four PDSCHs, wherein two PDSCHs are respectively scheduled on different BWPs of different carriers/cells, two PDSCHs are scheduled on the same BWP of the same carrier/cell, and the PDSCHs are indexed in an order of time domain first and then frequency domain. Following description shall be given by taking how the DCI may schedule a plurality of PDSCHs in the time domain as an example.

Following description shall be given by taking that the DCI may schedule a plurality of PDSCHs in the time domain as an example.

In some embodiments, in order to support that the DCI may schedule a plurality of PDSCHs in the time domain, the PDSCH time domain resource allocation table applied by the DCI supports one DCI scheduling a plurality of PDSCHs. For the convenience of explanation, the PDSCH time domain resource allocation configuration shall be further described below first.

In some embodiments, the PDSCH TDRA table for supporting one DCI scheduling a plurality of PDSCHs includes at least one PDSCH TDRA configuration for supporting one DCI scheduling a plurality of PDSCHs. Meanwhile, the table may include or may not include a PDSCH TDRA configuration for supporting one DCI scheduling one PDSCH. For example, the PDSCH TDRA table includes at least one (M) PDSCH TDRA configuration (at least one row), and in the M PDSCH TDRA configurations, there is at least one (P) PDSCH TDRA configuration that supports one DCI scheduling a plurality of PDSCHs, including M-P PDSCH TDRA configurations that support one DCI scheduling one PDSCH; where, M is greater than or equal to P, and both M and P are integers greater than or equal to 1.

In some embodiments, the PDSCH TDRA configuration used to support one DCI scheduling a plurality of PDSCHs includes at least two PDSCH time domain resource configurations (e.g. at least two SLIVs, each of which corresponding to a PDSCH).

In some embodiments, the PDSCH TDRA configuration used to support one DCI scheduling one PDSCH includes only one PDSCH time domain resource configuration.

In some embodiments, the method may further include (not shown): the terminal equipment determines PDSCH time domain resource allocation table applied by DCI according to a first list, so as to determine the first allocation table, a column of the first list corresponding to the first indication information (e.g. pdsch-TimeDomainAllocationListForMultiPDSCH) used to configure the PDSCH TDRA table supporting one DCI scheduling a plurality of PDSCHs. The first indication information is included, for example, in PDSCH-Config. That is, the terminal equipment determines the PDSCH time domain resource allocation (TDRA) table applied by the DCI according to the first list from the PDSCH time domain resource allocation (TDRA) tables that are predefined or configured by higher-layer signaling.

For example, the first list is used to determine a PDSCH time domain resource allocation table applied by DCI of DCI format 1_1 or DCI format 1_2, and is not used to determine a PDSCH time domain resource allocation table applied by DCI of DCI format 1_0; for example, the DCI of DCI format 1_0 may use a second list to determine a PDSCH TDRA table applied by the DCI, contents included in the second list being, for example, identical to those tables for DCI formats 1_0 and 1_1(applicable PDSCH time domain resource allocation for DCI formats 1_0 and 1_1). That is, the PDSCH TDRA tables applied by the DCI of DCI format 1_0 and DCI format 1_1 are determined based on different lists.

For example, one of differences between the first list and the second list is that the first list further includes a column corresponding to the first indication information (e.g. pdsch-Time DomainAllocationListForMultiPDSCH) used to configure the PDSCH TDRA table for supporting one DCI scheduling a plurality of PDSCHs, while the second list does not include a column of the first indication information used to configure the PDSCH TDRA table for supporting one DCI scheduling a plurality of PDSCHs. In other words, in determining the PDSCH TDRA table applied by the DCI, the second list does not take the first indication information used to configure the PDSCH TDRA table for supporting one DCI scheduling a plurality of PDSCHs into account. Hence, it is impossibly that the PDSCH time domain resource allocation table applied by the DCI determined based on the second list is a PDSCH TDRA table for supporting one DCI scheduling a plurality of PDSCHs, and the PDSCH time domain resource allocation table applied by the DCI determined based on the first list may be a PDSCH TDRA table for supporting one DCI scheduling a plurality of PDSCHs.

In some embodiments, the format of the DCI is DCI format 1_1 or DCI format 1_2, and the PDSCH TDRA table applied by the DCI is unrelated to a radio network temporary identifier (RNTI) scrambling cyclic redundancy check (CRC) of the DCI. For example, when the RNTI is a cell radio network temporary identifier (C-RNTI), or a coding modulation scheme C-RNTI (MCS-C-RNTI), or a configuration scheduling RNTI (CS-RNTI), PDSCH TDRA tables applied by the DCI are identical. Table 1 below is an example table of the first list, wherein a column PDSCH-ConfigCommon includes pdsch-TimeDomainAllocationList, and PDSCH-Config includes pdsch-TimeDomainAllocationList, which corresponds respectively to the second indication information (i.e. pdsch-TimeDomainAllocationList in PDSCH-ConfigCommon and pdsch-TimeDomainAllocationList in PDSCH-Config) used to configure cell-specific and UE-specific PDSCH TDRA tables for only supporting one DCI scheduling one PDSCH, and reference may be made to existing techniques for specific meanings thereof, which shall not be repeated herein any further. According to Table 1, for transmitting DCI in a common search space that is not associated with CORESET 0 (or in other words, a common search space of its associated CORESET is not a common search space of CORESET 0) or a UE-dedicated search space, in the case where the PDSCH TDRA table for supporting one DCI scheduling a plurality of PDSCHs is configured (i.e. in the case where the first indication information (pdsch-TimeDomainAllocationListForMultiPDSCH) for configuring the PDSCH TDRA table PDSCH is included in PDSCH-Config, the DCI applies the PDSCH TDRA table for supporting one DCI scheduling a plurality of PDSCHs in scrambling by using the C-RNTI, or the MCS-C-RNTI, or the CS-RNTI.

TABLE 1

| | | SS/PBCH | | |
|---|---|---|---|---|
| | | block and | | |
| | PDCCH | CORESET | PDSCH-ConfigCommon | PDSCH-Config |
| | search | multiplexing | includes pdsch- | includes pdsch- |
| RNTI | space | pattern | TimeDomainAllocationList | TimeDomainAllocationList |
| C-RNTI, | Common | 1, 2, 3 | No | — |
| MCS-C- | search space | 1, 2, 3 | Yes | — |
| RNTI, | associated | | | |
| CS-RNTI | with | | | |
| | CORESET 0 | | | |
| C-RNTI, | Common | 1, 2, 3 | No | No |
| MCS-C- | search space | 1, 2, 3 | Yes | No |
| RNTI, | that is not | 1, 2, 3 | No/Yes | Yes |
| CS-RNTI | associated | 1, 2, 3 | No/Yes | No/Yes |
| | CORESET 0 | | | |
| | UE-dedicated | | | |
| | search space | | | |

| | PDSCH-Config includes | PDSCH time domain |
|---|---|---|
| | pdsch-TimeDomainAllocation- | resource allocation |
| RNTI | ListForMultiPDSCH | to apply |
| C-RNTI, | — | Default A |
| MCS-C- | — | pdsch-TimeDomainAllocationList |
| RNTI, | | provided in PDSCH-ConfigCommon |
| CS-RNTI | | |
| C-RNTI, | No | Default A |
| MCS-C- | No | pdsch-TimeDomainAllocationList |
| RNTI, | | provided in PDSCH-ConfigCommon |
| CS-RNTI | No | pdsch-TimeDomainAllocationList |
| | | provided in PDSCH-Config |
| | Yes | pdsch- |
| | | TimeDomainAllocationListForMultiPDSCH |
| | | provided in PDSCH-Config |

In some embodiments, the format of the DCI is DCI format 1_1 or DCI format 1_2, and the PDSCH time domain resource allocation tables applied by the DCI are different when different RNTIs are used for scrambling. For example, the PDSCH time domain resource allocation table applied when the CS-RNTI is used for scrambling is different from the PDSCH time domain resource allocation table applied when non-CS-RNTI (C-RNTI or MCS-C-RNTI) is used for scrambling.

For example, in a case of the DCI is scrambled by a non-CS-RNTI (C-RNTI or MCS-C-RNTI), the PDSCH time domain resource allocation table applied by the DCI is a PDSCH time domain resource allocation table used to support one DCI scheduling a plurality of PDSCHs; and when the DCI is scrambled by the CS-RNTI, the PDSCH time domain resource allocation table applied by the DCI is not a PDSCH time domain resource allocation table used to support one DCI scheduling a plurality of PDSCHs, in other words, when the DCI is scrambled by the CS-RNTI, the PDSCH time domain resource allocation table applied by the DCI is a PDSCH time domain resource allocation table only supporting one DCI scheduling one PDSCH.

Or, in other words, when the DCI is scrambled by the CS-RNTI, the PDSCH time domain resource allocation table applied by the DCI is not the PDSCH time domain resource allocation table configured by the first indication information; and when the DCI is scrambled by a non-CS-RNTI (C-RNTI or MCS-C-RNTI), the PDSCH time domain resource allocation table applied by the DCI is the PDSCH time domain resource allocation table configured by the first indication information. As the DCI used for SPS activation must be scrambled by a CS-RNTI, even if the first indication information configures a PDSCH TDRA table supporting one DCI scheduling a plurality of PDSCHs, it is unable to be used for SPS activation.

Tables 2-1 and 2-2 below are example lists of the first column. A difference from Table 1 is that the PDSCH time domain resource allocation table applied in scrambling by using the CS-RNTI is different from the PDSCH time domain resource allocation table applied in scrambling by using a non-CS-RNTI (C-RNTI or MCS-C-RNTI). Additionally, in Table 2-1, the first indication information configures the PDSCH TDRA table supporting only one DCI scheduling one PDSCH and the PDSCH TDRA table supporting one DCI scheduling a plurality of PDSCHs simultaneously, and even if the first indication information configures the PDSCH TDRA table supporting one DCI scheduling a plurality of PDSCHs, the DCI with an RNTI that is a CS-RNTI may apply the PDSCH TDRA table supporting only one DCI scheduling one PDSCH; and in Table 2-2, the first indication information configures the PDSCH TDRA tables not needing to simultaneously support only one DCI scheduling one PDSCH and support one DCI scheduling a plurality of PDSCHs, and when the first indication information configures the PDSCH TDRA table supporting one DCI scheduling a plurality of PDSCHs but does not configure the PDSCH TDRA table only supporting one DCI scheduling one PDSCH, the DCI format 1_1 with an RNTI that is a CS-RNTI may apply a predefined PDSCH TDRA table.

TABLE 2-1

| | | SS/PBCH | | |
|---|---|---|---|---|
| | | block and | | |
| | PDCCH | CORESET | PDSCH-ConfigCommon | PDSCH-Config |
| | search | multiplexing | includes pdsch- | includes pdsch- |
| RNTI | space | pattern | TimeDomainAllocationList | TimeDomainAllocationList |
| C-RNTI, | Common | 1, 2, 3 | No | — |
| MCS-C- | search space | 1, 2, 3 | Yes | — |
| RNTI, | associated | | | |
| CS-RNTI | with | | | |
| | CORESET 0 | | | |
| C-RNTI, | Common | 1, 2, 3 | No | No |
| MCS-C- | search space | 1, 2, 3 | Yes | No |
| RNTI | that is not | 1, 2, 3 | No/Yes | Yes |
| | associated | 1, 2, 3 | No/Yes | Yes |
| | CORESET 0 | 1, 2, 3 | Yes | No |
| | UE-dedicated | | | |
| | search space | | | |
| CS-RNTI | Common | 1, 2, 3 | No | No |
| | search space | 1, 2, 3 | Yes | No |
| | that is not | 1, 2, 3 | No/Yes | Yes |
| | associated | | | |
| | CORESET 0 | | | |
| | UE-dedicated | | | |
| | search space | | | |

| | PDSCH-Config includes | PDSCH time domain |
|---|---|---|
| | pdsch-TimeDomainAllocation- | resource allocation |
| RNTI | ListForMultiPDSCH | to apply |
| C-RNTI, | — | Default A |
| MCS-C- | — | pdsch-TimeDomainAllocationList |
| RNTI, | | provided in PDSCH-ConfigCommon |
| CS-RNTI | | |
| C-RNTI, | No | Default A |
| MCS-C- | No | pdsch-TimeDomainAllocationList |
| RNTI | | provided in PDSCH-ConfigCommon |
| | No | pdsch-TimeDomainAllocationList |
| | | provided in PDSCH-Config |
| | Yes | pdsch- |
| | | TimeDomainAllocationListForMultiPDSCH |
| | | provided in PDSCH-Config |
| | Yes | pdsch- |
| | | TimeDomainAllocationListForMultiPDSCH |
| | | provided in PDSCH-Config |
| CS-RNTI | No | Default A |
| | No/Yes | pdsch-TimeDomainAllocationList |
| | | provided in PDSCH-ConfigCommon |
| | No/Yes | pdsch-TimeDomainAllocationList |
| | | provided in PDSCH-Config |

TABLE 2-2

| | | SS/PBCH | | |
|---|---|---|---|---|
| | | block and | | |
| | PDCCH | CORESET | PDSCH-ConfigCommon | PDSCH-Config |
| | search | multiplexing | includes pdsch- | includes pdsch- |
| RNTI | space | pattern | TimeDomainAllocationList | TimeDomainAllocationList |
| C-RNTI, | Common | 1, 2, 3 | No | — |
| MCS-C- | search space | 1, 2, 3 | Yes | — |
| RNTI, | associated | | | |
| CS-RNTI | with | | | |
| | CORESET 0 | | | |
| C-RNTI, | Common | 1, 2, 3 | No | No |
| MCS-C- | search space | 1, 2, 3 | Yes | No |
| RNTI | that is not | 1, 2, 3 | No/Yes | Yes |
| | associated | 1, 2, 3 | No/Yes | No/Yes |
| | CORESET 0 | | | |
| | UE-dedicated | | | |
| | search space | | | |
| CS-RNTI | Common | 1, 2, 3 | No | No |
| | search space | 1, 2, 3 | Yes | No |
| | that is not | 1, 2, 3 | No/Yes | Yes |
| | associated | 1, 2, 3 | No | No |
| | CORESET 0 | | | |
| | UE-dedicated | | | |
| | search space | | | |

| | PDSCH-Config includes | PDSCH time domain |
|---|---|---|
| | pdsch-TimeDomainAllocation- | resource allocation |
| RNTI | ListForMultiPDSCH | to apply |
| C-RNTI, | — | Default A |
| MCS-C- | — | pdsch-TimeDomainAllocationList |
| RNTI, | | provided in PDSCH-ConfigCommon |
| CS-RNTI | | |
| C-RNTI, | No | Default A |
| MCS-C- | No | pdsch-TimeDomainAllocationList |
| RNTI | | provided in PDSCH-ConfigCommon |
| | No | pdsch-TimeDomainAllocationList |
| | | provided in PDSCH-Config |
| | Yes | pdsch- |
| | | TimeDomainAllocationListForMultiPDSCH |
| | | provided in PDSCH-Config |
| CS-RNTI | No | Default A |
| | No/Yes | pdsch-TimeDomainAllocationList |
| | | provided in PDSCH-ConfigCommon |
| | No/Yes | pdsch-TimeDomainAllocationList |
| | | provided in PDSCH-Config |
| | Yes | Default A |

In some embodiments, the format of the DCI is DCI format 1_1 or DCI format 1_2, and the PDSCH time domain resource allocation table applied by the DCI in SPS activation and/or SPS retransmission (CRC of the DCI is scrambled by the CS-RNTI) is different from the PDSCH time domain resource allocation table applied in non-SPS activation and/or non-SPS retransmission (the CRC of the DCI is not scrambled by the CS-RNTI).

For example, when the DCI is used for SPS activation and/or SPS retransmission, the PDSCH time domain resource allocation table applied by the DCI is not used to support one DCI scheduling a plurality of PDSCHs. In other words, when the DCI is used for SPS activation and/or SPS retransmission, the PDSCH time domain resource allocation table applied by the DCI is a PDSCH TDRA table supporting only one DCI scheduling one PDSCH; and when the DCI is used for non-SPS activation and/or non-SPS retransmission, the PDSCH time domain resource allocation table applied by the DCI is used to support one DCI scheduling a plurality of PDSCHs.

Or, in other words, when the DCI is used for SPS activation and/or SPS retransmission, the PDSCH time domain resource allocation table applied by the DCI is not the PDSCH time domain resource allocation table configured by the first indication information; and when the DCI is used for non-SPS activation and/or non-SPS retransmission, the PDSCH time domain resource allocation table applied by the DCI is the PDSCH time domain resource allocation table configured by the first RRC signaling.

As described above, in Tables 1, 2-1 and 2-2, the first indication information configures the PDSCH TDRA table for supporting one DCI scheduling a plurality of PDSCHs, that is, a value of pdsch-TimeDomainAllocationListForMultiPDSCH is YES, and the first indication information configures the PDSCH TDRA table for not supporting one DCI scheduling a plurality of PDSCHs, that is, a value of pdsch-TimeDomainAllocationListForMultiPDSCH is NO.

In some embodiments, the first list is used to determine the PDSCH TDRA table applied by the DCI with a format of DCI format 1_1, and may also be used to determine the PDSCH TDRA table applied by the DCI with a format of DCI format 1_0; for example, the first table obtained by combining the third list by taken the table in the previous example as and an existing second table, and also, it is used to determine the PDSCH TDRA tables applied by the DCI with formats of DCI format 1_1 and DCI format 1_0.

In some embodiments, the DCI includes a second information field, wherein the may second information field be a time domain resource assignment domain, and the first information field indicates the PDSCH time domain resource by indicating an index (a row index, e.g. a value of the row index is greater than or equal to 1) to which the PDSCH TDRA configuration in the PDSCH TDRA table applied by the DCI corresponds. In other words, the DCI schedules the PDSCHs by indicating the PDSCH TDRA configuration in the PDSCH TDRA table it applies.

For example, a value m of the second information field of the DCI (assuming that m is an integer greater than or equal to 0) correspondingly indicates a PDSCH TDRA configuration with an index m+1 (i.e. an (m+1)-th row) in the PDSCH TDRA table applied by the DCI. In a case where the PDSCH TDRA table is configured by the first indication information, for example, the value of the index to which an (m+1)-th PDSCH TDRA configuration configured by the first indication information corresponds is m+1, that is, when the value of the second information field is m, it corresponds to an (m+1)-th PDSCH TDRA configuration configured by the first RRC signaling.

In some embodiments, in 201, when the PDSCH TDRA configuration(including a plurality of PDSCH time domain resource configurations) indicated by the DCI (such as the second information field in the DCI) is used for supporting one DCI scheduling a plurality of PDSCHs, the UE may determine the plurality of scheduled PDSCH time domain resources according to the PDSCH time domain resource configurations included in the PDSCH TDRA configuration respectively corresponding to a plurality of PDSCHs.

In some embodiments, the DCI may further include a third information field, the third information field being used to indicate an HARQ process identifier. Different scheduled PDSCHs correspond to identical or different HARQ processes, and the terminal equipment may determine the HARQ process indicated by the DCI and the HARQ processes of the scheduled PDSCHs according to the DCI.

In some embodiments, the third information field is, for example, ‘an HARQ process number’.

In some embodiments, the DCI explicitly and/or implicitly indicates the HARQ process. For example, the DCI indicates the HARQ process (explicitly) by using the first information field, and/or (explicitly) by multiplexing other information fields, and/or (implicitly) via a time domain resource and/or a frequency domain resource used for transmitting the DCI.

In some embodiments, the terminal equipment may further receive indication information related to HARQ-ACK feedback enabling and/or disabling, wherein the indication information may be carried (indicated or configured) by higher layer signaling and/or physical layer signaling, the higher layer signaling including radio resource control (RRC) signaling and/or media access control control element (MAC CE), etc., and the physical layer signaling being different from the DCI in operation 201 or the DCI in operation 202. The indication information includes a bitmap and/or first HARQ process indication information and/or second HARQ process indication information and/or enabling/disabling indication information, that is, the information in the above indication information may be carried by one above signaling or by the different above signaling respectively, and the embodiment of this disclosure is not limited thereto.

In some embodiments, the indication information is for one or more cells. In a case of a plurality of cells, HARQ feedback enabling and/or disabling configurations of different cells are identical or different. For example, when a plurality of cells (CA/DC) are configured, the indication information indicates HARQ feedback enabling and/or disabling for different cells.

In some embodiments, the indication information may include a bitmap, wherein each bit of the bitmap corresponds to one (or one group of) configured or pre-configured HARQ process(es), and a value of each bit indicates that a corresponding HARQ process (group) is enabled or disabled, that is, the bitmap corresponds to the HARQ process (group) in a one-to-one manner. For example, when a value of a bit of the bitmap is 0, the HARQ process (group) is a feedback disabled HARQ process (group)(hereinafter referred to as a first HARQ process), and when a value of a bit of the bitmap is 1, the HARQ process (group) is a feedback enabled HARQ process (group), and vice versa.

For example, the HARQ processes (groups) to which the bitmap corresponds may be all HARQ processes (groups) that are predefined or pre-configured or configured via signaling, or may be a part of all HARQ processes (groups) that are predefined or pre-configured or configured via signaling, and the part HARQ processes (groups) may be predefined, or may be indicated by first HARQ process indication information included in the indication information. The first HARQ process indication information will be explained later. When all the HARQ processes (groups) are configured via signaling, the method may further include (not shown): the terminal equipment receives HARQ process (group) configuration information, the HARQ process (group) configuration information being used for configuring all the HARQ processes (groups).

In some embodiments, the indication information may include second HARQ process indication information, an HARQ process (group) indicated by the second HARQ process indication information being HARQ feedback enabled or HARQ feedback disabled. A correspondence between the second HARQ process indication information and the HARQ process (group) indicated thereby is predefined. For example, the second HARQ process indication information may be an index and/or a start and length indicator value (index/SLIV), and the HARQ process (group) to which the index/SLIV corresponds is HARQ feedback enabled, and other HARQ processes (groups) that do not correspond to the index/SLIV are HARQ feedback disabled; or, the HARQ process (group) to which the index/SLIV corresponds is HARQ feedback disabled, and other HARQ processes (groups) that do not correspond to the index/SLIV are HARQ feedback enabled. Or, the second HARQ process indication information may indicate jointly with enabling/disabling indication information, the enabling/disabling indication information being used to indicate whether the HARQ process indicated by the second HARQ process indication information is HARQ feedback enabled or HARQ feedback disabled. The enabling/disabling indication information may be included in the indication information, or may be included in the DCI in operation 201, and the embodiment of this disclosure is not limited thereto. For example, when the enabling/disabling indication information indicates being enabled, the HARQ process indicated by the second HARQ process indication information is HARQ feedback enabled, and when the enabling/disabling indication information indicates being disabled, the HARQ process indicated by the second HARQ process indication information is HARQ feedback disabled. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further. For example, the HARQ processes (groups) having the correspondence with the second HARQ process indication information may be all HARQ processes (groups) that are predefined or pre-configured or configured via signaling, or may be a part of all HARQ processes (groups) that are predefined or pre-configured or configured via signaling, and part of the HARQ processes (groups) may be predefined, or may be indicated by first HARQ process indication information included in the indication information. The first HARQ process indication information will be explained later. The remain HARQ processes (groups) having no correspondence with the second HARQ process indication information may be predefined by default or may be preconfigured as HARQ feedback enabled or HARQ feedback disabled. When all the HARQ processes (groups) are configured via signaling, the method may further include (not shown): the terminal equipment receives HARQ process (group) configuration information, the HARQ process (group) configuration information being used for configuring all the HARQ processes (groups).

In some embodiments, the indication information may include first HARQ process indication information, an HARQ process (group) indicated by the first HARQ process indication information being HARQ-ACK feedback enabled, or HARQ-ACK feedback disabled.

For example, the first HARQ process indication information may be an HARQ process identifier (ID). The HARQ process identifier is a maximum value X of an identifier of an HARQ process that is HARQ feedback enabled or HARQ feedback disabled, that is, all HARQ processes with HARQ process identifiers in a range of 0˜X are HARQ processes that are HARQ feedback enabled or HARQ feedback disabled; or, the HARQ process identifier is a minimum value Y of an identifier of an HARQ process that is HARQ feedback enabled or HARQ feedback disabled, that is, all HARQ processes with HARQ process identifiers in a range of Y˜Z−1 are HARQ processes that are HARQ feedback enabled or HARQ feedback disabled. Z may be the number of HARQ processes that are pre-configured or predefined or configured via signaling; however, the embodiment of this disclosure is not limited thereto; or, the first HARQ process indication information may indicate jointly with enabling/disabling indication information, the enabling/disabling indication information being used to indicate whether the HARQ process (for example, with an ID in the range of 0˜X or Y˜Z−1) indicated by the first HARQ process indication information is HARQ feedback enabled or HARQ feedback disabled. The enabling/disabling indication information may be included in the indication information or in the DCI in operation 201, and the embodiment of this disclosure is not limited thereto. For example, when the enabling/disabling indication information indicates being enabled, the HARQ process corresponding to the HARQ process identifier (for example, with an ID in the range of 0˜X or Y˜Z−1) indicated by the first HARQ process indication information is HARQ feedback enabled, and when the enabling/disabling indication information indicates being disabled, the HARQ process corresponding to the HARQ process identifier (for example, with an ID in the range of 0˜X or Y˜Z−1) indicated by the first HARQ process indication information is HARQ feedback disabled. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

For example, the first HARQ process indication information may be an HARQ process identifier (ID), which indicates jointly with the above bitmap or second HARQ process indication information. For example, the first HARQ process indication information may indicate the above part of the HARQ processes, such as indicating the maximum value X or minimum value of the identifiers of the part of the HARQ processes. After determining the part of the HARQ processes according to the first HARQ process indication information, whether each HARQ process of the part of the HARQ processes is HARQ feedback enabled or HARQ feedback disabled according to the bits of the bitmap, or, after determining the HARQ process having the correspondence with the second HARQ process indication information according to the first HARQ process indication information, whether the HARQ process having the correspondence is HARQ feedback disabled or HARQ feedback enabled is determined; or, the first HARQ process indication information may indicate jointly with the above second HARQ process indication information and the enabling/disabling indication information. After determining the HARQ process having the correspondence with the second HARQ process indication information according to the first HARQ process indication information, whether the HARQ process having the correspondence is HARQ feedback disabled or HARQ feedback enabled is determined according to the enabling/disabling indication information. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

For example, the first HARQ process indication information may be a group of HARQ process IDs, and HARQ processes to which a group of HARQ process IDs indicated by the first HARQ process indication information correspond are all HARQ feedback enabled or HARQ feedback disabled. Other HARQ processes that do not correspond to this group of HARQ process IDs are HARQ feedback enabled, or HARQ feedback disabled by default.

For example, the first HARQ process indication information may be a group of HARQ process IDs, and the first HARQ process indication information may indicate jointly with the enabling/disabling indication information. The enabling/disabling indication information is used to indicate whether HARQ processes to which the group of HARQ process IDs indicated by the first HARQ process indication information correspond are HARQ feedback enabled or HARQ feedback disabled. The enabling/disabling indication information may be included in the indication information or in the DCI in operation 201, and the embodiment of this disclosure is not limited thereto. For example, when the enabling/disabling indication indicates being enabled, the HARQ processes to which the group of HARQ process IDs indicated by the first HARQ process indication information correspond are all HARQ feedback enabled, and when the enabling/disabling indication indicates being disabled, the HARQ processes to which a group of HARQ process IDs indicated by the second HARQ process indication information correspond are all HARQ feedback disabled. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

For example, the first HARQ process indication information also indicate jointly with the above second HARQ process indication information and enabling/disabling indication information. For example, the first HARQ process indication information may indicate the HARQ process having the correspondence with the above second HARQ process indication information. After determining the HARQ process having the correspondence with the second HARQ process indication information (corresponding to a group of HARQ process identifiers) according to the first HARQ process indication information, whether the HARQ process having the correspondence is HARQ feedback disabled or HARQ feedback enabled according to the enabling/disabling indication information. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

In the above contents, the HARQ process corresponding to an HARQ process ID refers to that an identifier of the HARQ process is the HARQ process ID.

For example, the first HARQ process indication information may be a second offset value offset, which may be an offset value of the HARQ process identifier. For example, the HARQ process identifier to which the second offset value corresponds is a maximum value X of an identifier an HARQ process that is HARQ feedback enabled or HARQ feedback disabled. That is, all HARQ processes with HARQ process identifiers in a range of 0˜X are HARQ processes that are HARQ feedback enabled or HARQ feedback disabled; or, the HARQ process identifier to which the second offset value corresponds is a minimum value Y of an identifier of an HARQ process that is HARQ feedback enabled or HARQ feedback disabled, that is, all HARQ processes with HARQ process identifiers to which the second offset value corresponds in a range of Y˜Z−1 are HARQ processes that are HARQ feedback enabled or HARQ feedback disabled. Z may be the number of HARQ processes that are pre-configured or predefined or configured via signaling; however, the embodiment of this disclosure is not limited thereto; or, the first HARQ process indication information may indicate together with the enabling/disabling indication information, the enabling/disabling indication information being used to indicate whether the HARQ process (for example, with an ID in the range of 0˜X or Y˜Z−1) to which the second offset value corresponds indicated by the first HARQ process indication information is HARQ feedback enabled or HARQ feedback disabled. The enabling/disabling indication information may be included in the indication information or in the DCI in operation 201, and the embodiment of this disclosure is not limited thereto. For example, when the enabling/disabling indication information indicates being enabled, the HARQ process corresponding to the HARQ process identifier (for example, with an ID in the range of 0˜X or Y˜Z−1) to which the second offset value corresponds indicated by the first HARQ process indication information is HARQ feedback enabled, and when the enabling/disabling indication information indicates being disabled, the HARQ process corresponding to the HARQ process identifier (for example, with an ID in the range of 0˜X or Y˜Z−1) to which the second offset value corresponds indicated by the first HARQ process indication information is HARQ feedback disabled. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

For example, the first HARQ process indication information may be a second offset value offset, and the first HARQ process indication information indicates together with the above bitmap or second HARQ process indication information. For example, the first HARQ process indication information may indicate the above part of the HARQ processes via the second offset value, such as indicating a maximum value or a minimum value of the identifiers of the part of the HARQ processes (corresponding respectively to the maximum second offset value and the minimum second offset value). After determining the part of the HARQ processes according to the first HARQ process indication information, whether each HARQ process of the part of the HARQ processes is HARQ feedback enabled or HARQ feedback disabled according to the bits of the bitmap, or, after determining the HARQ process having the correspondence with the second HARQ process indication information according to the first HARQ process indication information, whether the HARQ process having the correspondence is HARQ feedback disabled or HARQ feedback enabled is determined; or, the first HARQ process indication information may indicate jointly with the above second HARQ process indication information and the enabling/disabling indication information. After determining the HARQ process having the correspondence with the second HARQ process indication information according to the first HARQ process indication information, whether the HARQ process having the correspondence is HARQ feedback disabled or HARQ feedback enabled is determined according to the enabling/disabling indication information. The enabling/disabling indication information may be indication information of 1 bit, when a value of the bit is 0, it indicates HARQ feedback disabled, and when the value of the bit is 1, it indicates HARQ feedback enabled, and vice versa, which shall not be enumerated herein any further.

For example, the first HARQ process indication information may be a group of second offset values, HARQ processes corresponding to an HARQ process identifier to which the group of second offset values indicated by the first HARQ process indication information corresponds are HARQ feedback enabled or HARQ feedback disabled, and other HARQ processes that do not correspond to the group of second offset values are HARQ feedback enabled or HARQ feedback disabled by default.

For example, the first HARQ process indication information may be a group of second offset values, and may indicate jointly with the enabling/disabling indication information. The enabling/disabling indication information is used to indicate whether the HARQ processes to which the group of second offset values indicated by the first HARQ process indication information correspond are HARQ feedback enabled or HARQ feedback disabled. The enabling/disabling indication information may be included in the indication information or in the DCI in operation 201, and the embodiment of this disclosure is not limited thereto. For example, when the enabling/disabling indication information indicates being enabled, the HARQ processes corresponding to the group of second offset values indicated by the first HARQ process indication information are all HARQ feedback enabled, and when the enabling/disabling indication information indicates being disabled, the HARQ processes corresponding to the group of second offset values indicated by the second HARQ process indication information are all HARQ feedback disabled. The enabling/disabling indication information may be indication information of 1 bit, when a value of this bit is 0, it indicates HARQ feedback disabled, and when the value of this bit is 1, it indicates HARQ feedback enabled, and vice versa, which shall not be enumerated herein any further.

For example, the first HARQ process indication information may also indicate jointly with the above second HARQ process indication information and the enabling/disabling indication information. For example, the first HARQ process indication information may indicate the HARQ process having the correspondence with the second HARQ process indication information, and after determining the HARQ process having the correspondence with the second HARQ process indication information according to the first HARQ process indication information (an HARQ process corresponding to a group of second offset values), whether the HARQ process is HARQ feedback disabled or HARQ feedback enabled is determined according to the enabling/disabling indication information. The enabling/disabling indication information may be indication information of 1 bit, when a value of this bit is 0, it indicates HARQ feedback disabled, and when the value of this bit is 1, it indicates HARQ feedback enabled, and vice versa, which shall not be enumerated herein any further.

For example, when each information in the indication information is carried by the above higher layer signaling, or when the indication information includes a bitmap and/or the first HARQ process indication information and/or the second HARQ process indication information, the indication information is carried by the higher layer signaling, and the enabling/disabling indication information is carried by the DCI in operation 201 (for example, the enabling/disabling indication information is carried by the fourth information field); or, when the indication information includes the enabling/disabling indication information, the indication information may be carried by the DCI in operation 201; however, the embodiment of this disclosure is not limited thereto.

In some embodiments, according to the indication information and the DCI, the terminal equipment may determine whether the HARQ processes to which the one or the plurality of PDSCHs scheduled by the DCI correspond are HARQ feedback disabled or HARQ feedback enabled, such as determining the HARQ processes indicated by the DCI according to the indication information and/or the enabling/disabling indication information carried by the DCI, determining whether the indicated HARQ processes are feedback enabled or feedback disabled, determining the HARQ processes to which the PDSCHs scheduled by the DCI correspond, and determining whether the HARQ processes to the scheduled PDSCHs correspond are feedback enabled or feedback disabled. The one or the plurality of PDSCHs include at least one PDSCH with a corresponding HARQ process that is feedback enabled or feedback disabled.

In some embodiments, the method may further include (not shown): the terminal equipment receives one or more PDSCHs; for example, the terminal equipment may receive the PDSCHs from slot n−N+1 to slot n, and transmits the HARQ feedback information for the one or the plurality of PDSCHs by using an uplink resource (a PUCCH or a PUSCH) at slot n+k1 in 202. A value of k1 may be indicated by the DCI or by higher layer signaling, and a meaning and indication method of k1 may be determined according to existing techniques. The HARQ feedback information is included in the HARQ-ACK codebook. In other words, in a case where a plurality of DCI are received, time domain positions (such as slot n+k1) of HARQ-ACK feedback of the plurality of DCI (or PDSCHs scheduled by the plurality of DCI) are identical.

In some embodiments, the HARQ-ACK codebook may be a semi-static codebook. Reference may be made to existing techniques for a size and generation method of the semi-static codebook, which shall not be repeated herein any further. The semi-static codebook at least includes the HARQ feedback information for the one or the plurality of PDSCHs. How to determine the HARQ feedback information of the one or the plurality of PDSCHs in different scenarios shall only be described below.

It should be noted that in the embodiment of this disclosure, the PDSCHs scheduled by the DCI may refer to the PDSCHs (configured PDSCHs) corresponding to the PDSCH TDRA configuration indicated by the DCI, or may refer to PDSCHs practically scheduled by the DCI (actual PDSCHs); however, this disclosure is not limited thereto. For example, the actual PDSCHs may be configured PDSCH satisfying a first condition, or, the actual PDSCHs may be equivalent to the configured PDSCHs. In some embodiments, the first condition may be a condition related to a semi-statically configured transmission direction (or, in other words, information for semi-statically configuring a transmission direction) and/or a configured PRACH resource and/or information for dynamically scheduling uplink transmission and/or information for dynamically configuring a transmission direction. For example, the actual PDSCHs may be configured PDSCHs not including symbols transmission directions that are semi-statically configured as uplink, or the actual PDSCHs may be configured PDSCHs with a corresponding HARQ processes, which shall not be enumerated herein any further. That is, in the embodiment of this disclosure, the terms “PDSCHs scheduled by the DCI”, “configured PDSCHs scheduled by the DCI”, “PDSCHs practically scheduled by the DCI”, “occasion PDSCHs scheduled by the DCI” and “actual PDSCHs in the PDSCHs scheduled by the DCI” may be interchangeable, and the terms “HARQ feedback information” and “HARQ-ACK information” may be interchangeable.

In some embodiments, when the terminal equipment is not configured or activated with SPS, or regardless of whether the terminal equipment is configured or activated with SPS, and the PDSCHs scheduled by the DCI include a second PDSCH with a corresponding HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH. That HARQ feedback information to which the second PDSCH corresponds is not related to a decoding result of the second PDSCH may also indicate ignoring the decoding result of the second PDSCH and setting the HARQ feedback information to which the second PDSCH corresponds to be NACK. That is, even if the second PDSCH is successfully decoded (successfully received), the HARQ feedback information to which the second PDSCH corresponds is still set to be NACK. The second PDSCH may be one or more, and as the HARQ process to which the second PDSCH corresponds is feedback disabled, that is, the terminal equipment may not transmit the HARQ feedback information of the second PDSCH for the HARQ process, at this moment, an actual decoding result of the second PDSCH needs not to be taken into account, and the HARQ feedback information to which the second PDSCH corresponds is directly set to be NACK.

In some embodiments, when the terminal equipment is not configured or activated with SPS, or regardless of whether the terminal equipment is configured or activated with SPS, and the PDSCHs scheduled by the DCI include a first PDSCH with a corresponding HARQ process that is feedback enabled, HARQ feedback information to which the first PDSCH corresponds is related to a decoding result of the first PDSCH. The first PDSCH may be one or more, and as the HARQ process to which the first PDSCH corresponds is feedback enabled, that is, the terminal equipment needs to transmit the HARQ feedback information of the first PDSCH for the HARQ process, at this moment, an actual decoding result of the first PDSCH needs to be taken into account, when the decoding is successful (reception is successful), the HARQ process to which the first PDSCH corresponds is set to be ACK, and when the decoding fails (reception fail), the HARQ process to which the first PDSCH corresponds is set to be NACK.

In some embodiments, when the terminal equipment is further configured or activated with an SPS, and the HARQ process to which the PDSCH of the SPS (SPS PDSCH) corresponds is HARQ feedback disabled, determination methods of the HARQ feedback information to which the SPS PDSCH and the second PDSCH correspond are identical or different. When the HARQ feedback information to which the first PDSCH corresponds is related to the decoding result of the first PDSCH (when the decoding is successful (reception is successful)), the HARQ feedback information to which the first PDSCH corresponds is set to be ACK, and when the decoding fails (reception fails), the HARQ feedback information to which the first PDSCH corresponds is set to be NACK. The HARQ process to which the SPS PDSCH corresponds may be determined by using formula (1) or (2) below:

$$HARQ Process ID = [ floor ( CURRENT\_slot \times 10 / ( numberOfSlotsPerFrame \times periodicity ) ) ] modulo nrofHARQ ‐ Processes , \qquad formula ( 1 )$$

$$HARQ Process ID = [ floor ( CURRENT\_slot \times 10 / ( numberOfSlotsPerFrame \times periodicity ) ) ] modulo nrofHARQ ‐ Processes + harq ‐ ProcID ‐ Offset ; \qquad formula ( 2 )$$

where, CURRENT_slot is equal to [(SFN×numberOfSlotsPerFrame)+slot number in the frame], where, numberOfSlotsPerFrame is the number of slots included in a system frame, nrofHARQ-Processes is the number of HARQ processes, and harq-ProcID-Offset is an offset of an HARQ process identifier (e.g. an offset relative to HARQ process identifier 0), which is included in SPS configuration information SPS-Config. For a case where harq-ProcID-Offset is not configured, an HARQ process identifier associated with a starting slot of downlink transmission may be determined by using formula (1), and for a case where harq-ProcID-Offset is configured, an HARQ process identifier associated with the starting slot of the downlink transmission may be determined by using formula (2). In addition, when the DCI for activating SPS schedules a plurality of PDSCHs, the HARQ process identifier of SPS PDSCH is further related to the number of the PDSCHs scheduled by DCI and/or sequence numbers of PDSCH time domain resources in at least two PDSCHs time domain resources scheduled by the DCI, and reference may be made to existing techniques for details, which shall not be described herein any further. In addition, in a case where it is supported that an HARQ process is configured to be feedback enabled or feedback disabled, it is further needed to determine the HARQ process to which the SPS PDSCH corresponds according to whether the HARQ process is feedback enabled or feedback disabled. For example, HARQ processes to which HARQ process identifiers in a range of 0˜harq-ProcID-Offset correspond are all HARQ feedback enabled, or are all HARQ feedback disabled, which shall not be enumerated herein any further.

For example, that determination methods of the HARQ feedback information to which the SPS PDSCH and the second PDSCH correspond are identical includes that the HARQ feedback information to which the SPS PDSCH corresponds is not related to a decoding result of the SPS PDSCH, that is, the decoding result of the SPS PDSCH is ignored, the HARQ feedback information to which the SPS PDSCH corresponds is set to be NACK, and the HARQ feedback information to which the second PDSCH corresponds is not related to the decoding result of the second PDSCH, that is, the decoding result of the second PDSCH is ignored, the HARQ feedback information to which the second PDSCH corresponds is set to be NACK. That is, even if the second PDSCH and the SPS PDSCH are successfully decoded (successfully received), the HARQ feedback information to which the second PDSCH and the SPS PDSCH correspond is still set to be NACK. Or, the HARQ feedback information to which the SPS PDSCH corresponds is related to the decoding result of the SPS PDSCH, and the HARQ feedback information to which the second PDSCH corresponds is related to the decoding result of the second PDSCH, that is, when the SPS PDSCH is successfully decoded (successfully received), the HARQ feedback information to which the SPS PDSCH corresponds is set to be ACK, and when decoding the SPS PDSCH fails (reception fails), the HARQ feedback information to which the SPS PDSCH corresponds is set to be NACK; when the second PDSCH is successfully decoded (successfully received), the HARQ feedback information to which the second PDSCH corresponds to be ACK, and when decoding the second PDSCH fails (reception thereof fails), the HARQ feedback information to which the second PDSCH corresponds to be NACK.

For example, that determination methods of the HARQ feedback information to which the SPS PDSCH and the second PDSCH correspond are different includes that the HARQ feedback information to which the SPS PDSCH corresponds is related to a decoding result of the SPS PDSCH and the HARQ feedback information to which the second PDSCH corresponds is not related to a decoding result of the second PDSCH, that is, the decoding result of the second PDSCH is ignored, the HARQ feedback information to which the second PDSCH corresponds is set to be NACK (even though the second PDSCH is successfully decoded (successfully received), the HARQ feedback information to which the second PDSCH corresponds is still set to be NACK), that is, when the SPS PDSCH is successfully decoded (successfully received), the HARQ feedback information to which the SPS PDSCH correspond is set to be ACK, and when decoding the SPS PDSCH fails (reception fails), the HARQ feedback information to which the SPS PDSCH corresponds is set to be NACK, but the HARQ feedback information to which the second PDSCH corresponds is always set to be NACK. Or, the HARQ feedback information to which the SPS PDSCH corresponds is not related to the decoding result of the SPS PDSCH, that is, the decoding result of the SPS PDSCH is ignored, and the HARQ feedback information to which the SPS PDSCH corresponds is set to be NACK (even though the SPS PDSCH is successfully decoded (successfully received), and the HARQ feedback information to which the second PDSCH corresponds is related to the decoding result of the second PDSCH, that is, when the second PDSCH is decoded successfully (received successfully), the HARQ feedback information to which the second PDSCH corresponds is set to be ACK, and when decoding the second PDSCH fails (reception thereof fails), the HARQ feedback information to which the second PDSCH corresponds is set to be NACK, but the HARQ feedback information to which the SPS PDSCH corresponds is always set to be NACK.

In some embodiments, the PDSCH corresponding to the HARQ process that is feedback enabled is referred to as the first PDSCH, the PDSCH corresponding to the HARQ process that is feedback disabled is referred to as the second PDSCH, and the first PDSCH and/or the second PDSCH may be the above configured PDSCH(s) or actual PDSCH(s), or in other words, the first PDSCH and/or the second PDSCH has/have corresponding HARQ process(es). In 201, the at least one DCI includes first DCI and/or second DCI and/or third DCI, wherein the first DCI schedules a plurality of PDSCHs, and the plurality of PDSCHs include at least one first PDSCH and at least one second PDSCH; the second DCI schedules a plurality of PDSCHs (or may schedule a plurality of PDSCHs), and the plurality of PDSCHs are all second PDSCHs, or the second DCI schedules only one PDSCH (may schedule only one PDSCH), the one PDSCH being a second PDSCH; and the third DCI schedules a plurality of PDSCHs (or may schedule a plurality of PDSCHs), and the PDSCHs are all first PDSCHs, or the third DCI schedules one PDSCH (may schedule only one PDSCH), and the one PDSCH is a first PDSCH.

In some embodiments, in 201, the terminal equipment may receive only one or more first DCI, or receives only one or more second DCI, or receives only one or more third DCI, or receives at least one third DCI in addition to receiving at least one first DCI or at least one second DCI. How to determine the HARQ feedback information of the one or the plurality of PDSCHs in cases where different DCI are received shall be respectively described below.

(I) A Case where the Terminal Equipment is not Configured or Activated with SPS

In some embodiments, when only at least one first DCI is received, the HARQ feedback information to which the second PDSCH corresponds is not related to the decoding result of the second PDSCH (an actual decoding result of the second PDSCH is ignored), and the HARQ feedback information of the first PDSCH is related to the decoding result of the first PDSCH; or, the HARQ feedback information of the first PDSCH is related to the decoding result of the first PDSCH, and the HARQ feedback information of the second PDSCH is related to the decoding result of the second PDSCH.

For example, the HARQ feedback information to which the second PDSCH corresponds is NACK, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

For example, when the second PDSCH is successfully decoded (successfully received), the HARQ feedback information to which the second PDSCH corresponds is set to be ACK, when decoding the second PDSCH fails (reception fails), the HARQ feedback information to which the second PDSCH corresponds is set to be NACK, when the first PDSCH is successfully decoded (successfully received), the HARQ feedback information to which the first PDSCH corresponds is set to be ACK, when decoding the first PDSCH fails (reception fails), the HARQ feedback information to which the first PDSCH corresponds is set to be NACK.

In the above embodiment, that only receives at least one first DCI refers to that within a predetermined period of time before a feedback time domain position (such as a slot n+k) corresponding to HARQ feedback timing (k) to which the first DCI corresponds, the terminal equipment does not receive any other second DCI and/or third DCI corresponding to the time domain position (such as the slot n+k), or, in other words, within a predetermined period of time before a time domain position (such as a slot n+k) corresponding to HARQ feedback timing (k) to which the first DCI corresponds, if the second DCI and/or the third DCI is/are received but a slot position/slot positions corresponding to HARQ feedback timing to which the second DCI and/or third DCI correspond(s) is/are different from a time domain position (such as slot n+k) corresponding to HARQ feedback timing (k) to which the first DCI corresponds, it is indicated that only at least one first DCI is received. In addition, when a plurality of first DCI are received, feedback time domain positions of the HARQ feedback information to which the PDSCHs scheduled by a plurality of first DCI correspond (or time domain positions of corresponding HARQ-ACK feedback) are identical.

In some embodiments, when only at least one second DCI is received, the HARQ feedback information to which the PDSCH scheduled by the second DCI corresponds is related to a decoding result of the PDSCH scheduled by the second DCI; or, the HARQ feedback information to which the PDSCH scheduled by the second DCI corresponds is not related to the decoding result of the PDSCH scheduled by the second DCI (the actual decoding result of the second PDSCH is ignored).

For example, when the second PDSCH is successfully decoded (successfully received), the HARQ feedback information to which the second PDSCH corresponds is set to be ACK, and when decoding the second PDSCH fails (reception fails), the HARQ feedback information to which the second PDSCH corresponds is set to be NACK, or the decoding result of the second PDSCH scheduled by the second DCI is ignored, and the HARQ feedback information to which the second PDSCH corresponds is set to be NACK.

In the above embodiment, that only receives at least one second DCI refers to that within a predetermined period of time before a feedback time domain position (such as a slot n+k) corresponding to HARQ feedback timing (k) to which the second DCI corresponds, the terminal equipment does not receive any other first DCI and/or third DCI corresponding to the time domain position (such as the slot n+k), or, in other words, within a predetermined period of time before a time domain position (such as a slot n+k) corresponding to HARQ feedback timing (k) to which the second DCI corresponds, if the first DCI and/or the third DCI is/are received but a slot position/slot positions corresponding to HARQ feedback timing to which the first DCI and/or third DCI correspond(s) is/are different from a time domain position (such as slot n+k) corresponding to HARQ feedback timing (k) to which the second DCI corresponds, it is indicated that only at least one second DCI is received. In addition, when a plurality of second DCI are received, feedback time domain positions of the HARQ feedback information to which the PDSCHs scheduled by a plurality of second DCI correspond (or time domain positions of corresponding HARQ-ACK information feedback) are identical.

In some embodiments, when only at least one third DCI is received, HARQ feedback information to which the PDSCH scheduled by the third DCI corresponds is related to a decoding result of the PDSCH scheduled by the third DCI.

For example, when the first PDSCH scheduled by the third DCI is successfully decoded (successfully received), the HARQ feedback information to which the first PDSCH corresponds is set to be ACK, and when decoding the first PDSCH fails (reception fail), the HARQ feedback information to which the first PDSCH corresponds is set to be NACK.

In the above embodiment, that only receives at least one third DCI refers to that within a predetermined period of time before a feedback time domain position (such as a slot n+k) corresponding to HARQ feedback timing (k) to which the third DCI corresponds, the terminal equipment does not receive any other first DCI and/or second DCI corresponding to the time domain position (such as the slot n+k), or, in other words, within a predetermined period of time before a time domain position (such as a slot n+k) corresponding to HARQ feedback timing (k) to which the third DCI corresponds, if the first DCI and/or the second DCI is/are received but a slot position/slot positions corresponding to HARQ feedback timing to which the first DCI and/or second DCI correspond(s) is/are different from a time domain position (such as slot n+k) corresponding to HARQ feedback timing (k) to which the third DCI corresponds, it is indicated that only at least one third DCI is received. In addition, when a plurality of third DCI are received, feedback time domain positions of the HARQ feedback information to which the PDSCHs scheduled by a plurality of third DCI correspond (or time domain positions of corresponding HARQ-ACK information feedback) are identical.

In some embodiments, when at least one first DCI and/or at least one second DCI is/are received and at least one third DCI is also received, the HARQ feedback information to which the second PDSCH corresponds is not related to the decoding result of the second PDSCH (the actual decoding result of the second PDSCH is ignored), and the HARQ feedback information to which the first PDSCH corresponds is related to the decoding result of the first PDSCH; or, the HARQ feedback information to which the first PDSCH corresponds is related to the decoding result of the first PDSCH, and the HARQ feedback information to which the second PDSCH corresponds is related to the decoding result of the second PDSCH.

For example, the HARQ feedback information to which the second PDSCH corresponds is NACK, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

For example, when the second PDSCH is successfully decoded (successfully received), the HARQ feedback information to which the second PDSCH corresponds is set to be ACK, when decoding the second PDSCH fails (reception fails), the HARQ feedback information to which the second PDSCH corresponds is set to be NACK, when the first PDSCH is successful decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

In the above embodiment, within a predetermined period of time before the feedback time domain position (such as a slot n+k) corresponding to the HARQ feedback timing (k) to which the first DCI and/or the second DCI correspond(s), the terminal equipment further receives third DCI corresponding to the time domain position (such as the slot n+k), or, in other words, within a predetermined period of time before the feedback time domain position (such as a slot n+k) corresponding to the HARQ feedback timing (k) to which the first DCI and/or the second DCI correspond(s), third DCI is received, and a time domain position corresponding to the HARQ feedback timing to which the third DCI corresponds is identical to the time domain position corresponding to the HARQ feedback timing (k) to which the first DCI or the second DCI corresponds. In addition, the feedback time domain position of the HARQ feedback information to which the PDSCH scheduled by at least one first DCI and/or at least one second DCI corresponds is identical to the feedback time domain position of the HARQ feedback information (or time domain positions of corresponding HARQ-ACK information feedback) to which the PDSCH scheduled by at least one third DCI corresponds.

(II) A Case where the Terminal Equipment is Configured or Activated with SPS

In some embodiments, when the terminal equipment is configured or activated with SPS, the HARQ-ACK process to which the PDSCH of the SPS (SPS PDSCH) corresponds is HARQ feedback disabled and only at least one first DCI or at least one third DCI is received, or when the terminal equipment is configured or activated with SPS, the HARQ-ACK process to which the SPS PDSCH corresponds is HARQ feedback disabled, at least one first DCI is received and/or at least one second DCI is received, and at least one third DCI is further received,
determination methods of the HARQ feedback information to which the SPS PDSCH corresponds and the HARQ feedback information to which the second PDSCH corresponds are identical, the HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.

For example, the HARQ feedback information to which the second PDSCH corresponds and feedback information to which the SPS PDSCH corresponds are NACK (actual decoding results of the second PDSCH and SPS PDSCH are ignored), when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

Or, determination methods of the HARQ feedback information to which the SPS PDSCH corresponds and the HARQ feedback information to which the second PDSCH corresponds are identical, the HARQ feedback information of the first PDSCH corresponds is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH.

For example, when the second PDSCH is successfully decoded (successfully received), the HARQ feedback information to which the second PDSCH corresponds is set to be ACK, when decoding the second PDSCH fails (reception thereof fails), the HARQ feedback information to which the second PDSCH corresponds is set to be NACK, when the first PDSCH is successfully decoded (successfully received), the HARQ feedback information to which the first PDSCH corresponds is set to be ACK, when decoding the first PDSCH fails (reception thereof fails), the HARQ feedback information to which the first PDSCH corresponds is set to be NACK, when the SPS PDSCH is successfully decoded (successfully received), the HARQ feedback information to which the SPS PDSCH corresponds is set to be ACK, and when decoding SPS PDSCH fails (reception thereof fails), the HARQ feedback information to which the SPS PDSCH corresponds is set to be NACK.

Or, determination methods of the HARQ feedback information to which the SPS PDSCH corresponds and the HARQ feedback information to which the second PDSCH corresponds are different, the HARQ feedback information to which the SPS PDSCH corresponds is not related to the decoding result of the SPS PDSCH, the HARQ feedback information of the first PDSCH is related to the decoding result of the first PDSCH, and the HARQ feedback information of the second PDSCH is related to the decoding result of the second PDSCH.

For example, feedback information to which the SPS PDSCH corresponds is NACK (the actual decoding result of the SPS PDSCH is ignored), when the first PDSCH is successfully decoded (successfully received), the HARQ feedback information to which the first PDSCH corresponds is set to be ACK, when decoding the first PDSCH fails (reception fails), the HARQ feedback information to which the first PDSCH corresponds is set to be NACK, when the second PDSCH is successfully decoded (successfully received), the HARQ feedback information to which the second PDSCH corresponds is set to be ACK, when decoding the second PDSCH fails (reception fails), the HARQ feedback information to which the second PDSCH corresponds is set to be NACK.

Or, determination methods of the HARQ feedback information to which the SPS PDSCH corresponds and the HARQ feedback information to which the second PDSCH corresponds are different, the HARQ feedback information to which the SPS PDSCH corresponds is related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.

For example, the feedback information to which the second PDSCH corresponds is NACK (the actual decoding result of the second PDSCH is ignored), when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK; when SPS PDSCH is successfully decoded (successfully received), the HARQ feedback information to which the SPS PDSCH corresponds is set to be ACK, and when decoding the SPS PDSCH fails (reception fails), the HARQ feedback information to which the SPS PDSCH corresponds is set to be NACK.

In some embodiments, when the terminal equipment is configured or activated with SPS, the HARQ-ACK process to which the PDSCH of the SPS (SPS PDSCH) corresponds is HARQ feedback disabled and only at least one second DCI is received,
determination methods of the HARQ feedback information to which the SPS PDSCH corresponds and the HARQ feedback information to which the second PDSCH corresponds are identical, the HARQ feedback information to which the SPS PDSCH corresponds is related to the decoding result of the SPS PDSCH, the HARQ feedback information to which the second PDSCH corresponds is related to the decoding result of the PDSCH scheduled by the second DCI.

For example, when the second PDSCH is successfully decoded (successfully received), the HARQ feedback information to which the second PDSCH corresponds is set to be ACK, and when decoding the second PDSCH fails (reception fails), the HARQ feedback information to which the second PDSCH corresponds is set to be NACK, when the SPS PDSCH is successfully decoded (successfully received), the HARQ feedback information to which the SPS PDSCH corresponds is set to be ACK, and when decoding the SPS PDSCH fails (reception fails), the HARQ feedback information to which the SPS PDSCH corresponds is set to be NACK.

Or, determination methods of the HARQ feedback information to which the SPS PDSCH corresponds and the HARQ feedback information to which the second PDSCH corresponds are identical, the HARQ feedback information to which the SPS PDSCH corresponds is not related to the decoding result of the SPS PDSCH, and the HARQ feedback information to which the PDSCH scheduled by the second DCI corresponds is not related to the decoding result of the second PDSCH.

For example, the decoding result of the second PDSCH scheduled by the second DCI and the decoding result of the SPS PDSCH are ignored, and the HARQ feedback information to which the second PDSCH corresponds and the HARQ feedback information to which the SPS PDSCH corresponds are set to be NACK.

In some embodiments, when the terminal equipment is configured or activated with SPS, the HARQ-ACK process to which the PDSCH of the SPS (SPS PDSCH) corresponds is HARQ feedback enabled and only at least one first DCI is received or only at least one second DCI is received or only at least one third DCI is received, or when the terminal equipment is configured or activated with SPS, the HARQ-ACK process to which the SPS PDSCH corresponds is HARQ feedback enabled, at least one first DCI is received and/or at least one second DCI is received, and at least one third DCI is received,
determination methods of the HARQ feedback information to which the SPS PDSCH corresponds and the HARQ feedback information to which the second PDSCH corresponds are identical, the HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.

For example, the decoding result of the second PDSCH scheduled by the second DCI and the decoding result of the SPS PDSCH are ignored, the HARQ feedback information to which the second PDSCH corresponds and the HARQ feedback information to which the SPS PDSCH corresponds are set to be NACK, when the first PDSCH is successfully decoded (successfully received), the HARQ feedback information to which the first PDSCH corresponds to is set to be ACK, and when decoding the first PDSCH fails (reception fails), the HARQ feedback information to which the first PDSCH corresponds is set to be NACK.

Or, determination methods of the HARQ feedback information to which the SPS PDSCH corresponds and the HARQ feedback information to which the second PDSCH corresponds are identical, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH.

For example, when the second PDSCH is successfully decoded (successfully received), the HARQ feedback information to which the second PDSCH corresponds is set to be ACK, when decoding the second PDSCH fails (reception fails), the HARQ feedback information to which the second PDSCH corresponds is set to be NACK, when the SPS PDSCH is successfully decoded (successfully received), the HARQ feedback information to which the SPS PDSCH corresponds is set to be ACK, when decoding the SPS PDSCH fails (reception fails), the HARQ feedback information to which the SPS PDSCH corresponds is set to be NACK, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

In the above embodiment (II), feedback time domain positions (or, in other words, time domain positions of corresponding HARQ-ACK information feedback) between the first DCI and/or the second DCI and/or the third DCI and the HARQ-ACK information feedback time domain positions of the HARQ feedback timing (k) of the first DCI and/or the second DCI and/or the third DCI corresponding to the SPS PDSCH are identical. A meaning/meanings of only receiving the first DCI and/or only receiving the second DCI and/or only receiving the third DCI is/are as described in (I), which shall not be repeated herein any further.

It should be noted that FIG. 2 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the HARQ information is transmitted in the case where the HARQ mechanism of the HARQ feedback enables/disables is supported. Hence, uplink control signaling overhead may be lowered, and also, the network device may transmit new data without needing to wait for the terminal equipment to report the HARQ feedback information, thereby reducing data transmission latency.

### Embodiment of a Second Aspect

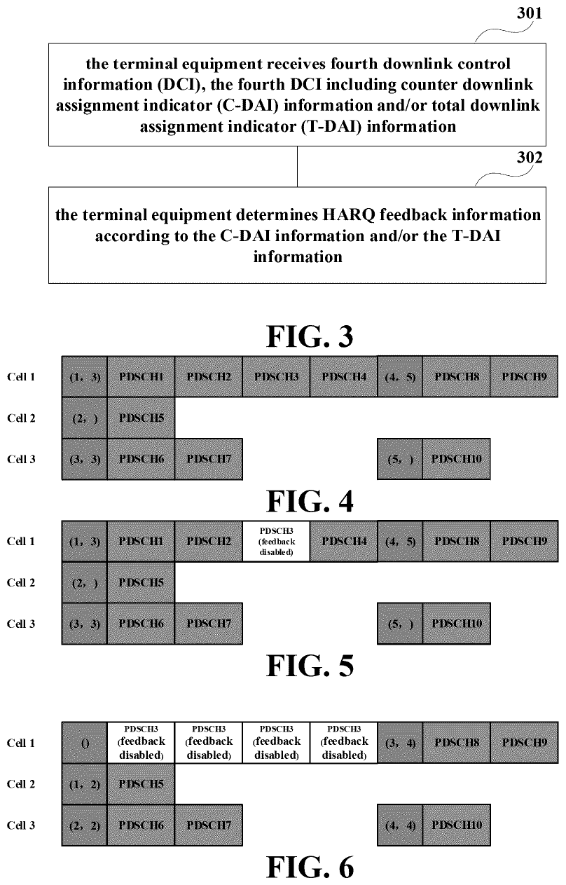

FIG. 3 is a schematic diagram of an information feedback method of the embodiment of this disclosure, applicable to a side of a terminal equipment. As shown in FIG. 3, the method includes:
301: the terminal equipment receives fourth downlink control information (DCI), the fourth DCI including counter downlink assignment indicator (C-DAI) information and/or total downlink assignment indicator (T-DAI) information; and
302: the terminal equipment determines HARQ feedback information according to the C-DAI information and/or the T-DAI information.

In some embodiments, the fourth DCI may be used to schedule a PDSCH, the scheduled PDSCH including a PDSCH with a corresponding HARQ process that is feedback enabled or feedback disabled. The fourth DCI may schedule one or a plurality of PDSCHs, and when the DCI schedules one PDSCH, a PDSCH time domain resource allocation table applied by the DCI only supports one DCI scheduling one PDSCH; or, when the DCI schedules one or a plurality of PDSCHs, a PDSCH time domain resource allocation table applied by the DCI supports one DCI scheduling a plurality of PDSCHs, and reference may be made to the embodiment of the first aspect for a specific implementation, which shall not be repeated herein any further; however, the embodiment of this disclosure is not limited thereto. For example, the fourth DCI may also be used to schedule (one or more) PUSCHs, or the fourth DCI does not schedule data transmission, which shall not be enumerated herein any further. A format of the fourth DCI may be 1_0 or 1_1, and reference may be made to existing techniques for details.

In some embodiments, the fourth DCI includes C-DAI and/or T-DAI. In a conventional method, C-DAI denotes a released number of cumulatively received PDSCHs or SPS PDSCHs associated with DCI format(s) 1_1/1_0, denoted by a {serving cell, PDCCH monitoring occasion} pair. A statistical order of the counting number is: an ascending order of serving cell indices first, and then an ascending order of PDCCH monitoring occasion indices. A value of the T-DAI denotes a total number of {serving cells, PDCCH monitoring occasion} pairs. T-DAIs of all serving cells at the same PDCCH monitoring occasion are identical, and the T-DAIs are updated along with the PDCCH monitoring occasion indices. FIG. 4 is a schematic diagram of a C-DAI and a T-DAI in the conventional method. As shown in FIG. 4, at a first PDCCH monitoring occasion, DCI received on serving cells 1 and 3 includes a C-DAI and a T-DAI, DCI received on serving cell 2 includes a C-DAI, wherein a value of the T-DAI is 3, and the C-DAIs on the serving cells are arranged in an ascending order of serving cell indices; at the second PDCCH monitoring occasion, DCI received on serving cell 1 includes a C-DAI and a T-DAI, and DCI received on serving cell 3 includes a C-DAI, wherein a value of the T-DAI is 5, and the C-DAIs on serving cells 1 and 3 are arranged in an ascending order of serving cell indices. That is, in the conventional method, in counting the C-DAIs and T-DAIs, whether the HARQ process may be indicated or configured as feedback enabled or feedback disabled is supported is not taken into account, or, in other words, whether the PDSCH scheduled by the DCI includes a PDSCH with a corresponding HARQ process that is feedback disabled or feedback enabled is not taken into account.

In order to support that the HARQ process may be indicated or configured as feedback enabled or feedback disabled, in the embodiment of this disclosure, a counting and statistical method of C-DAI and T-DAI different from the conventional method is provided, wherein in counting a C-DAI and a T-DAI, it is needed to take whether a PDSCH scheduled by DCI includes a PDSCH with a corresponding HARQ process that is feedback disabled or feedback enabled into account, and the counter DAI information and/or the total DAI information is/are counted for DCI scheduling a PDSCH in a granularity of the DCI and/or the PDSCH. The counting and statistical method of C-DAI and T-DAI and how to determine HARQ feedback information according to the counter DAI information and/or total DAI information in the method shall be respectively described below.

### (I) Counting at a Granularity of DCI

In some embodiments, DCI that may participate in counting may include DCI that practically receives a scheduled PDSCH, or DCI that misses in detection (not received) (used for or not used for scheduling a PDSCH), or DCI that activates SPS, or DCI that practically receives a PDSCH in conflict with uplink. However, the DCI that may participate in counting needs to include at least one DCI with a corresponding HARQ process. For the sake of convenience, in the following description, the PDSCH scheduled by the DCI in the figures refers to a PDSCH with a corresponding HARQ process, which is also applicable to (II) later.

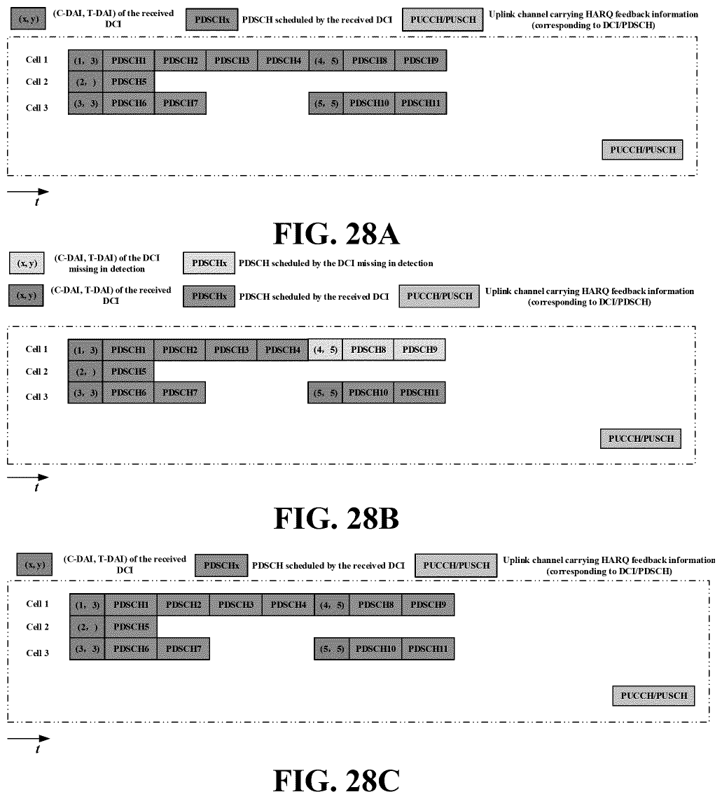

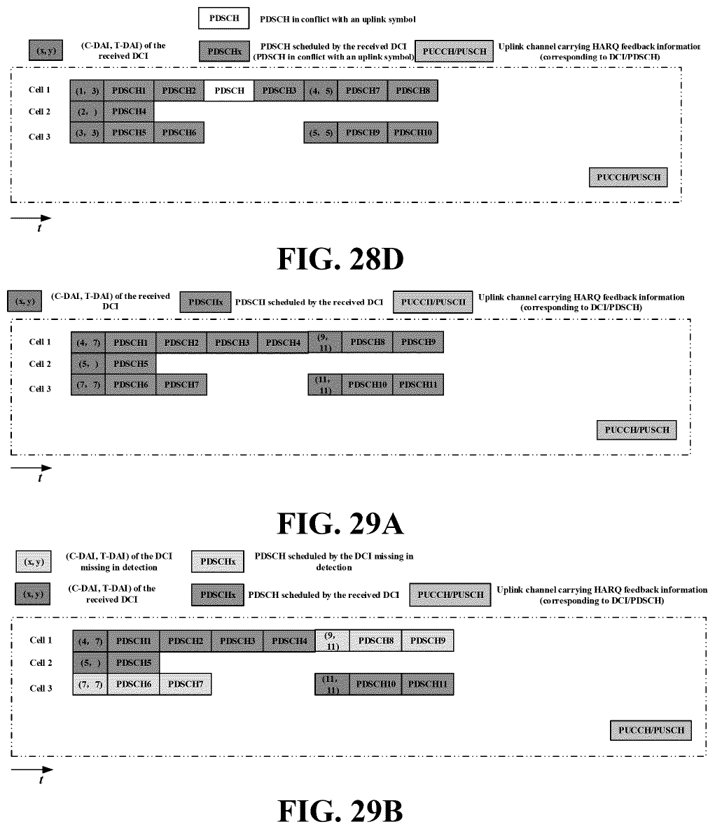

FIGS. 28A-28C are schematic diagrams of C-DAI and T-DAI counted at a granularity of DCI. As shown in FIGS. 28A-28C, uplink resources (time domain positions) transmitting the HARQ feedback information to which the PDSCH scheduled by the DCI corresponds are identical. As shown in FIG. 28A, the C-DAI and the T-DAI are counted at a granularity of practically received DCI. As shown in FIG. 28B, a difference from FIG. 28A exists in that DCI missing in detection (not received) (used or not used for scheduling the PDSCH) also participates in counting. As shown in FIG. 28C, DCI including at least one PDSCH in conflict with uplink also participates in counting.

In some embodiments, in the DCI that may participate in counting, for the DCI used for scheduling the PDSCH, the C-DAI and/or T-DAI only count(s) DCI scheduling PDSCHs including at least one PDSCH having a corresponding HARQ process that is feedback enabled. The C-DAI and/or T-DAI do(es) not count DCI with scheduled PDSCHs only including a PDSCH having a corresponding HARQ process that is feedback disabled. It should be noted that the above DCI refers to DCI in a general sense, and does not specifically refer to the fourth DCI in 301.

For example, for the fourth DCI used for scheduling PDSCHs, the PDSCHs scheduled by the fourth DCI include at least one first PDSCH with a corresponding HARQ process that is feedback enabled and at least one second PDSCH with a corresponding HARQ process that is feedback disabled. The C-DAI and/or T-DAI count(s) the fourth DCI, or, in other words, the fourth DCI is counted in counting. Meaning(s) expressed by the C-DAI and/or the T-DAI in the fourth DCI is/are similar to that/those in existing techniques, which shall not be repeated herein any further.

FIG. 5 is a schematic diagram of a C-DAI and a T-DAI counted at a granularity of DCI. As shown in FIG. 5, a difference from FIG. 4 exists in that the PDSCH scheduled by the DCI received by serving cell 1 at the first PDCCH monitoring occasion includes one second PDSCH. However, as the PDSCH scheduled by the DCI further includes three first PDSCHs, the DCI is also counted by the C-DAI and/or the T-DAI, that is, at the first PDCCH monitoring occasion, the DCI received by serving cells 1 and 3 includes a C-DAI and a T-DAI, and the DCI received on serving cell 2 includes a C-DAI, where a value of the T-DAI is 3. The C-DAIs on the serving cells are arranged in an ascending order of serving cell indices; and at the second PDCCH monitoring occasion, the DCI received on serving cell 1 includes a C-DAI and a T-DAI, and the DCI received on serving cell 3 includes a C-DAI, wherein a value of the T-DAI is 5, and the C-DAIs on serving cells 1 and 3 are arranged in an ascending order of serving cell indices.

In the above embodiment, the determining the HARQ feedback information by the terminal equipment according to the counter DAI information and/or the total DAI information includes that HARQ feedback information corresponding to a first PDSCH with a corresponding HARQ process that is feedback enabled to which the PDSCH scheduled by the fourth DCI corresponds is related to the decoding result of the first PDSCH, and HARQ feedback information corresponding to a second PDSCH with a corresponding HARQ process that is feedback disabled to which the PDSCH scheduled by the fourth DCI corresponds is not related to the decoding result of the second PDSCH, that is, an actual decoding result of the second PDSCH is ignored, the HARQ feedback information to which the second PDSCH corresponds is set to be NACK, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

Or, HARQ feedback information corresponding to a first PDSCH with a corresponding HARQ process that is feedback enabled to which the PDSCH scheduled by the fourth DCI corresponds is related to the decoding result of the first PDSCH, and HARQ feedback information corresponding to a second PDSCH with a corresponding HARQ process that is feedback disabled in the PDSCH scheduled by the fourth DCI is related to the decoding result of the second PDSCH, that is, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK, and when the second PDSCH is successfully decoded (successfully received), the HARQ feedback information to which the second PDSCH corresponds is set to be ACK, and when decoding the second PDSCH fails (reception fails), the HARQ feedback information to which the second PDSCH corresponds is set to be NACK.

For example, for the fourth DCI for scheduling the PDSCHs, the PDSCHs scheduled by the fourth DCI are all the first PDSCHs, and the C-DAI and/or T-DAI count the fourth DCI, or, in other words, the fourth DCI is counted in counting. Meanings denoted by the C-DAI and/or the T-DAI in the fourth DCI are similar to those in existing techniques, which shall not be repeated herein any further. As shown in FIG. 4, the PDSCHs at the PDCCH monitoring occasions scheduled by the DCI received by the serving cell only include one or more first PDSCHs, but do not include a second PDSCH. Therefore, the DCI is counted by the C-DAI and/or the T-DAI, that is, at a first PDCCH monitoring occasion, the DCI received on serving cells 1 and 3 includes the C-DAI and the T-DAI, and the DCI received on serving cell 2 includes the C-DAI; where, a value of the T-DAI is 3, and the C-DAIs on the serving cells are arranged in an ascending order of the serving cell indices; at the second PDCCH monitoring occasion, the DCI received on serving cell 1 includes the C-DAI and the T-DAI, and the DCI received on serving cell 3 includes the C-DAI; where, a value of the T-DAI is 5, and the C-DAIs received on serving cells 1 and 3 are arranged in an ascending order of the serving cell indices.

In the above embodiment, the determining the HARQ feedback information by the terminal equipment according to the counter DAI information and/or the total DAI information includes that the HARQ feedback information to which the first PDSCH scheduled by the fourth DCI corresponds is related to the decoding result of the first PDSCH, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK.

For example, for the fourth DCI for scheduling the PDSCHs, the PDSCHs scheduled by the fourth DCI are all the second PDSCHs, and the C-DAI and/or the T-DAI do not count the fourth DCI, or, in other words, the fourth DCI is not counted in counting. The C-DAI and/or the T-DAI in the fourth DCI may be a counting number of received DCI (the PDSCHs scheduled by the DCI include at least one first PDSCH), for example, the C-DAI and/or the T-DAI may be equal to a total number of DCI received on the serving cells at monitoring occasions till the PDCCH monitoring occasion received by the fourth DCI (the PDSCHs scheduled by the DCI include at least one first PDSCH).

FIG. 6 is a schematic diagram of a C-DAI and a T-DAI counted at a granularity of DCI. As shown in FIG. 6, a difference from FIG. 4 exists in that the PDSCH scheduled by the DCI received by serving cell 1 at the first PDCCH monitoring occasion includes only a second PDSCH, but does not include a first PDSCH. Hence, the DCI is not counted by the C-DAI and/or the T-DAI, that is, at the first PDCCH monitoring occasion, the DCI received by serving cells 2 and 3 includes a C-DAI and a T-DAI, where a value of the T-DAI is 2. The C-DAIs on the serving cells are arranged in an ascending order of serving cell indices; and at the second PDCCH monitoring occasion, the DCI received on serving cells 1 and 3 includes a C-DAI and a T-DAI, wherein a value of the T-DAI is 4, and the C-DAIs on serving cells 1 and 3 are arranged in an ascending order of serving cell indices.

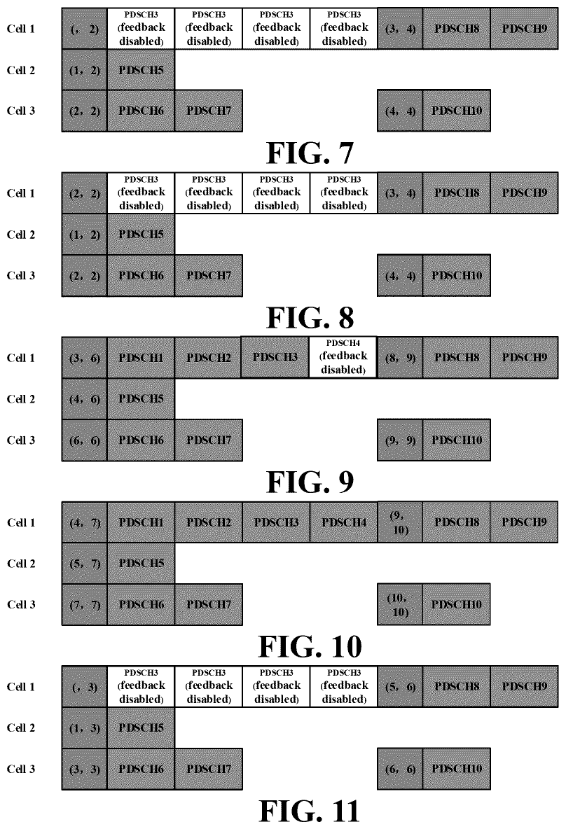

FIG. 7 is a schematic diagram of C-DAI and T-DAI counted at a granularity of DCI. As shown in FIG. 7, the PDSCH scheduled by the DCI received by serving cell 1 at the first PDCCH monitoring occasion only includes a second PDSCH, but does not include a first PDSCH. Hence, the DCI is not counted by the C-DAI and/or the T-DAI. A difference from FIG. 6 exists in that the DCI (the fourth DCI) may include a T-DAI, which may be equal to a total number 2 of DCI received on the serving cells at the first PDCCH monitoring occasion (the PDSCHs scheduled by the DCI include at least one first PDSCH).

FIG. 8 is a schematic diagram of C-DAI and T-DAI counted at a granularity of DCI. As shown in FIG. 8, the PDSCH scheduled by the DCI received by serving cell 1 at the first PDCCH monitoring occasion only includes a second PDSCH, but does not include a first PDSCH. Hence, the DCI is not counted by the C-DAI and/or the T-DAI. A difference from FIG. 7 exists in that the DCI (the fourth DCI) may further include a C-DAI, which may be equal to a total number 2 of DCI received on the serving cells at the first PDCCH monitoring occasion (the PDSCHs scheduled by the DCI include at least one first PDSCH).

In the above embodiment, as the PDSCHs scheduled by the fourth DCI are all the second PDSCHs, there is no need to generate HARQ feedback information for the second PDSCHs.

It should be noted that how to count at a granularity of DCI in a scenario shown in FIG. 28A is described in FIGS. 5-8. However, FIGS. 5-8 may also be described in scenarios shown in FIGS. 28B-28C, which shall not be repeated herein any further.

In the above embodiment, after the terminal equipment receives a plurality of DCI, after the HARQ feedback information of the PDSCHs scheduled by the DCI is determined by using one of methods identical to the method for scheduling the PDSCHs by the fourth DCI, a dynamic codebook may be generated, which includes HARQ feedback information of X PDSCHs, where, X is equal to a value of a T-DAI in last received DCI. HARQ feedback information of a PDSCH scheduled by a certain DCI is arranged at a Y-th position in the dynamic codebook, where, Y is equal to a value of a C-DAI in the DCI, that is, the terminal equipment includes the HARQ feedback information in the codebook and transmits it at a determined time domain position for transmitting HARQ feedback information. The time domain position shall be described later; in addition, in a case where an SPS PDSCH is taken into account, or an encoding block group is supported, reference may be made to existing techniques for a method for generating the dynamic codebook, which shall not be described herein any further.

### (II) Counting at a Granularity of PDSCHs

In some embodiments, PDSCHs that may participate in counting may include PDSCHs scheduled by DCI that practically receives a scheduled PDSCH, or PDSCHs scheduled by DCI that misses in detection (not received) (used for or not used for scheduling a PDSCH), or other PDSCHs that are not in conflict with uplink and scheduled by DCI that practically receives a PDSCH in conflict with uplink. However, the PDSCHs scheduled by the DCI that may participate in counting needs to include corresponding HARQ processes.

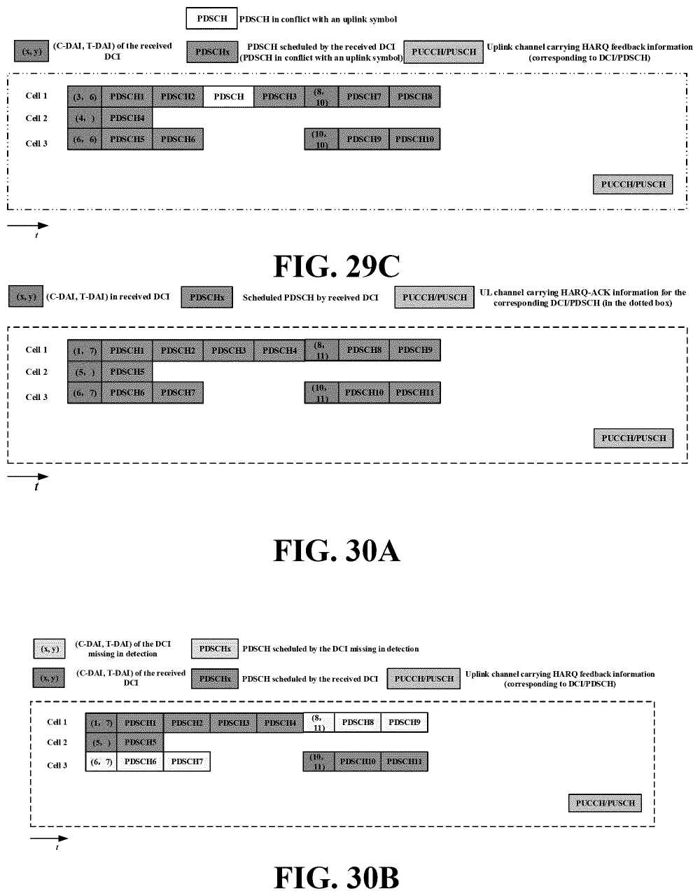

FIGS. 29A-29C are schematic diagrams of C-DAI and T-DAI counted at a granularity of PDSCHs. As shown in FIGS. 29A-29C, uplink resources (time domain positions) transmitting the HARQ feedback information to which the PDSCH scheduled by the DCI corresponds are identical. As shown in FIG. 29A, the C-DAI and the T-DAI are counted at a granularity of PDSCHs scheduled by practically received DCI. As shown in FIG. 29B, a difference from FIG. 29A exists in that PDSCHs scheduled by DCI missing in detection (not received) (used or not used for scheduling the PDSCH) also participates in counting. As shown in FIG. 29C, a difference from FIG. 29A exists in that other PDSCHs scheduled by DCI including at least one PDSCH in conflict with uplink also participate in counting.

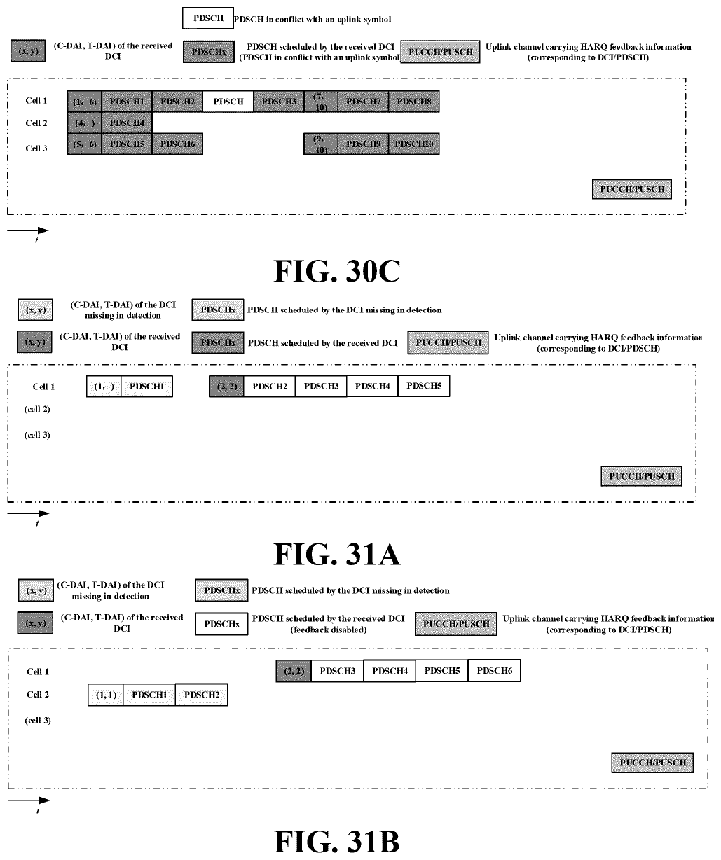

FIGS. 30A-30C are schematic diagrams of C-DAI and T-DAI counted at a granularity of PDSCHs. As shown in FIGS. 30A-30C, uplink resources (time domain positions) transmitting the HARQ feedback information to which the PDSCH scheduled by the DCI corresponds are identical, and a difference from FIGS. 29A-29C exists in that when a plurality of PDSCHs are scheduled by one DCI, the C-DAI in FIGS. 29A-29C indicates a sequence number to which a last PDSCH scheduled by the DCI corresponds, while the C-DAI in FIGS. 30A-30C indicates a sequence number to which a first PDSCH scheduled by the DCI corresponds. Following description shall be given by taking that the C-DAI indicates the sequence number to which the last PDSCH scheduled by the DCI corresponds as an example.

In some embodiments, in PDSCHs that may participate in counting, the C-DAI and/or the T-DAI only counts PDSCHs with a corresponding HARQ processes that are feedback enabled for the PDSCHs scheduled by the DCI. The counter DAI information and/or the total DAI information do not count PDSCHs with a corresponding HARQ processes that are feedback disabled. It should be noted that the above DCI refers to DCI in a general sense, and does not specifically refer to the fourth DCI in 301. By counting at a granularity of PDSCHs, in feeding back HARQ-ACK information by using the dynamic codebook, a size of the codebook may be reduced, and resource overhead may be lowered.

For example, for the fourth DCI for scheduling PDSCHs, the PDSCHs scheduled by the fourth DCI include at least one first PDSCH with a corresponding HARQ process that is feedback enabled and at least one second PDSCH with a corresponding HARQ process that is feedback disabled, the C-DAI and/or the T-DAI count(s) the first PDSCH scheduled by the fourth DCI, or in other words, the first PDSCH scheduled by the fourth DCI is counted in counting. The C-DAI and/or the T-DAI in the fourth DCI may be equal to a counting number of the first PDSCHs received on the serving cells at monitoring occasions till the PDCCH monitoring occasion received by the fourth DCI.

FIG. 9 is a schematic diagram of C-DAI and T-DAI counted at a granularity of PDSCHs. As shown in FIG. 9, the PDSCHs scheduled by the DCI received by serving cell 1 at the first PDCCH monitoring occasion include one second PDSCH, however, as the PDSCHs scheduled by the DCI also include three first PDSCHs, and only three first PDSCHs in the fourth DCI are counted by the C-DAI and/or the T-DAI, that is, at the first PDCCH monitoring occasion, the DCI received on serving cells 1 and 3 includes a C-DAI and a T-DAI, and the DCI received on serving cell 2 includes a C-DAI, where, a value of the T-DAI is 6, and the C-DAIs on the serving cells are arranged in an ascending order of the serving cell indices; and at the second PDCCH monitoring occasion, the DCI received on serving cell 1 includes a C-DAI and a T-DAI, and the DCI received on serving cell 3 includes a C-DAI, where a value of the T-DAI is 9, and the C-DAIs received on serving cells 1 and 3 are arranged in an ascending order of the serving cell indices.

In the above embodiment, that the terminal equipment determines the HARQ feedback information according to the counter DAI information and/or the total DAI information includes that the HARQ feedback information to which the first PDSCH corresponds is related to the decoding result of the first PDSCH scheduled by the fourth DCI, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK, that is, there is no need to generate HARQ feedback information of the second PDSCH.

For example, for the fourth DCI for scheduling the PDSCHs, the PDSCHs scheduled by the fourth DCI are all the first PDSCHs, and the C-DAI and/or the T-DAI count the first PDSCHs scheduled by the fourth DCI, or, in other words, the first PDSCHs scheduled by the fourth DCI are counted in counting. The C-DAI in the fourth DCI may be equal to a current counting number of the scheduled first PDSCHs till the PDCCH monitoring occasion received by the fourth DCI, and the T-DAI in the fourth DCI may be equal to a total number of the first PDSCHs received on the serving cells at the monitoring occasions till the PDCCH monitoring occasion received by the fourth DCI.

FIG. 10 is a schematic diagram of C-DAI and T-DAI counted at a granularity of PDSCHs. As shown in FIG. 10, as the DCI received on the serving cells to which the monitoring occasions correspond only schedules the first PDSCH, the first PDSCHs are included in the C-DAI and/or the T-DAI. That is, at the first PDCCH monitoring occasion, the DCI received on serving cells 1-3 includes a C-DAI and a T-DAI, where, a value of the T-DAI is 7, and values of the C-DAI are 5, 6 and 7 sequentially; and at the second PDCCH monitoring occasion, the DCI received on serving cells 1 and 3 includes a C-DAI and a T-DAI, where, a value of the T-DAI is 10, and the C-DAIs on serving cells 1 and 3 are 9 and 10 sequentially.

In the above embodiment, that the terminal equipment determines the HARQ feedback information according to the counter DAI information and/or the total DAI information includes that the HARQ feedback information to which the first PDSCH corresponds is related to the decoding result of the first PDSCH scheduled by the fourth DCI, when the first PDSCH is successfully decoded (successfully received), the HARQ feedback information to which the first PDSCH corresponds is set to be ACK, and when decoding the first PDSCH fails (reception fails), the HARQ feedback information to which the first PDSCH corresponds is set to be NACK, that is, as the fourth DCI does not include a second PDSCH, there is no need to generate HARQ feedback information of the second PDSCH.

For example, for the fourth DCI for scheduling the PDSCHs, the PDSCHs scheduled by the fourth DCI are all the second PDSCHs, and the C-DAI and/or the T-DAI do(es) count all the second PDSCHs scheduled by the fourth DCI, or, in other words, all the second PDSCHs scheduled by the fourth DCI are not counted in counting. The C-DAI and/or the T-DAI in the fourth DCI may be equal to a counting number of the first PDSCHs received on the serving cells at the monitoring occasions till the PDCCH monitoring occasion received by the fourth DCI.

FIG. 11 is a schematic diagram of C-DAI and T-DAI counted at a granularity of PDSCHs. As shown in FIG. 11, as all the fourth DCI only schedules the second PDSCHs, all the second PDSCHs scheduled by the fourth DCI are not counted by the C-DAI and/or the T-DAI. That is, at the first PDCCH monitoring occasion, the DCI received on serving cells 2-3 includes a C-DAI and a T-DAI, wherein, a value of the T-DAI is 3, and values of the C-DAI are 1 and 3 sequentially; and at the second PDCCH monitoring occasion, the DCI received on serving cells 1 and 3 includes a C-DAI and a T-DAI, wherein, a value of the T-DAI is 6, and the C-DAIs on serving cells 1 and 3 are 5 and 6 sequentially. At the first PDCCH monitoring occasion, the DCI received on serving cell 1 includes a T-DAI with a value 2.

In the above embodiment, as the PDSCHs scheduled by the fourth DCI are all second PDSCHs, there is no need to generate HARQ feedback information for the second PDSCHs.

In the above embodiment, after the terminal equipment receives a plurality of DCI, after the HARQ feedback information of the PDSCHs scheduled by the DCI is determined by using one of methods identical to the method for scheduling the PDSCHs by the fourth DCI, a dynamic codebook may be generated, which includes HARQ feedback information of X PDSCHs, wherein, X is equal to a value of a T-DAI in last received DCI. HARQ feedback information of a PDSCH scheduled by a certain DCI is arranged at a Y-th position in the dynamic codebook, wherein, Y is equal to a value of a C-DAI in the DCI, that is, the terminal equipment includes the HARQ feedback information in the codebook and transmits it at a determined time domain position for transmitting HARQ feedback information. The time domain position shall be described later; in addition, in a case where an SPS PDSCH is taken into account, or an encoding block group is supported, reference may be made to existing techniques for a method for generating the dynamic codebook, which shall not be described herein any further.

In some embodiments, the methods in (1) and (2) may be executed separately or in a combined manner, and the embodiment of this disclosure is not limited thereto.

In some embodiments, when the PDSCHs scheduled by the fourth DCI are all the second PDSCHs, the C-DAI and/or the T-DAI in the fourth DCI are of specific values.

For example, when only (one or more) the fourth DCI scheduling (one or more) PDSCHs with a corresponding HARQ process(es) that is/are feedback disabled is received but there exits DCI (used for scheduling or not used for scheduling PDSCHs) missing in detection (not received) (such as being determined according to the C-DAI/T-DAI in the received DCI), the HARQ feedback information needs to be transmitted, and information bits included in the HARQ feedback information are all NACK. The C-DAI and/or T-DAI in the fourth DCI is/are set to be of a specific value, e.g. 0, without the need to change according to the scheduling situation (without the need to change according to the number of other DCI or the number of PDSCHs scheduled by other DCI).

In some embodiments, the method may further include (not shown): the terminal equipment receives one or a plurality of PDSCHs; for example, the terminal equipment may receive the PDSCHs from slot n-N+1 to slot n, and the method may further include:
the terminal equipment transmits the HARQ feedback information at time domain positions for transmitting HARQ feedback information to which the received PDSCHs correspond.

In some embodiments, the terminal equipment determines the time domain positions for transmitting HARQ feedback information according to a time domain position of a last PDSCH scheduled by the DCI with a corresponding HARQ process that is HARQ feedback enabled.

For example, the terminal equipment determines the time domain positions for transmitting HARQ feedback information of the PDSCHs scheduled by the DCI according to the time domain position of the last PDSCH with a corresponding HARQ process that is HARQ feedback enabled and HARQ feedback timing, the HARQ feedback timing k indicating a time domain offset between the time domain position of the last PDSCH with a corresponding HARQ process that is HARQ feedback enabled scheduled by the DCI and a time domain position transmitting the HARQ feedback information of the PDSCH scheduled by the DCI. For example, the time domain position may be a slot and/or a symbol. Hence, feedback latency may further be reduced.

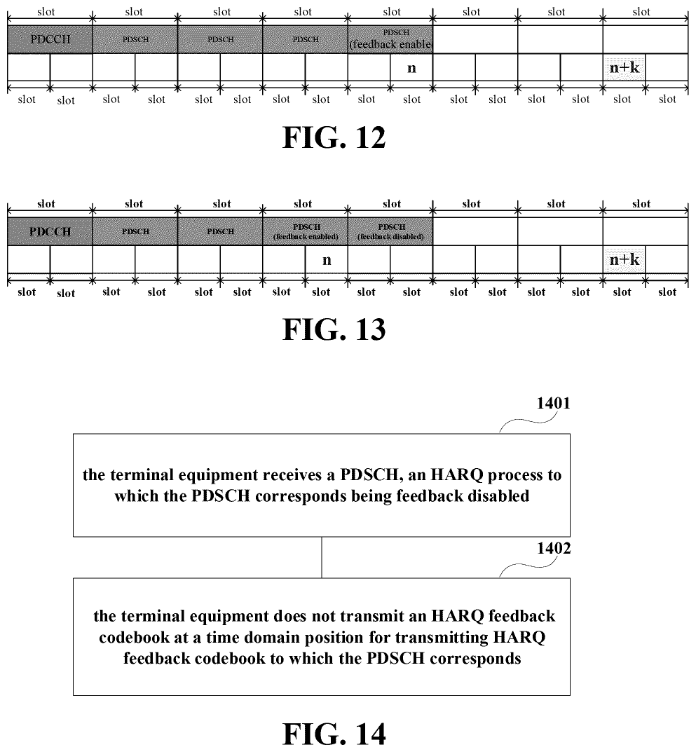

FIGS. 12 and 13 are schematic diagrams of the time domain position transmitting the HARQ feedback information. As shown in FIGS. 12 and 13, the offset between slot n+k and the time domain position slot n of the last PDSCH with a corresponding HARQ process that is HARQ feedback enabled scheduled by the DCI is equal to the HARQ feedback timing k, and a value of k may be indicated by the DCI or by higher layer signaling.

For example, the fourth DCI includes a first information field, the first information field being used for indicating the HARQ feedback timing, or, the method further includes (not shown):
the terminal equipment receives the higher layer signaling, the higher layer signaling being used to indicate the HARQ feedback timing k.

Reference may be made to existing techniques for a method for carrying k, which shall not be repeated herein any further. In the case where a plurality of DCI are received, the time domain positions (such as slot n+k) of the HARQ-ACK feedback of the plurality of DCI (or the PDSCHs scheduled by the plurality of DCI) are identical.

In some embodiments, reference may be made to the embodiment of the first aspect for a method for determining whether the PDSCH scheduled by DCI is the first PDSCH or the second PDSCH, which shall not be repeated herein any further.

It can be seen from the above embodiment that the HARQ information is transmitted in the case where the HARQ mechanism of HARQ feedback enables/disables is supported. Hence, uplink control signaling overhead may be lowered, and also, the network device may transmit new data without needing to wait for the terminal equipment to report the HARQ feedback information, thereby reducing data transmission latency.

### Embodiment of a Third Aspect

The embodiment of this disclosure provides an information feedback method, which shall be described from a side of a terminal equipment, wherein contents repeated with those in the embodiment of the first or second aspect shall not be described herein any further.

FIG. 14 is a schematic diagram of an information feedback method of the embodiment of this disclosure. As shown in FIG. 14, the method includes:
1401: the terminal equipment receives a PDSCH, an HARQ process to which the PDSCH corresponds being feedback disabled; and
1402: the terminal equipment does not transmit an HARQ feedback codebook at a time domain position for transmitting HARQ feedback codebook to which the PDSCH corresponds.

In some embodiments, in 1401, the PDSCH may be a PDSCH in one or a plurality of PDSCHs scheduled by DCI, or may be an SPS PDSCH. When the PDSCH is a PDSCH in one or a plurality of PDSCHs scheduled by the DCI, such as when the DCI schedules a plurality of PDSCHs, the terminal equipment receives one or a part or all of the scheduled PDSCHs, in other words, when a plurality of PDSCHs in the received PDSCH in 1401 are scheduled by the same DCI, and the embodiment of this disclosure is not limited thereto. A method for determining that the HARQ process to which the PDSCH corresponds is feedback disabled is as described in the first aspect, which shall not be repeated herein any further.

Therefore, in the case where the HARQ mechanism of the HARQ feedback enables/disables and the scheduling mode of one DCI scheduling a plurality of PDSCHs may be simultaneously supported, the HARQ information is not transmitted. Hence, not only the number of times of monitoring the PDCCHs by the terminal equipment may be reduced to lower complexity and power consumption of the terminal equipment in monitoring the PDCCHs, but also resource overhead for transmitting the downlink control information (DCI) may be lowered to improve the data throughput. And on the other hand, uplink control signaling overhead may be lowered, and also, the network device may transmit new data without needing to wait for the terminal equipment to report the HARQ feedback information, thereby reducing data transmission latency.

In some embodiments, reference may be made to the embodiment of the first or second aspect for determination of the time domain position. It should be noted that the time domain position only corresponds to the PDSCH, that is, there exists no other downlink transmission corresponding to the time domain position a predetermined time before the time domain position, that is, no downlink transmission feeds back the HARQ-ACK information (codebook) at the time domain position. For example, there exists no other PDSCH corresponding to the time domain position the predetermined time before the time domain position, in other words, there exists other PDSCH at the time domain position needing to transmit HARQ feedback information (codebook) corresponding to other PDSCH.

In some embodiments, the terminal equipment determines that the time domain position only corresponds to the PDSCH according to the C-DAI and/or the T-DAI in the DCI, and/or, the terminal equipment determines that the time domain position only corresponds to the PDSCH according to SPS configuration and/or an active state.

For example, the terminal equipment determines that the time domain position only corresponds to the PDSCH according to the C-DAI and/or the T-DAI in the DCI. That is, the received DCI or the PDSCHs scheduled by the DCI may be determined according to the C-DAI and/or the T-DAI in the DCI, thereby determining whether there exists other downlink transmission (e.g. a PDSCH) corresponding to the time domain position the predetermined time before the time domain position, and determining whether the time domain position only corresponds to the PDSCH (if there exists no other downlink transmission corresponding to the time domain position the predetermined time before the time domain position, determining that the time domain position only corresponds to the PDSCH). Likewise, the terminal equipment determines not to transmit the HARQ feedback codebook at the time domain position for transmitting HARQ feedback codebooks to which the PDSCH corresponds according to the C-DAI and/or the T-DAI in the DCI, that is, the received DCI or the PDSCHs scheduled by the DCI may be determined according to the C-DAI and/or the T-DAI in the DCI, thereby determining whether there exists other downlink transmission (e.g. a PDSCH) corresponding to the time domain position the predetermined time before the time domain position, determining whether the time domain position only corresponds to the PDSCH, and determining whether to transmit the HARQ feedback codebook at the time domain position for transmitting HARQ feedback codebooks to which the PDSCH corresponds (if the time domain position corresponds only to the PDSCH, determining not to transmit the HARQ feedback codebook at the time domain position for transmitting HARQ feedback codebooks to which the PDSCH corresponds). The DCI may be DCI scheduling the received PDSCH. However, the embodiment is not limited thereto, and the DCI may also be DCI received a predetermined time before or after the DCI scheduling the received PDSCH.

In some embodiments, in following cases 1)-3), the terminal equipment determines that it is needed to transmit an HARQ feedback codebook (a semi-static codebook or a dynamic codebook) at the time domain position for transmitting HARQ feedback codebooks to which the PDSCH corresponds according to the C-DAI and/or the T-DAI in the DCI.
1) Only (one or more) DCI scheduling (one or more) PDSCHs with a corresponding HARQ process(es) that is/are feedback disabled, but there exists DCI (used for scheduling or not used for scheduling PDSCHs) missing in detection (not received) (such as being determined according to the C-DAI/T-DAI in the received DCI).
2) Only one DCI is received, an HARQ process to which the PDSCH scheduled by the DCI corresponds is feedback disabled, and a C-DAI of the DCI is not a first specific value, e.g. 1, and/or a T-DAI thereof (if the DCI includes a T-DAI) is not a second specific value, e.g. 1 (assuming that the C-DAI is counted based on the DCI).
3) Only one DCI is received, an HARQ process to which the PDSCH scheduled by the DCI corresponds is feedback disabled, and a C-DAI of the DCI is not a first specific value, e.g. 1, or is the number of the PDSCHs scheduled by the DCI, and/or a T-DAI thereof (if the DCI includes a T-DAI) is not a second specific value, e.g. 1, or is the number of the PDSCHs scheduled by the DCI (assuming that the DAI is counted based on the PDSCHs).

In cases 1)-3), the information bits of the feedback codebook are all NACK, and the DCI may be DCI that may only schedule one PDSCH or DCI that may schedule a plurality of PDSCHs.

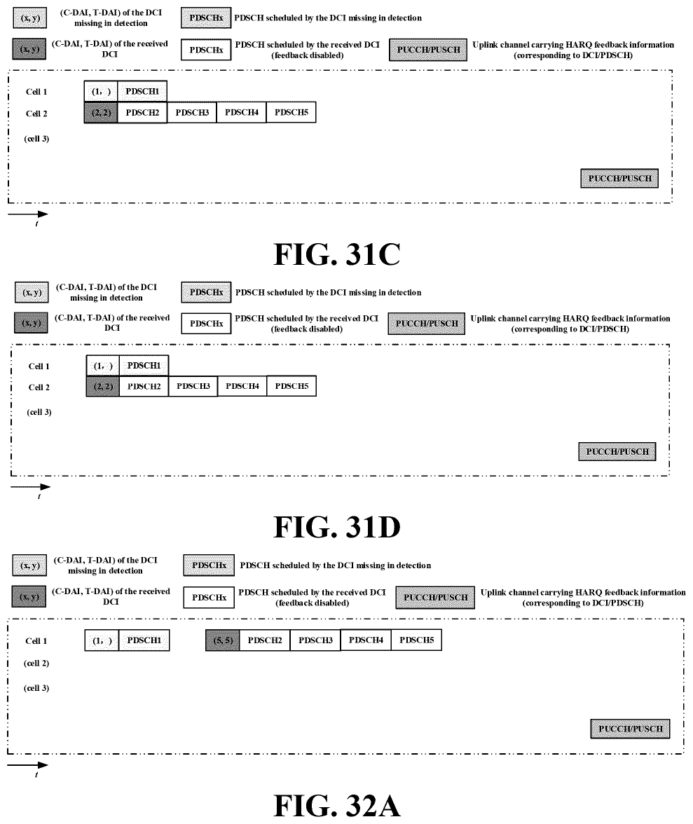

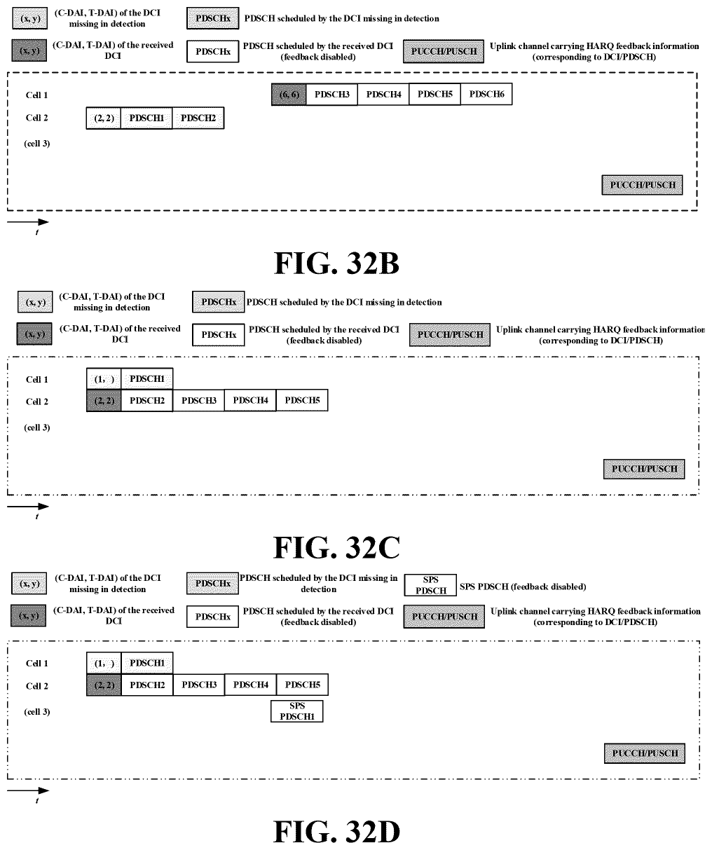

FIGS. 15A-15C describe the C-DAI and the T-DAI in cases 1)-3) by taking that one DCI is received and the DCI schedules one PDSCH as an example, and FIGS. 31A-31D describe the C-DAI and the T-DAI in cases 1)-3) by taking that one DCI is received and the DCI schedules a plurality of PDSCHs as an example. In FIGS. 31A-31D, the DAI is counted at a granularity of DCI. FIGS. 32A-32D describe the C-DAI and the T-DAI in cases 1)-3) by taking that one DCI is received and the DCI schedules a plurality of PDSCHs as an example. In FIGS. 32A-32D, the DAI is counted at a granularity of PDCCHs; that is, in the scenarios shown in FIGS. 15A-15C, 31A-31D and 32A-32D, the terminal equipment determines that it is needed to transmit an HARQ feedback codebook (a semi-static codebook or a dynamic codebook) at the time domain position for transmitting HARQ feedback codebooks to which the PDSCH corresponds according to the C-DAI and/or the T-DAI in the DCI, but information bits of the feedback codebook are all NACK.

In some embodiments, except the case where the HARQ process to which the PDCCH corresponds is feedback disabled, in following cases 4)-6), the terminal equipment determines that it is not needed to transmit an HARQ feedback codebook (a semi-static codebook or a dynamic codebook) at the time domain position for transmitting HARQ feedback codebooks to which the PDSCH corresponds according to the C-DAI and/or the T-DAI in the DCI
4) Only (one or more) DCI scheduling a PDSCH with a corresponding HARQ process that is feedback disabled, and there exists no DCI (used for scheduling or not used for scheduling PDSCHs) missing in detection (not received) (such as being determined according to the C-DAI/T-DAI in the received DCI).
5) Only one DCI is received, an HARQ process to which the PDSCH scheduled by the DCI corresponds is feedback disabled, and a C-DAI of the DCI is a first specific value, e.g. 0/1, and/or a T-DAI thereof (if the DCI includes a T-DAI) is a second specific value, e.g. 0/1 (assuming that the C-DAI is counted based on the DCI).

The DCI is DCI that may only schedule one PDSCH or DCI that may schedule a plurality of PDSCHs.
6) Only one DCI is received, an HARQ process to which the PDSCH scheduled by the DCI corresponds is feedback disabled, and a C-DAI of the DCI is a first specific value, e.g. 0/1, or is the number of the PDSCHs scheduled by the DCI, and/or a T-DAI thereof (if the DCI includes a T-DAI) is a second specific value, e.g. 0/1, or is the number of the PDSCHs scheduled by the DCI (assuming that the DAI is counted based on the PDSCHs).

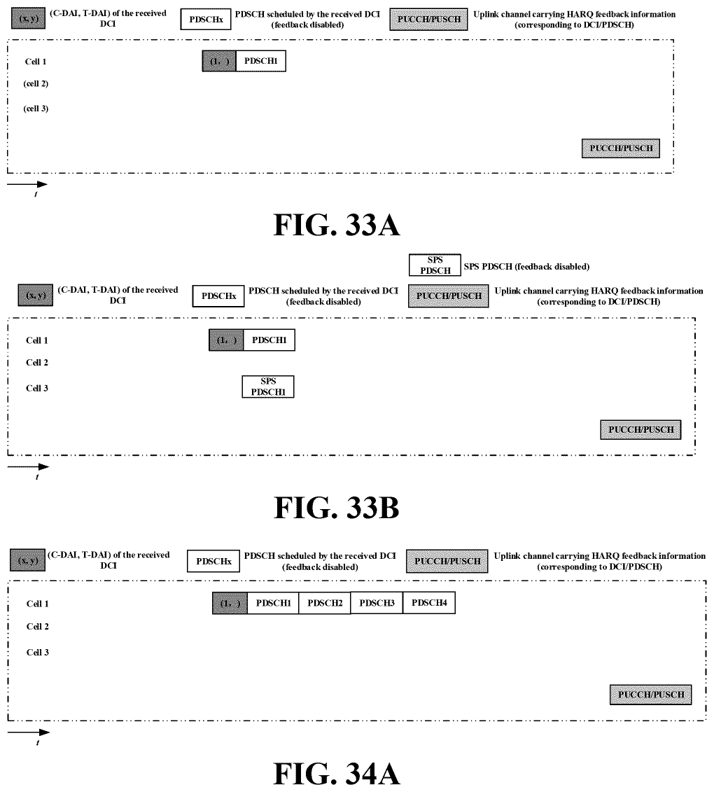

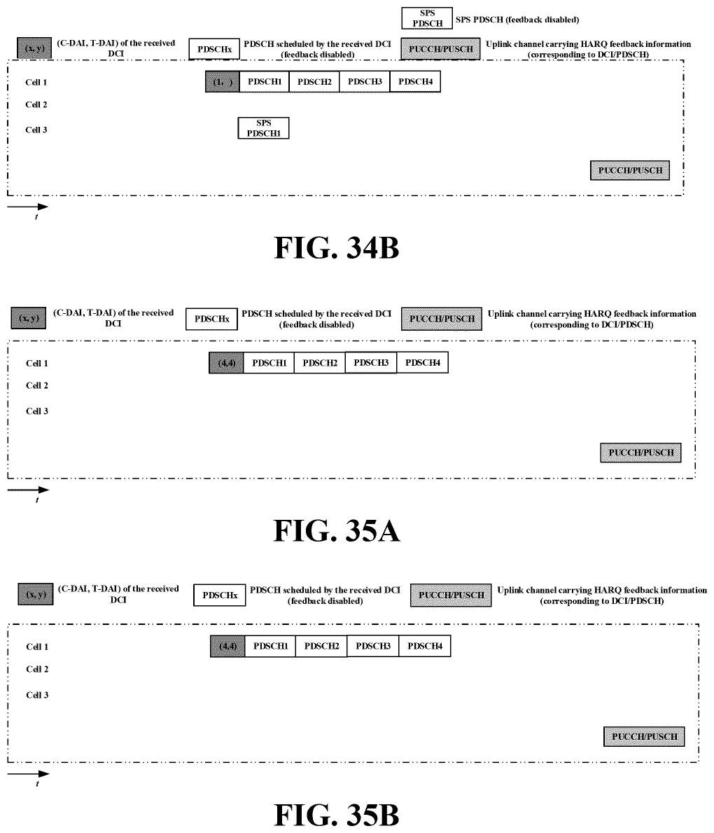

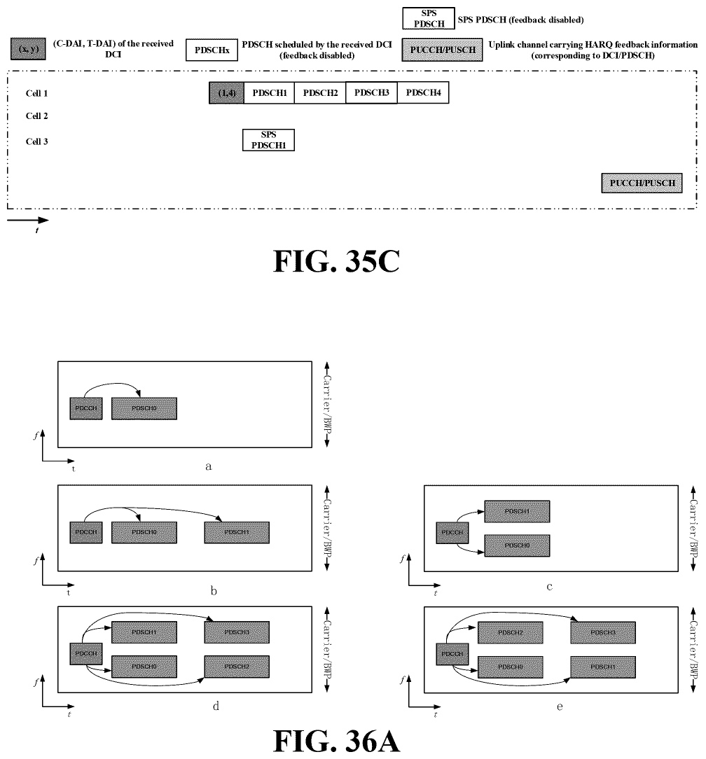

FIGS. 33A-33B describe the C-DAI and the T-DAI in cases 4)-6) by taking that one DCI is received and the DCI schedules one PDSCH as an example, and FIGS. 34A-34B describe the C-DAI and the T-DAI in cases 4)-6) by taking that one DCI is received and the DCI schedules a plurality of PDSCHs as an example. In FIGS. 34A-34D, the DAI is counted at a granularity of DCI. FIGS. 35A-35D describe the C-DAI and the T-DAI in cases 4)-6) by taking that one DCI is received and the DCI schedules a plurality of PDSCHs as an example. In FIGS. 35A-35D, the DAI is counted at a granularity of PDCCHs; that is, in the scenarios shown in FIGS. 33A-33B, 34A-34B and 35A-35D, the terminal equipment determines that it is not needed to transmit an HARQ feedback codebook (a semi-static codebook or a dynamic codebook) at the time domain position for transmitting HARQ feedback codebooks to which the PDSCH corresponds according to the C-DAI and/or the T-DAI in the DCI.

For example, the terminal equipment determines that the time domain position only corresponds to PDSCH according to SPS configuration and/or an active state. That is, the SPS PDSCH may be determined according to the SPS configuration and/or the active state, thereby determining whether there exists other downlink transmission (e.g. SPS PDSCH) corresponding to the time domain position a predetermined time before the time domain position, and determining whether the time domain position only corresponds to the PDSCH (if there is no downlink transmission corresponding to the time domain position the predetermined time before the time domain position, determining that the time domain position only corresponds to the PDSCH). Likewise, the terminal equipment determines not to transmit the HARQ feedback codebook at the time domain position for transmitting HARQ feedback codebooks to which the PDSCH corresponds according to the SPS configuration and/or the active state, that is, the SPS PDSCH may be determined according to the configuration and/or the active state, thereby determining whether there exists other downlink transmission (e.g. an SPS PDSCH) corresponding to the time domain position the predetermined time before the time domain position, determining whether the time domain position only corresponds to the PDSCH, and determining whether to transmit the HARQ feedback codebook at the time domain position for transmitting HARQ feedback codebooks to which the PDSCH corresponds (if the time domain position corresponds only to the PDSCH, determining not to transmit the HARQ feedback codebook at the time domain position for transmitting HARQ feedback codebooks to which the PDSCH corresponds).

In some embodiments, the time domain positions (such as slot n+k) for transmitting HARQ feedback information to which the time domain position corresponds may be determined according to a time domain position of a last PDSCH scheduled by the DCI scheduling the PDSCH with a corresponding HARQ process that is HARQ feedback enabled, and reference may be made to the embodiment of the first or second aspect, which shall not be repeated herein any further.

In some embodiments, in 1402, the HARQ feedback codebook may also be only for the HARQ feedback information of the received PDSCH.

For example, when the terminal equipment is not configured or activated with SPS, and when the terminal equipment only receives at least one second DCI described in the first aspect, the PDSCH received in 1401 is a PDSCH in the PDSCHs scheduled by the DCI, and HARQ processes to which all the second PDSCHs scheduled by the second DCI correspond are feedback disabled. Thereafter, when the terminal equipment receives one or more or all of the PDSCHs in the second PDSCHs (hereinafter collectively referred to as received PDSCHs), generation of feedback codebooks (such as semi-static codebooks) may be skipped (the feedback codebooks are not generated), that is, the HARQ feedback information (or the codebook) is not transmitted at the time domain position for transmitting HARQ feedback information to which the received PDSCHs correspond. SPS PDSCHs and PDSCHs scheduled by at least two second DCI correspond to identical time domain positions for transmitting HARQ feedback information. For example, when the terminal equipment is configured or activated with SPS PDSCH and the PDSCH received in 1401 is an SPS PDSCH, the terminal equipment may skip generation of a feedback codebook (such as a semi-static codebook) (not generating a feedback codebook), that is, it does not transmit the HARQ feedback information (or codebook) for the SPS PDSCH at the time domain position for transmitting HARQ feedback information to which the received SPS PDSCH corresponds.

For example, when the terminal equipment is configured or activated with SPS and only receives at least one second DCI described in the first aspect, the PDSCH received in 1401 includes the SPS PDSCH and the PDSCH scheduled by the DCI, and the terminal equipment may skip generation of a feedback codebook (such as a semi-static codebook) (not generating a feedback codebook), that is, it does not transmit the HARQ feedback information (or codebook) for the SPS PDSCH at the time domain position for transmitting HARQ feedback information to which the SPS PDSCH and the PDSCH scheduled by the DCI. The SPS PDSCH and PDSCH scheduled by the DCI correspond to identical time domain positions for transmitting HARQ feedback information.

For example, a difference from the embodiment of the second aspect exists in that when the terminal equipment only receives at least one fourth DCI described in the second aspect, the PDSCH received in 1401 is a PDSCH in the PDSCHs scheduled by the fourth DCI, and HARQ processes to which all the second PDSCHs scheduled by the fourth DCI correspond are feedback disabled. Thereafter, when the terminal equipment receives one or more or all of the PDSCHs in the second PDSCHs (hereinafter collectively referred to as received PDSCHs), the C-DAI and/or the T-DAI in the fourth DCI may be ignored.

It can be seen from the above embodiment that for the PDSCHs with HARQ processes that are feedback disabled, the HARQ feedback codebooks may not be transmitted at the time domain positions for transmitting HARQ feedback codebooks to which the PDSCHs correspond. Hence, that the HARQ information is not transmitted in the case where the HARQ mechanism of HARQ feedback enables/disables is supported. Thus, uplink control signaling overhead may be lowered, and also, the network device may transmit new data without needing to wait for the terminal equipment to report the HARQ feedback information, thereby reducing data transmission latency.

### Embodiment of a Fourth Aspect

The embodiment of this disclosure provides an information feedback method, which shall be described from a side of a terminal equipment, wherein contents repeated with those in the embodiment of the second or third aspect shall not be described herein any further.

FIG. 16 is a schematic diagram of an information feedback method of the embodiment of this disclosure. As shown in FIG. 16, the method includes:
1601: the terminal equipment receives DCI scheduling PDSCHs;
1602: the terminal equipment determines time domain positions for transmitting HARQ feedback information of the PDSCHs scheduled by the DCI according to a time domain position of a last PDSCH scheduled by the DCI with a corresponding HARQ process that is HARQ feedback enabled; and
1603: the terminal equipment transmits HARQ feedback information for the PDSCHs at the determined time domain positions.

Reference may be made to the embodiment of the second aspect for implementations of 1601 and 1603, which shall not be repeated herein any further.

In some embodiments, the terminal equipment determines the time domain positions for transmitting the HARQ feedback information according to the time domain position of the last PDSCH scheduled by the DCI with a corresponding HARQ process that is HARQ feedback enabled.

For example, the terminal equipment determines the time domain positions for transmitting HARQ feedback information of the PDSCHs scheduled by the DCI according to the time domain position of the last PDSCH with a corresponding HARQ process that is HARQ feedback enabled and HARQ feedback timing, the HARQ feedback timing k indicating a time domain offset between the time domain position of the last PDSCH with a corresponding HARQ process that is HARQ feedback enabled scheduled by the DCI and a time domain position transmitting the HARQ feedback information of the PDSCH scheduled by the DCI. For example, the time domain position may be a slot and/or a symbol.

For example, the DCI includes a first information field, the first information field being used for indicating the HARQ feedback timing, or the method further includes (not shown):
the terminal equipment receives higher layer signaling, the higher layer signaling being used for indicating the HARQ feedback timing k.

Reference may be made to existing techniques for a method for carrying k, which shall not be repeated herein any further. In the case where a plurality of DCI are received, the time domain positions (such as slot n+k) of the HARQ-ACK feedback of the plurality of DCI (or the PDSCHs scheduled by the plurality of DCI) are identical. In addition, the above method may only be applicable to a case where feeding back a dynamic codebook is to determine a time domain position of HARQ feedback information, and is not applicable to a case where feeding back a semi-static codebook is to determine a time domain position of HARQ feedback information; however, the embodiment of this disclosure is not limited thereto.

With the above embodiment, feedback latency may further be reduced.

### Embodiment of a Fifth Aspect

The embodiment of this disclosure provides an information reception method, which shall be described from a side of a network device, wherein contents repeated with those in the embodiment of the first or second aspect shall not be described herein any further.

FIG. 17 is a schematic diagram of an information reception method of the embodiment of this disclosure. As shown in FIG. 17, the method includes:
1701: the network device transmits to a terminal equipment at least one downlink control information (DCI) for scheduling a physical downlink shared channel (PDSCH), the DCI scheduling one or a plurality of PDSCHs, wherein the one or the plurality of PDSCHs include at least one PDSCH with a corresponding HARQ process that is feedback enabled or feedback disabled; and
1702: the network device receives HARQ feedback information for the one or the plurality of PDSCHs transmitted by the terminal equipment.

In some embodiments, reference may be made to 201-202 in the embodiment of the first aspect for implementations of 1601-1602, which shall not be repeated herein any further.

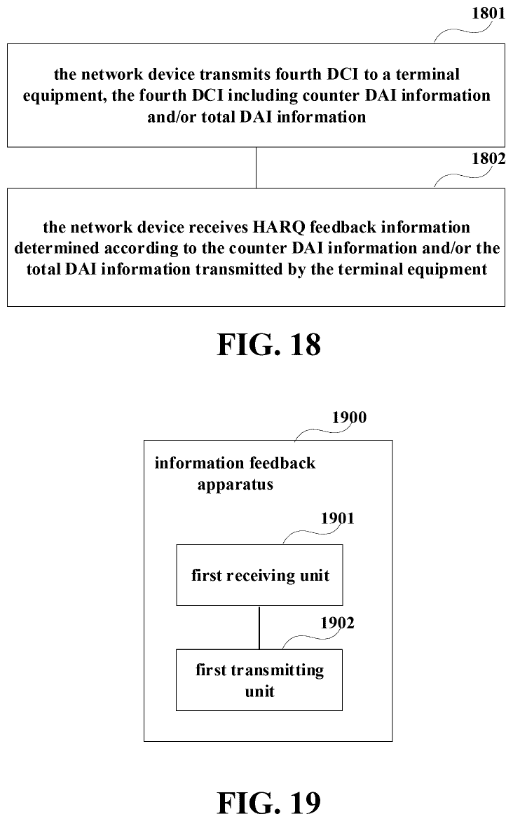

FIG. 18 is a schematic diagram of an information reception method of the embodiment of this disclosure. As shown in FIG. 18, the method includes:
1801: the network device transmits fourth DCI to a terminal equipment, the fourth DCI including counter DAI information and/or total DAI information; and
1802: the network device receives HARQ feedback information determined according to the counter DAI information and/or the total DAI information transmitted by the terminal equipment.

In some embodiments, reference may be made to 301-302 in the embodiment of the first aspect for implementations of 1801-1802, which shall not be repeated herein any further.

Reference may be made to the above embodiments and a corresponding embodiment in a seventh aspect for implementations of the DCI, counter DAI information and/or total DAI information, HARQ feedback information and the fourth DCI, which shall not be repeated herein any further.

### Embodiment of a Sixth Aspect

The embodiment of this disclosure provides an information feedback apparatus. The apparatus may be, for example, a terminal equipment, or may be one or more components or assemblies configured in a terminal equipment. Contents in this embodiment identical to those in the embodiment of the first aspect shall not be described herein any further.

FIG. 19 is a schematic diagram of an information feedback apparatus of the embodiment of this disclosure. As shown in FIG. 19, an information feedback apparatus 1900 includes:
a first receiving unit 1901 configured to receive at least one downlink control information (DCI) used for scheduling a physical downlink shared channel (PDSCH), the DCI scheduling one or a plurality of PDSCHs, wherein the one or the plurality of PDSCHs include at least one PDSCH with a corresponding HARQ process that is feedback enabled or feedback disabled; and
a first transmitting unit 1902 configured to transmit HARQ feedback information for the one or the plurality of PDSCHs.

In some embodiments, when the PDSCH scheduled by the DCI includes a second PDSCH with an HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.

In some embodiments, that HARQ feedback information to which the second PDSCH corresponds is not related to a decoding result of the second PDSCH includes that the HARQ feedback information to which the second PDSCH corresponds is NACK.

In some embodiments, when the PDSCH scheduled by the DCI includes a first PDSCH with a corresponding HARQ process that is feedback enabled, HARQ feedback information to which the first PDSCH corresponds is related to a decoding result of the first PDSCH.

In some embodiments, when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.

In some embodiments, that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.

In some embodiments, that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.

In some embodiments, the terminal equipment transmits the HARQ feedback information at a time domain position corresponding to the one or the plurality of PDSCHs and used for transmitting HARQ feedback information.

In some embodiments, feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.

In some embodiments, the first PDSCH and/or the second PDSCH is/are practically transmitted PDSCH(s), and/or the first PDSCH and/or the second PDSCH has/have corresponding HARQ process(es).

In some embodiments, the at least one DCI includes first DCI and/or second DCI and/or third DCI, wherein the first DCI schedules a plurality of PDSCHs, the plurality of PDSCHs including at least one first PDSCH with a corresponding HARQ process that is feedback enabled and at least one second PDSCH with a corresponding HARQ process that is feedback disabled, the second DCI schedules a plurality of second PDSCHs, all of the plurality of second PDSCHs corresponding to an HARQ process that is HARQ feedback disabled, or the second DCI schedules one second PDSCH, the one second PDSCH corresponding to an HARQ process that is HARQ feedback disabled, and the third DCI schedules a plurality of first PDSCHs, all of the plurality of first PDSCHs corresponding to an HARQ process that is HARQ feedback enabled, or the third DCI schedules one first PDSCH, the one first PDSCH corresponding to an HARQ process that is HARQ feedback enabled.

In some embodiments, when the first receiving unit receives only at least one first DCI, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, and the HARQ feedback information of the second PDSCH is related to the decoding result of the second PDSCH.

In some embodiments, when the first receiving unit receives only at least one second DCI, the HARQ feedback information to which the PDSCH scheduled by the second DCI corresponds is related to the decoding result of the PDSCH scheduled by the second DCI, or, the HARQ feedback information to which the PDSCH scheduled by the second DCI corresponds is not related to the decoding result of the PDSCH scheduled by the second DCI.

In some embodiments, when the first receiving unit receives only at least one third DCI, the HARQ feedback information to which the PDSCH scheduled by the third DCI corresponds is related to the decoding result of the PDSCH scheduled by the third DCI.

In some embodiments, when the first receiving unit receives at least one first DCI and/or at least one second DCI and receives at least one third DCI, the HARQ feedback information to which the second PDSCH corresponds is not related to the decoding result of the second PDSCH, and the HARQ feedback information to which the first PDSCH corresponds is related to the decoding result of the first PDSCH, or, the HARQ feedback information to which the first PDSCH corresponds is related to the decoding result of the first PDSCH, and the HARQ feedback information to which the second PDSCH corresponds is related to the decoding result of the second PDSCH.

In some embodiments, when the terminal equipment is configured or activated with SPS, an HARQ-ACK process to which a PDSCH of the SPS (SPS PDSCH) corresponds is HARQ feedback disabled and the first receiving unit receives only at least one first DCI or receives only at least one third DCI, or when the terminal equipment is configured or activated with SPS, an HARQ-ACK process to which the SPS PDSCH corresponds is HARQ feedback disabled and the first receiving unit receives at least one first DCI and/or receives at least one second DCI, and also receives at least one third DCI,

HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH, or,

HARQ feedback information to which the SPS PDSCH corresponds is not related to the decoding result of the SPS PDSCH, the HARQ feedback information of the first PDSCH is related to the decoding result of the first PDSCH, and the HARQ feedback information of the second PDSCH is related to the decoding result of the second PDSCH, or,

HARQ feedback information to which the SPS PDSCH corresponds is related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.

In some embodiments, when the terminal equipment is configured or activated with SPS, an HARQ-ACK process to which a PDSCH of the SPS (SPS PDSCH) corresponds is HARQ feedback disabled and the first receiving unit receives only at least one second DCI,

HARQ feedback information to which the SPS PDSCH corresponds is related to the decoding result of the SPS PDSCH, and HARQ feedback information to which the PDSCH scheduled by the second DCI corresponds is related to the decoding result of the PDSCH scheduled by the second DCI, or, HARQ feedback information to which the SPS PDSCH corresponds is not related to the decoding result of the SPS PDSCH, and HARQ feedback information to which the PDSCH scheduled by the second DCI corresponds is not related to the decoding result of the second PDSCH.

In some embodiments, when the terminal equipment is configured or activated with SPS, an HARQ-ACK process to which a PDSCH of the SPS (SPS PDSCH) corresponds is HARQ feedback enabled and the first receiving unit receives only at least one first DCI or receives only at least one second DCI or receives only at least one third DCI, or when the terminal equipment is configured or activated with SPS, an HARQ-ACK process to which the SPS PDSCH corresponds is HARQ feedback enabled and the first receiving unit receives at least one first DCI and/or receives at least one second DCI, and also receives at least one third DCI,
the HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH.

In some embodiments, within a predetermined period of time before a time domain position corresponding to HARQ feedback timing to which the DCI corresponds, when the first receiving unit does not receive other DCI corresponding to the time domain position, it is indicated that the terminal equipment only receives the DCI.

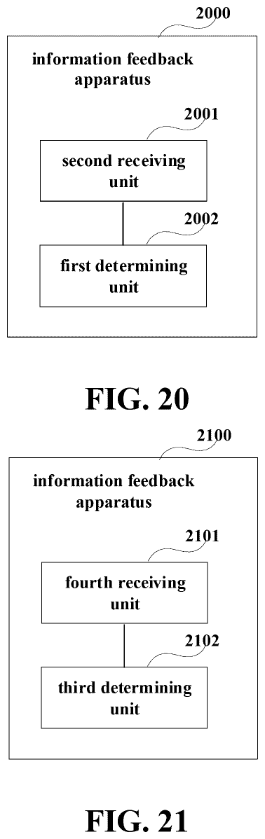

FIG. 20 is a schematic diagram of an information feedback apparatus of the embodiment of this disclosure. As shown in FIG. 20, an information feedback apparatus 1900 includes:
a second receiving unit 2001 configured to receive fourth downlink control information (DCI), the fourth DCI including counter DAI information and/or total DAI information; and
a first determining unit 2002 configured to determine HARQ feedback information according to the counter DAI information and/or the total DAI information.

In some embodiments, the counter DAI information and/or the total DAI information is/are counted for DCI used for scheduling a PDSCH by taking DCI as a granularity and/or a PDSCH as a granularity.

In some embodiments, for the DCI used to schedule the PDSCH, the counter DAI information and/or the total DAI information only count(s) DCI scheduling PDSCHs containing at least one PDSCH with a corresponding HARQ process that is feedback enabled.

In some embodiments, the counter DAI information and/or the total DAI information do/does not count DCI scheduling PDSCHs only containing PDSCH with corresponding HARQ process that is feedback disabled.

In some embodiments, the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.

In some embodiments, HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.

In some embodiments, that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.

In some embodiments, the counter DAI information and/or the total DAI information for the PDSCH scheduled by DCI only count(s) PDSCHs with a corresponding HARQ process that is feedback enabled.

In some embodiments, the counter DAI information and/or the total DAI information do/does not count PDSCHs with a corresponding HARQ process that is feedback disabled.

In some embodiments, HARQ feedback information to which a first PDSCH with an HARQ process to the PDSCH scheduled by the fourth DCI corresponds that is feedback disabled corresponds is related to the decoding result of the first PDSCH.

In some embodiments, the apparatus further includes:
a second transmitting unit (not shown) configured to transmit the HARQ feedback information at a time domain position to which the PDSCH corresponds for transmitting HARQ feedback information.

In some embodiments, the apparatus further includes:
a second determining unit (not shown) configured to determine the time domain position for transmitting the HARQ feedback information according to a time domain position where a last PDSCH scheduled by the DCI with a corresponding HARQ process that is HARQ feedback enabled is located.

In some embodiments, the second determining unit determines the time domain position for transmitting the HARQ feedback information according to the time domain position where the last PDSCH scheduled by the DCI with the corresponding HARQ process that is HARQ feedback enabled is located and HARQ feedback timing.

In some embodiments, the HARQ feedback timing indicates a time domain offset between the time domain position where the last PDSCH scheduled by the DCI with the corresponding HARQ process that is HARQ feedback enabled is located and the time domain position for transmitting the HARQ feedback information.

In some embodiments, the fourth DCI includes a first information field, the first information field being used to indicate the HARQ feedback timing, or the apparatus further includes:
a third receiving unit (not shown) configured to receive higher layer signaling, the higher layer signaling being used to indicate the HARQ feedback timing.

In some embodiments, the fourth DCI is used to schedule PDSCHs and/or PUSCHs.

In some embodiments, the fourth DCI is used to schedule PDSCHs, the PDSCHs scheduled by the DCI including PDSCHs with a corresponding HARQ process that is feedback enabled or feedback disabled.

In some embodiments, the fourth DCI does not schedule data transmission.

In some embodiments, the fourth DCI schedules one or a plurality of PDSCHs, and a PDSCH time domain resource allocation table applied by the fourth DCI supports one DCI scheduling a plurality of PDSCHs.

FIG. 21 is a schematic diagram of an information feedback apparatus of the embodiment of this disclosure. As shown in FIG. 21, the information feedback apparatus 2100 includes:
a fourth receiving unit 2101 configured to receive DCI for scheduling PDSCHs;
a third determining unit 2102 configured to, according to the time domain position where the last PDSCH scheduled by the DCI with the corresponding HARQ process that is HARQ feedback enabled is located, determine the time domain position of the HARQ feedback information of the PDSCH scheduled by the DCI; and
a second transmitting unit 2103 configured to transmit the HARQ feedback information of the PDSCH scheduled by the DCI at the determined time domain position.

In some embodiments, the third determining unit determines the time domain position of the HARQ feedback information of the PDSCH scheduled by the DCI according to the time domain position where the last PDSCH scheduled by the DCI with the corresponding HARQ process that is HARQ feedback enabled is located and HARQ feedback timing.

In some embodiments, the HARQ feedback timing indicates a time domain offset between the time domain position where the last PDSCH scheduled by the DCI with the corresponding HARQ process that is HARQ feedback enabled is located and the time domain position for transmitting the HARQ feedback information of the PDSCH scheduled by the DCI.

In some embodiments, the DCI includes a first information field, the first information field being used to indicate the HARQ feedback timing, or the apparatus further includes:
a fifth receiving unit (not shown) configured to receive higher layer signaling, the higher-layer signaling being used to indicate the HARQ feedback timing.

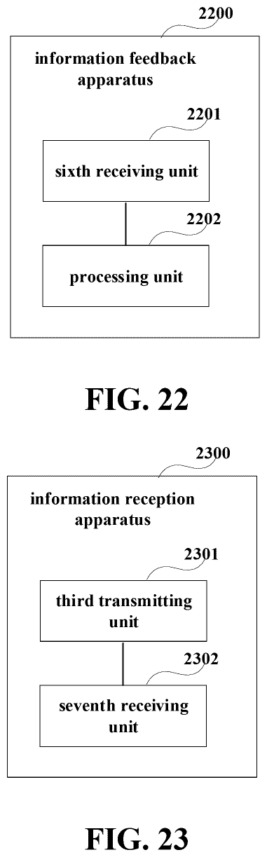

FIG. 22 is a schematic diagram of an information feedback apparatus of the embodiment of this disclosure. As shown in FIG. 22, an information feedback apparatus 2200 includes:
a sixth receiving unit 2201 configured to receive a PDSCH, an HARQ process to which the PDSCH corresponds is feedback disabled; and
a processing unit 2202 configured not to transmit an HARQ feedback codebook at a time domain position for transmitting an HARQ feedback codebook to which the PDSCH corresponds.

In some embodiments, the time domain position corresponds only to the PDSCH.

In some embodiments, that the time domain position corresponds only to the PDSCH includes: there existing no other downlink transmission corresponding to the time domain position before a predetermined time of the time domain position.

In some embodiments, the processing unit determines that the time domain position corresponds only to the PDSCH according to C-DAI and/or T-DAI in the DCI, and/or determines that the time domain position corresponds only to the PDSCH according to SPS configuration and/or an active state.

In some embodiments, the processing unit determines not to transmit the HARQ feedback codebook at the time domain position for transmitting an HARQ feedback codebook to which the PDSCH corresponds according to the C-DAI and/or T-DAI in the DCI, and/or, not to transmit the HARQ feedback codebook at the time domain position for transmitting an HARQ feedback codebook to which the PDSCH corresponds according to SPS configuration and/or an active state.

In some embodiments, the processing unit does not generate an HARQ feedback codebook to which the PDSCH corresponds.

In some embodiments, the PDSCH includes a PDSCH scheduled by the DCI and/or an SPS PDSCH.

In some embodiments, a plurality of PDSCHs in the PDSCH are scheduled by the same DCI.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information feedback apparatuses 1900-2200 may further include other components or modules, and reference may be made to related techniques for particulars of these components or modules.

Furthermore, for the sake of simplicity, connection relationships between the components or modules or signal profiles thereof are only illustrated in FIGS. 19-22. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the HARQ information is transmitted or not transmitted in the case where the HARQ mechanism of the HARQ feedback enables/disables is supported. Hence, uplink control signaling overhead may be lowered, and also, the network device may transmit new data without needing to wait for the terminal equipment to report the HARQ feedback information, thereby reducing data transmission latency.

### Embodiment of a Seventh Aspect

The embodiment of this disclosure provides an information reception apparatus. The apparatus may be, for example, a network device, or may be one or more components or assemblies configured in a network device. Contents in this embodiment identical to those in the embodiment of the fifth aspect shall not be described herein any further.

FIG. 23 is a schematic diagram of an information reception apparatus of the embodiment of this disclosure. As shown in FIG. 23, an information reception apparatus 2300 includes:
a third transmitting unit 2301 configured to transmit at least one downlink control information (DCI) for scheduling a physical downlink shared channel (PDSCH) to a terminal equipment, the DCI scheduling one or a plurality of PDSCHs, wherein the one or the plurality of PDSCHs include at least one PDSCH with a corresponding HARQ process that is feedback enabled or feedback disabled; and
a seventh receiving unit 2302 configured to receive HARQ feedback information for the one or the plurality of PDSCHs transmitted by the terminal equipment.

In some embodiments, when the PDSCHs scheduled by the DCI include a second PDSCH with a corresponding HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.

In some embodiments, that HARQ feedback information to which the second PDSCH corresponds is not related to a decoding result of the second PDSCH includes that the HARQ feedback information to which the second PDSCH corresponds is NACK.

In some embodiments, when the PDSCH scheduled by the DCI includes a first PDSCH with a corresponding HARQ process that is feedback enabled, HARQ feedback information to which the first PDSCH corresponds is related to a decoding result of the first PDSCH.

In some embodiments, when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.

In some embodiments, that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS

PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.

In some embodiments, that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.

In some embodiments, the seventh receiving unit receives the HARQ feedback information at a time domain position corresponding to the one or the plurality of PDSCHs and used for transmitting HARQ feedback information.

In some embodiments, feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.

In some embodiments, the first PDSCH and/or the second PDSCH is/are practically transmitted PDSCH(s), and/or the first PDSCH and/or the second PDSCH has/have corresponding HARQ process(es).

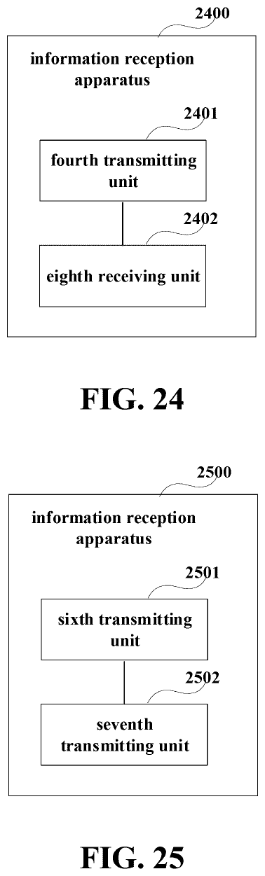

FIG. 24 is another schematic diagram of an information reception apparatus of the embodiment of this disclosure. As shown in FIG. 24, an information reception apparatus 2400 includes:

a fourth transmitting unit 2401 configured to transmit fourth DCI to a terminal equipment, the fourth DCI including counter DAI information and/or total DAI information; and

an eighth receiving unit 2402 configured to receive HARQ feedback information determined according to the counter DAI information and/or the total DAI information transmitted by the terminal equipment.

In some embodiments, the counter DAI information and/or the total DAI information is/are counted for DCI used for scheduling a PDSCH by taking DCI as a granularity and/or a PDSCH as a granularity.

In some embodiments, for the DCI used to schedule the PDSCH, the counter DAI information and/or the total DAI information only count(s) DCI scheduling PDSCHs containing at least one PDSCH with a corresponding HARQ process that is feedback enabled.

In some embodiments, the counter DAI information and/or the total DAI information do/does not count DCI scheduling PDSCHs only containing PDSCH with corresponding HARQ process that is feedback disabled.

In some embodiments, the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.

In some embodiments, HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.

In some embodiments, that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.

In some embodiments, the counter DAI information and/or the total DAI information for the PDSCH scheduled by DCI only count(s) PDSCHs with a corresponding HARQ process that is feedback enabled.

In some embodiments, the counter DAI information and/or the total DAI information do/does not count PDSCHs with a corresponding HARQ process that is feedback disabled.

In some embodiments, HARQ feedback information to which a first PDSCH with an HARQ process to the PDSCH scheduled by the fourth DCI corresponds that is feedback disabled corresponds is related to the decoding result of the first PDSCH.

In some embodiments, the eighth receiving unit receives the HARQ feedback information at a time domain position corresponding to the PDSCH and used for transmitting HARQ feedback information.

In some embodiments, the time domain position for transmitting the HARQ feedback information is determined according to a time domain position of a last PDSCH scheduled by the DCI with a corresponding HARQ process that is HARQ feedback enabled.

In some embodiments, the time domain position for transmitting the HARQ feedback information is determined according to a time domain position of a last PDSCH scheduled by the DCI with a corresponding HARQ process that is HARQ feedback enabled and HARQ feedback timing.

In some embodiments, the HARQ feedback timing indicates a time domain offset between the time domain position of the last PDSCH with a corresponding HARQ process that is HARQ feedback enabled scheduled by the DCI and the time domain position transmitting the HARQ feedback information.

In some embodiments, the fourth DCI includes a first information field, the first information field being used to indicate the HARQ feedback timing, or the apparatus further includes:
a fifth transmitting unit (not shown) configured to transmit higher layer signaling, the higher layer signaling being used to indicate the HARQ feedback timing.

In some embodiments, the fourth DCI is used to schedule PDSCHs and/or PUSCHs.

In some embodiments, the fourth DCI is used to schedule PDSCHs, the PDSCHs scheduled by the DCI including PDSCHs with a corresponding HARQ process that is feedback enabled or feedback disabled.

In some embodiments, the fourth DCI does not schedule data transmission.

In some embodiments, the fourth DCI schedules one or a plurality of PDSCHs, and a PDSCH time domain resource allocation table applied by the fourth DCI supports one DCI scheduling a plurality of PDSCHs.

FIG. 25 is a further schematic diagram of an information reception apparatus of the embodiment of this disclosure. As shown in FIG. 25, an information reception apparatus 2500 includes:
a sixth transmitting unit 2501 configured to transmit DCI for scheduling PDSCH; and
a seventh transmitting unit 2502 configured to, at a time domain position for transmitting the HARQ feedback information of the PDSCH scheduled by the DCI, receive HARQ feedback information of the PDSCH scheduled by the DCI transmitted by the terminal equipment, the time domain position being determined according to a time domain position where a last PDSCH scheduled by the DCI with a corresponding HARQ process that is HARQ feedback enabled is located.

In some embodiments, the time domain position is determined according to a time domain position of a last PDSCH scheduled by the DCI with a corresponding HARQ process that is HARQ feedback enabled and HARQ feedback timing.

In some embodiments, the HARQ feedback timing indicates a time domain offset between the time domain position of the last PDSCH with a corresponding HARQ process that is HARQ feedback enabled scheduled by the DCI and the time domain position transmitting the HARQ feedback information.

In some embodiments, the DCI includes a first information field, the first information field being used to indicate the HARQ feedback timing, or the apparatus further includes:

an eighth transmitting unit (not shown) configured to transmit higher layer signaling, the higher layer signaling being used to indicate the HARQ feedback timing.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information reception apparatuses 2300-2500 may further include other components or modules, and reference may be made to related techniques for particulars of these components or modules.

Furthermore, for the sake of simplicity, connection relationships between the components or modules or signal profiles thereof are only illustrated in FIGS. 23-25. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the HARQ information is transmitted or not transmitted in the case where HARQ mechanism of the HARQ feedback enables/disables is supported. Hence, uplink control signaling overhead may be lowered, and also, the network device may transmit new data without needing to wait for the terminal equipment to report the HARQ feedback information, thereby reducing data transmission latency.

### Embodiment of an Eighth Aspect

The embodiment of this disclosure provides a communication system, and reference may be made to FIG. 1, with contents identical to those in the embodiments of the first to the fourth aspects being not going to be described herein any further.

In some embodiments, the communication system 100 may at least include: a terminal equipment 102 and a network device 101.

In some embodiments, reference may be made to the terminal equipment 1100 for implementation of the terminal equipment 102, and reference may be made to the network device 100 for implementation of the network device, which shall not be repeated herein any further.

The embodiment of this disclosure further provides a network device, which may be, for example, a base station. However, this disclosure is not limited thereto, and it may also be another network device.

FIG. 27 is a schematic diagram of a structure of the network device of the embodiment of this disclosure. As shown in FIG. 27, a network device 2700 may include a processor 2710 (such as a central processing unit (CPU)) and a memory 2720, the memory 2720 being coupled to the processor 2710. The memory 2720 may store various data, and furthermore, it may store a program 2730 for information processing, and execute the program 2730 under control of the processor 2710.

For example, the processor 2710 may be configured to execute a program to carry out the information reception method described in the embodiment of the fifth aspect.

Furthermore, as shown in FIG. 27, the network device 2700 may include a transceiver 2740, and an antenna 2750, etc. Functions of the above components are similar to those in the related art, and shall not be described herein any further. It should be noted that the network device 2700 does not necessarily include all the parts shown in FIG. 27, and furthermore, the network device 2700 may include parts not shown in FIG. 10, and the related art may be referred to.

The embodiment of this disclosure further provides a terminal equipment; however, this disclosure is not limited thereto, and it may also be another equipment.

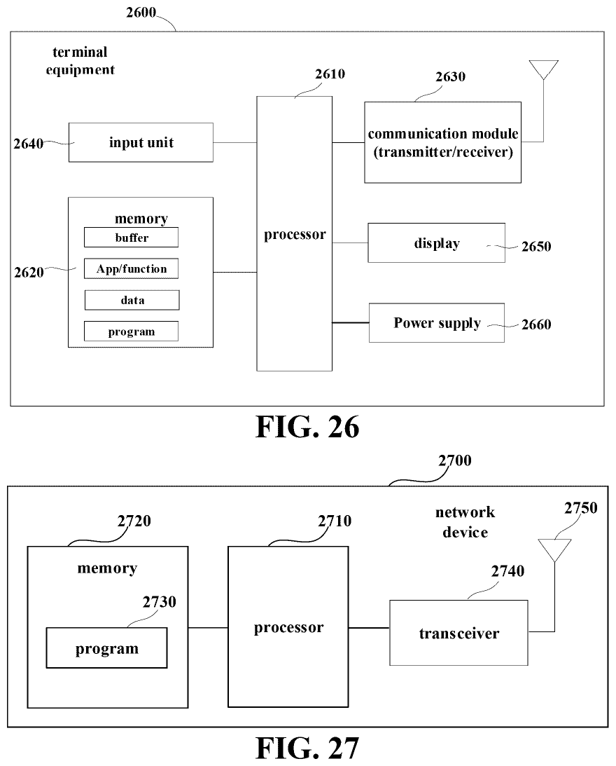

FIG. 26 is a schematic diagram of the terminal equipment of the embodiment of this disclosure. As shown in FIG. 26, a terminal equipment 2600 may include a processor 2610 and a memory 2620, the memory 2620 storing data and a program and being coupled to the processor 2610. It should be noted that this figure is illustrative only, and other types of structures may also be used, so as to supplement or replace this structure and achieve a telecommunications function or other functions.

For example, the processor 2610 may be configured to execute a program to carry out the information feedback method as described in the embodiment of the first or the second or the third or the fourth aspect.

As shown in FIG. 26, the terminal equipment 2600 may further include a communication module 2630, an input unit 2640, a display 2650, and a power supply 2660, wherein functions of the above components are similar to those in the related art, which shall not be described herein any further. It should be noted that the terminal equipment 2600 does not necessarily include all the parts shown in FIG. 26, and the above components are not necessary. Furthermore, the terminal equipment 2600 may include parts not shown in FIG. 26, and the related art may be referred to.

An embodiment of this disclosure provides a computer readable program, which, when executed in a terminal equipment, causes the terminal equipment to carry out the information feedback method as described in the embodiment of the first or the second or the third or the fourth aspect.

An embodiment of this disclosure provides a computer storage medium, including a computer readable program, which causes a terminal equipment to carry out the information feedback method as described in the embodiment of the first or the second or the third or the fourth aspect.

An embodiment of this disclosure provides a computer readable program, which, when executed in a network device, causes the network device to carry out the information reception method as described in the embodiment of the fifth aspect.

An embodiment of this disclosure provides a computer storage medium, including a computer readable program, which causes a network device to carry out the information reception method as described in the embodiment of the fifth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.
1. An information feedback method, applicable to terminal equipment, characterized in that the method includes:
receiving at least one downlink control information (DCI) used for scheduling a physical downlink shared channel (PDSCH) by the terminal equipment, the DCI scheduling one or a plurality of PDSCHs, wherein the one or the plurality of PDSCHs include at least one PDSCH with a corresponding HARQ process that is feedback enabled or feedback disabled; and
transmitting HARQ feedback information for the one or the plurality of PDSCHs by the terminal equipment.
2. The method according to supplement 1, wherein when the PDSCH scheduled by the DCI includes a second PDSCH with an HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.
3. The method according to supplement 2, wherein that HARQ feedback information to which the second PDSCH corresponds is not related to a decoding result of the second PDSCH includes that the HARQ feedback information to which the second PDSCH corresponds is NACK.
4. The method according to supplement 1, wherein when the PDSCH scheduled by the DCI includes a first PDSCH with a corresponding HARQ process that is feedback enabled, HARQ feedback information to which the first PDSCH corresponds is related to a decoding result of the first PDSCH.
5. The method according to any one of supplements 1-4, wherein when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.
6. The method according to supplement 5, wherein that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.
7. The method according to supplement 5, wherein that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.
8. The method according to any one of supplements 1-7, wherein the terminal equipment transmits the HARQ feedback information at a time domain position corresponding to the one or the plurality of PDSCHs and used for transmitting HARQ feedback information.
8a. The method according to any one of supplements 1-8, wherein feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.
9. The method according to any one of supplements 2-8a, wherein the first PDSCH and/or the second PDSCH is/are practically transmitted PDSCH(s), and/or the first PDSCH and/or the second PDSCH has/have corresponding HARQ process(es).
10. The method according to any one of supplements 1-9, wherein the at least one DCI includes first DCI and/or second DCI and/or third DCI, wherein the first DCI schedules a plurality of PDSCHs, the plurality of PDSCHs including at least one first PDSCH with a corresponding HARQ process that is feedback enabled and at least one second PDSCH with a corresponding HARQ process that is feedback disabled, the second DCI schedules a plurality of second PDSCHs, all of the plurality of second PDSCHs corresponding to an HARQ process that is HARQ feedback disabled, or the second DCI schedules one second PDSCH, the one second PDSCH corresponding to an HARQ process that is HARQ feedback disabled, and the third DCI schedules a plurality of first PDSCHs, all of the plurality of first PDSCHs corresponding to an HARQ process that is HARQ feedback enabled, or the third DCI schedules one first PDSCH, the one first PDSCH corresponding to an HARQ process that is HARQ feedback enabled.
11. The method according to supplement 10, wherein when only at least one first DCI is received, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, and the HARQ feedback information of the second PDSCH is related to the decoding result of the second PDSCH.
12. The method according to supplement 10, wherein when only at least one second DCI is received, the HARQ feedback information to which the PDSCH scheduled by the second DCI corresponds is related to the decoding result of the PDSCH scheduled by the second DCI, or, the HARQ feedback information to which the PDSCH scheduled by the second DCI corresponds is not related to the decoding result of the PDSCH scheduled by the second DCI.
13. The method according to supplement 10, wherein when only at least one third DCI is received, the HARQ feedback information to which the PDSCH scheduled by the third DCI corresponds is related to the decoding result of the PDSCH scheduled by the third DCI.
14. The method according to supplement 10, wherein when at least one first DCI and/or at least one second DCI is/are received and at least one third DCI is received, the HARQ feedback information to which the second PDSCH corresponds is not related to the decoding result of the second PDSCH, and the HARQ feedback information to which the first PDSCH corresponds is related to the decoding result of the first PDSCH, or, the HARQ feedback information to which the first PDSCH corresponds is related to the decoding result of the first PDSCH, and the HARQ feedback information to which the second PDSCH corresponds is related to the decoding result of the second PDSCH.
15. The method according to supplement 10, wherein when the terminal equipment is configured or activated with SPS, an HARQ-ACK process to which a PDSCH of the SPS (SPS PDSCH) corresponds is HARQ feedback disabled and only at least one first DCI is received or only at least one third DCI is received, or when the terminal equipment is configured or activated with SPS, an HARQ-ACK process to which the SPS PDSCH corresponds is HARQ feedback disabled and at least one first DCI is received and/or at least one second DCI is received, and at least one third DCI is also received,
HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH, or,
HARQ feedback information to which the SPS PDSCH corresponds is not related to the decoding result of the SPS PDSCH, the HARQ feedback information of the first PDSCH is related to the decoding result of the first PDSCH, and the HARQ feedback information of the second PDSCH is related to the decoding result of the second PDSCH, or,
HARQ feedback information to which the SPS PDSCH corresponds is related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.
16. The method according to supplement 10, wherein when the terminal equipment is configured or activated with SPS, an HARQ-ACK process to which a PDSCH of the SPS (SPS PDSCH) corresponds is HARQ feedback disabled and only at least one first DCI is received,
HARQ feedback information to which the SPS PDSCH corresponds is related to the decoding result of the SPS PDSCH, and HARQ feedback information to which the PDSCH scheduled by the second DCI corresponds is related to the decoding result of the PDSCH scheduled by the second DCI, or, HARQ feedback information to which the SPS PDSCH corresponds is not related to the decoding result of the SPS PDSCH, and HARQ feedback information to which the PDSCH scheduled by the second DCI corresponds is not related to the decoding result of the second PDSCH.
17. The method according to supplement 10, wherein when the terminal equipment is configured or activated with SPS, an HARQ-ACK process to which a PDSCH of the SPS (SPS PDSCH) corresponds is HARQ feedback enabled and only at least one first DCI is received or only at least one second DCI is received or only at least one third DCI is received, or when the terminal equipment is configured or activated with SPS, an HARQ-ACK process to which the SPS PDSCH corresponds is HARQ feedback enabled and at least one first DCI is received and/or at least one second DCI is received, and at least one third DCI is also received,
the HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH.
18. The method according to any one of supplements 11-17, wherein when the terminal equipment does not receive other DCI corresponding to the time domain position within a predetermined period of time before a time domain position corresponding to HARQ feedback timing to which the DCI corresponds, it is indicated that the terminal equipment only receives the DCI.
19. An information feedback method, applicable to a terminal equipment, characterized in that the method includes:
receiving fourth downlink control information (DCI) by the terminal equipment, the fourth DCI including counter DAI information and/or total DAI information; and
determining HARQ feedback information by the terminal equipment according to the counter DAI information and/or the total DAI information.
20. The method according to supplement 19, wherein the counter DAI information and/or the total DAI information is/are counted for DCI used for scheduling a PDSCH by taking DCI as a granularity and/or a PDSCH as a granularity.
21. The method according to supplement 19 or 20, wherein in counting at a granularity of DCI, for the DCI used to schedule one or a plurality of PDSCH, the counter DAI information and/or the total DAI information only count(s) DCI scheduling PDSCHs containing at least one PDSCH with a corresponding HARQ process that is feedback enabled.
22. The method according to any one of supplements 19-21, wherein in counting at a granularity of DCI, the counter DAI information and/or the total DAI information do/does not count DCI scheduling PDSCHs only containing PDSCH with corresponding HARQ process that is feedback disabled.
23. The method according to any one of supplements 19-21, wherein the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.
24. The method according to supplement 23, wherein HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.
25. The method according to supplement 24, wherein that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.
26. The method according to supplement 19 or 20, wherein in counting at a granularity of PDSCH, the counter DAI information and/or the total DAI information for the PDSCH scheduled by DCI only counts PDSCHs with a corresponding HARQ process that is feedback enabled.
27. The method according to supplement 19 or 20 or 26, wherein in counting at a granularity of PDSCH, the counter DAI information and/or the total DAI information do/does not count PDSCHs with a corresponding HARQ process that is feedback disabled.
28. The method according to supplement 26 or 27, wherein HARQ feedback information to which a first PDSCH with an HARQ process to the PDSCH scheduled by the fourth DCI corresponds that is feedback disabled corresponds is related to the decoding result of the first PDSCH.
29. The method according to any one of supplements 19-28, wherein the method further includes:
transmitting the HARQ feedback information by the terminal equipment at a time domain position to which the PDSCH corresponds for transmitting HARQ feedback information.
30. The method according to supplement 29, wherein the terminal equipment determines the time domain position for transmitting the HARQ feedback information according to a time domain position where a last PDSCH scheduled by the DCI with a corresponding HARQ process that is HARQ feedback enabled is located.
31. The method according to supplement 29 or 30, wherein the terminal equipment determines the time domain position for transmitting the HARQ feedback information according to the time domain position where the last PDSCH scheduled by the DCI with the corresponding HARQ process that is HARQ feedback enabled is located and HARQ feedback timing.
32. The method according to supplement 31, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
33. The method according to supplement 31 or 32, wherein the fourth DCI includes a first information field, the first information field being used to indicate the HARQ feedback timing, or the method further includes:
receiving higher-layer signaling by the terminal equipment, the higher-layer signaling being used to indicate the HARQ feedback timing.
34. The method according to any one of supplements 19-33, wherein the fourth DCI is used to schedule PDSCHs and/or PUSCHs.
35. The method according to any one of supplements 19-34, wherein the fourth DCI is used to schedule PDSCHs, the PDSCHs scheduled by the DCI including PDSCHs with a corresponding HARQ process that is feedback enabled or feedback disabled.
36. The method according to any one of supplements 19-33, wherein the fourth DCI does not schedule data transmission.
37. The method according to supplement 35, wherein the fourth DCI schedules one or a plurality of PDSCHs, and a PDSCH time domain resource allocation table applied by the fourth DCI supports one DCI scheduling a plurality of PDSCHs.
HARQ timing
38. An information feedback method, applicable to a terminal equipment, characterized in that the method includes:
receiving DCI for scheduling PDSCHs by the terminal equipment;
according to the time domain position where the last PDSCH scheduled by the DCI with the corresponding HARQ process that is HARQ feedback enabled is located, determining the time domain position of the HARQ feedback information of the PDSCH scheduled by the DCI by the terminal equipment; and
transmitting the HARQ feedback information of the PDSCH scheduled by the DCI by the terminal equipment at the determined time domain position.
39. The method according to supplement 38, wherein the terminal equipment determines the time domain position of the HARQ feedback information of the PDSCH scheduled by the DCI according to the time domain position where the last PDSCH scheduled by the DCI with the corresponding HARQ process that is HARQ feedback enabled is located and HARQ feedback timing.
40. The method according to supplement 39, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information of the PDSCH scheduled by the DCI.
41. The method according to supplement 39 or 40, wherein the DCI includes a first information field, the first information field being used to indicate the HARQ feedback timing, or the method further includes:
receiving higher-layer signaling by the terminal equipment, the higher-layer signaling being used to indicate the HARQ feedback timing.
42. An information feedback method, applicable to a terminal equipment, characterized in that the method includes:
receiving a PDSCH by the terminal equipment, an HARQ process to which the PDSCH corresponds is feedback disabled;
not transmitting an HARQ feedback codebook by the terminal equipment at a time domain position for transmitting an HARQ feedback codebook to which the PDSCH corresponds.
43. The method according to supplement 42, wherein the time domain position corresponds only to the PDSCH.
44. The method according to supplement 43, wherein that the time domain position corresponds only to the PDSCH includes: there existing no other downlink transmission corresponding to the time domain position before a predetermined time of the time domain position.
45. The method according to supplement 42, wherein the terminal equipment determines that the time domain position corresponds only to the PDSCH according to C-DAI and/or T-DAI in the DCI, and/or the terminal equipment determines that the time domain position corresponds only to the PDSCH according to SPS configuration and/or an active state.
46. The method according to supplement 42 or 45, wherein the terminal equipment determines not to transmit the HARQ feedback codebook at the time domain position for transmitting an HARQ feedback codebook to which the PDSCH corresponds according to the C-DAI and/or T-DAI in the DCI, and/or, the terminal equipment determines not to transmit the HARQ feedback codebook at the time domain position for transmitting an HARQ feedback codebook to which the PDSCH corresponds according to SPS configuration and/or an active state.
47. The method according to any one of supplements 42-46, wherein the method further includes:
not generating an HARQ feedback codebook to which the PDSCH corresponds by the terminal equipment.
48. The method according to any one of supplements 42-47, wherein the PDSCH includes a PDSCH scheduled by the DCI and/or an SPS PDSCH.
49. The method according to any one of supplements 42-48, wherein a plurality of PDSCHs in the PDSCH are scheduled by the same DCI.
50. An information reception method, applicable to a network device, characterized in that the method includes:
transmitting at least one downlink control information (DCI) for scheduling a physical downlink shared channel (PDSCH) by the network device to a terminal equipment, the DCI scheduling one or a plurality of PDSCHs, wherein the one or the plurality of PDSCHs include at least one PDSCH with a corresponding HARQ process that is feedback enabled or feedback disabled; and
receiving, by the network device, HARQ feedback information for one or a plurality of PDSCHs transmitted by the terminal equipment.
51. The method according to supplement 50, wherein when the PDSCH scheduled by the DCI includes a second PDSCH with an HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.
52. The method according to supplement 51, wherein that HARQ feedback information to which the second PDSCH corresponds is not related to a decoding result of the second PDSCH includes that the HARQ feedback information to which the second PDSCH corresponds is NACK.
53. The method according to supplement 50, wherein when the PDSCH scheduled by the DCI includes a first PDSCH with a corresponding HARQ process that is feedback enabled, HARQ feedback information to which the first PDSCH corresponds is related to a decoding result of the first PDSCH.
54. The method according to any one of supplements 50-53, wherein when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.
55. The method according to supplement 54, wherein that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.
56. The method according to supplement 54, wherein that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.
57. The method according to any one of supplements 49-56, wherein the network device receives the HARQ feedback information at a time domain position for transmitting HARQ feedback information to which the one or the plurality of PDSCHs correspond.
58. The method according to any one of supplements 50-57, wherein feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.
59. The method according to any one of supplements 51-58, wherein the first PDSCH and/or the second PDSCH is/are practically transmitted PDSCH(s), and/or the first PDSCH and/or the second PDSCH has/have corresponding HARQ process(es).
60. An information reception method, applicable to a network device, characterized in that the method includes:
transmitting fourth DCI by the network device to a terminal equipment, the fourth DCI including counter DAI information and/or total DAI information; and
receiving, by the network device, HARQ feedback information determined according to the counter DAI information and/or the total DAI information transmitted by the terminal equipment.
61. The method according to supplement 60, wherein the counter DAI information and/or the total DAI information is/are counted for DCI used for scheduling a PDSCH by taking DCI as a granularity and/or a PDSCH as a granularity.
62. The method according to supplement 60 or 61, wherein in counting by taking DCI as a granularity, for the DCI used to schedule one or a plurality of PDSCH, the counter DAI information and/or the total DAI information only count(s) DCI scheduling PDSCHs containing at least one PDSCH with a corresponding HARQ process that is feedback enabled.
63. The method according to any one of supplements 60-62, wherein in counting by taking DCI as a granularity, the counter DAI information and/or the total DAI information do/does not count DCI scheduling PDSCHs only containing PDSCH with corresponding HARQ process that is feedback disabled.
64. The method according to any one of supplements 60-62, wherein the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.
65. The method according to supplement 64, wherein HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.
66. The method according to supplement 65, wherein that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.
67. The method according to supplement 60 or 61, wherein the counter DAI information and/or the total DAI information for the PDSCH scheduled by DCI only count(s) PDSCHs with a corresponding HARQ process that is feedback enabled.
68. The method according to supplement 60 or 61 or 67, wherein in counting by taking PDSCH as a granularity, the counter DAI information and/or the total DAI information do/does not count PDSCHs with a corresponding HARQ process that is feedback disabled.
69. The method according to supplement 67 or 68, wherein HARQ feedback information to which a first PDSCH with an HARQ process to the PDSCH scheduled by the fourth DCI corresponds that is feedback disabled corresponds is related to the decoding result of the first PDSCH.
70. The method according to any one of supplements 60-69, wherein the network device receives the HARQ feedback information at a time domain position for transmitting HARQ feedback information to which the PDSCH corresponds.
71. The method according to supplement 60, wherein the time domain position for transmitting the HARQ feedback information is determined according to the time domain position where the last PDSCH scheduled by the DCI with the corresponding HARQ process that is HARQ feedback enabled is located and HARQ feedback timing.
72. The method according to supplement 60 or 71, wherein the time domain position for transmitting the HARQ feedback information is determined according to the time domain position where the last PDSCH scheduled by the DCI with the corresponding HARQ process that is HARQ feedback enabled is located and HARQ feedback timing.
73. The method according to supplement 72, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
74. The method according to supplement 72 or 73, wherein the fourth DCI includes a first information field, the first information field being used to indicate the HARQ feedback timing, or the method further includes:
transmitting higher-layer signaling by the network device to the terminal equipment, the higher-layer signaling being used to indicate the HARQ feedback timing.
75. The method according to any one of supplements 60-74, wherein the fourth DCI is used to schedule PDSCHs and/or PUSCHs.
76. The method according to any one of supplements 60-75, wherein the fourth DCI is used to schedule PDSCHs, the PDSCHs scheduled by the DCI including PDSCHs with a corresponding HARQ process that is feedback enabled or feedback disabled.
77. The method according to any one of supplements 60-74, wherein the fourth DCI does not schedule data transmission.
78. The method according to supplement 76, wherein the fourth DCI schedules one or a plurality of PDSCHs, and a PDSCH time domain resource allocation table applied by the fourth DCI supports one DCI scheduling a plurality of PDSCHs.
79. An information reception method, applicable to a network device, characterized in that the method includes:
transmitting DCI for scheduling PDSCH by the network device; and
at a time domain position for transmitting the HARQ feedback information of the PDSCH scheduled by the DCI, receiving, by the network device, HARQ feedback information of the PDSCH scheduled by the DCI transmitted by the terminal equipment, the time domain position being determined according to a time domain position where a last PDSCH scheduled by the DCI with a corresponding HARQ process that is HARQ feedback enabled is located.
80. The method according to supplement 79, wherein the time domain position for transmitting the HARQ feedback information is determined according to the time domain position where the last PDSCH scheduled by the DCI with the corresponding HARQ process that is HARQ feedback enabled is located and HARQ feedback timing.
81. The method according to supplement 79, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
82. The method according to supplement 79 or 80, wherein the DCI includes a first information field, the first information field being used to indicate the HARQ feedback timing, or the method further includes:
transmitting higher-layer signaling by the network device, the higher-layer signaling being used to indicate the HARQ feedback timing.
83. A terminal equipment, including a memory and a processor, the memory storing a computer program, and the processor being configured to execute the computer program to carry out the information feedback method as described in any one of supplements 1-49.
84. A network device, including a memory and a processor, the memory storing a computer program, and the processor being configured to execute the computer program to carry out the information reception method as described in any one of supplements 50-82.
85. A communication system, including:
the terminal equipment as described in supplement 82, and/or the network device as described in supplement 84.

As to implementations containing the above embodiments, following supplements are further disclosed.
1. An information feedback apparatus, applicable to terminal equipment, characterized in that the apparatus includes:
a first receiving unit configured to receive at least one downlink control information (DCI) used for scheduling a physical downlink shared channel (PDSCH), the DCI scheduling one or a plurality of PDSCHs, wherein the one or the plurality of PDSCHs include at least one PDSCH with a corresponding HARQ process that is feedback enabled or feedback disabled; and
a first transmitting unit configured to transmit HARQ feedback information for the one or the plurality of PDSCHs.
2. The apparatus according to supplement 1, wherein when the PDSCH scheduled by the DCI includes a second PDSCH with an HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.
3. The apparatus according to supplement 2, wherein that HARQ feedback information to which the second PDSCH corresponds is not related to a decoding result of the second PDSCH includes that the HARQ feedback information to which the second PDSCH corresponds is NACK.
4. The apparatus according to supplement 1, wherein when the PDSCH scheduled by the DCI includes a first PDSCH with a corresponding HARQ process that is feedback enabled, HARQ feedback information to which the first PDSCH corresponds is related to a decoding result of the first PDSCH.
5. The apparatus according to any one of supplements 1-4, wherein when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.
6. The apparatus according to supplement 5, wherein that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.
7. The apparatus according to supplement 5, wherein that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.
8. The apparatus according to any one of supplements 1-7, wherein the terminal equipment transmits the HARQ feedback information at a time domain position corresponding to the one or the plurality of PDSCHs and used for transmitting HARQ feedback information.
8a. The apparatus according to any one of supplements 1-8, wherein feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.
9. The apparatus according to any one of supplements 2-8a, wherein the first PDSCH and/or the second PDSCH is/are practically transmitted PDSCH(s), and/or the first PDSCH and/or the second PDSCH has/have corresponding HARQ process(es).
10. The apparatus according to any one of supplements 1-9, wherein the at least one DCI includes first DCI and/or second DCI and/or third DCI, wherein the first DCI schedules a plurality of PDSCHs, the plurality of PDSCHs including at least one first PDSCH with a corresponding HARQ process that is feedback enabled and at least one second PDSCH with a corresponding HARQ process that is feedback disabled, the second DCI schedules a plurality of second PDSCHs, all of the plurality of second PDSCHs corresponding to an HARQ process that is HARQ feedback disabled, or the second DCI schedules one second PDSCH, the one second PDSCH corresponding to an HARQ process that is HARQ feedback disabled, and the third DCI schedules a plurality of first PDSCHs, all of the plurality of first PDSCHs corresponding to an HARQ process that is HARQ feedback enabled, or the third DCI schedules one first PDSCH, the one first PDSCH corresponding to an HARQ process that is HARQ feedback enabled.
11. The apparatus according to supplement 10, wherein when the first receiving unit receives only at least one first DCI, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, and the HARQ feedback information of the second PDSCH is related to the decoding result of the second PDSCH.
12. The apparatus according to supplement 10, wherein when the first receiving unit receives only at least one second DCI, the HARQ feedback information to which the PDSCH scheduled by the second DCI corresponds is related to the decoding result of the PDSCH scheduled by the second DCI, or, the HARQ feedback information to which the PDSCH scheduled by the second DCI corresponds is not related to the decoding result of the PDSCH scheduled by the second DCI.
13. The apparatus according to supplement 10, wherein when the first receiving unit receives only at least one third DCI, the HARQ feedback information to which the PDSCH scheduled by the third DCI corresponds is related to the decoding result of the PDSCH scheduled by the third DCI.
14. The apparatus according to supplement 10, wherein when the first receiving unit receives at least one first DCI and/or at least one second DCI and receives at least one third DCI, the HARQ feedback information to which the second PDSCH corresponds is not related to the decoding result of the second PDSCH, and the HARQ feedback information to which the first PDSCH corresponds is related to the decoding result of the first PDSCH, or, the HARQ feedback information to which the first PDSCH corresponds is related to the decoding result of the first PDSCH, and the HARQ feedback information to which the second PDSCH corresponds is related to the decoding result of the second PDSCH.
15. The apparatus according to supplement 10, wherein when the terminal equipment is configured or activated with SPS, an HARQ-ACK process to which a PDSCH of the SPS (SPS PDSCH) corresponds is HARQ feedback disabled and the first receiving unit receives only at least one first DCI or receives only at least one third DCI, or when the terminal equipment is configured or activated with SPS, an HARQ-ACK process to which the SPS PDSCH corresponds is HARQ feedback disabled and the first receiving unit receives at least one first DCI and/or receives at least one second DCI, and also receives at least one third DCI,
HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH, or,
HARQ feedback information to which the SPS PDSCH corresponds is not related to the decoding result of the SPS PDSCH, the HARQ feedback information of the first PDSCH is related to the decoding result of the first PDSCH, and the HARQ feedback information of the second PDSCH is related to the decoding result of the second PDSCH, or,
HARQ feedback information to which the SPS PDSCH corresponds is related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH.
16. The apparatus according to supplement 10, wherein when the terminal equipment is configured or activated with SPS, an HARQ-ACK process to which a PDSCH of the SPS (SPS PDSCH) corresponds is HARQ feedback disabled and the first receiving unit receives only at least one first DCI,
HARQ feedback information to which the SPS PDSCH corresponds is related to the decoding result of the SPS PDSCH, and HARQ feedback information to which the PDSCH scheduled by the second DCI corresponds is related to the decoding result of the PDSCH scheduled by the second DCI, or, HARQ feedback information to which the SPS PDSCH corresponds is not related to the decoding result of the SPS PDSCH, and HARQ feedback information to which the PDSCH scheduled by the second DCI corresponds is not related to the decoding result of the second PDSCH.
17. The apparatus according to supplement 10, wherein when the terminal equipment is configured or activated with SPS, an HARQ-ACK process to which a PDSCH of the SPS (SPS PDSCH) corresponds is HARQ feedback enabled and the first receiving unit receives only at least one first DCI or receives only at least one second DCI or receives only at least one third DCI, or when the terminal equipment is configured or activated with SPS, an HARQ-ACK process to which the SPS PDSCH corresponds is HARQ feedback enabled and the first receiving unit receives at least one first DCI and/or receives at least one second DCI, and also receives at least one third DCI,
the HARQ feedback information to which the SPS PDSCH corresponds is not related to the decoding result of the SPS PDSCH, the HARQ feedback information to which the second PDSCH corresponds is not related to the decoding result of the second PDSCH, and the HARQ feedback information of the first PDSCH is related to the decoding result of the first PDSCH, or, the HARQ feedback information of the first PDSCH is related to the decoding result of the first PDSCH, the HARQ feedback information of the second PDSCH is related to the decoding result of the second PDSCH, and the HARQ feedback information to which the SPS PDSCH corresponds is related to the decoding result of the SPS PDSCH.
18. The apparatus according to any one of supplements 11-17, wherein, when the first receiving unit does not receive other DCI corresponding to the time domain position within a predetermined period of time before a time domain position corresponding to HARQ feedback timing to which the DCI corresponds, it is indicated that the terminal equipment only receives the DCI.
19. An information feedback apparatus, applicable to a terminal equipment, characterized in that the apparatus includes:
a second receiving unit configured to receive fourth downlink control information (DCI), the fourth DCI including counter DAI information and/or total DAI information; and
a first determining unit configured to determine HARQ feedback information according to the counter DAI information and/or the total DAI information.
20. The apparatus according to supplement 19, wherein the counter DAI information and/or the total DAI information is/are counted for DCI used for scheduling a PDSCH by taking DCI as a granularity and/or a PDSCH as a granularity.
21. The apparatus according to supplement 19 or 20, wherein, for the DCI used to schedule one or a plurality of PDSCH, the counter DAI information and/or the total DAI information only count(s) DCI scheduling PDSCHs containing at least one PDSCH with a corresponding HARQ process that is feedback enabled.
22. The apparatus according to any one of supplements 19-21, wherein the counter DAI information and/or the total DAI information do/does not count DCI scheduling PDSCHs only containing PDSCH with corresponding HARQ process that is feedback disabled.
23. The apparatus according to any one of supplements 19-21, wherein the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.
24. The apparatus according to supplement 23, wherein HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.
25. The apparatus according to supplement 24, wherein that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.
26. The apparatus according to supplement 19 or 20, wherein the counter DAI information and/or the total DAI information for the PDSCH scheduled by DCI only counts PDSCHs with a corresponding HARQ process that is feedback enabled.
27. The apparatus according to supplement 19 or 20 or 26, wherein the counter DAI information and/or the total DAI information do/does not count PDSCHs with a corresponding HARQ process that is feedback disabled.
28. The apparatus according to supplement 26 or 27, wherein HARQ feedback information to which a first PDSCH with an HARQ process to the PDSCH scheduled by the fourth DCI corresponds that is feedback disabled corresponds is related to the decoding result of the first PDSCH.
29. The apparatus according to any one of supplements 19-28, wherein the apparatus further includes:
a second transmitting unit configured to transmit the HARQ feedback information at a time domain position to which the PDSCH corresponds for transmitting HARQ feedback information.
30. The apparatus according to supplement 29, wherein the apparatus further includes:
a second determining unit configured to determine the time domain position for transmitting the HARQ feedback information according to a time domain position where a last PDSCH scheduled by the DCI with a corresponding HARQ process that is HARQ feedback enabled is located.
31. The apparatus according to supplement 29 or 30, wherein the second determining unit determines the time domain position for transmitting the HARQ feedback information according to the time domain position where the last PDSCH scheduled by the DCI with the corresponding HARQ process that is HARQ feedback enabled is located and HARQ feedback timing.
32. The apparatus according to supplement 31, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
33. The apparatus according to supplement 31 or 32, wherein the fourth DCI includes a first information field, the first information field being used to indicate the HARQ feedback timing, or the apparatus further includes:
a third receiving unit configured to receive higher-layer signaling, the higher-layer signaling being used to indicate the HARQ feedback timing.
34. The apparatus according to any one of supplements 19-33, wherein the fourth DCI is used to schedule PDSCHs and/or PUSCHs.
35. The apparatus according to any one of supplements 19-34, wherein the fourth DCI is used to schedule PDSCHs, the PDSCHs scheduled by the DCI including PDSCHs with a corresponding HARQ process that is feedback enabled or feedback disabled.
36. The apparatus according to any one of supplements 19-33, wherein the fourth DCI does not schedule data transmission.
37. The apparatus according to supplement 35, wherein the fourth DCI schedules one or a plurality of PDSCHs, and a PDSCH time domain resource allocation table applied by the fourth DCI supports one DCI scheduling a plurality of PDSCHs.
38. An information feedback apparatus, applicable to a terminal equipment, characterized in that the apparatus includes:
a fourth receiving unit configured to receive DCI for scheduling PDSCHs;
a third determining unit configured to, according to the time domain position where the last PDSCH scheduled by the DCI with the corresponding HARQ process that is HARQ feedback enabled is located, determine the time domain position of the HARQ feedback information of the PDSCH scheduled by the DCI; and
a second transmitting unit configured to transmit the HARQ feedback information of the PDSCH scheduled by the DCI at the determined time domain position.
39. The apparatus according to supplement 38, wherein the third determining unit determines the time domain position of the HARQ feedback information of the PDSCH scheduled by the DCI according to the time domain position where the last PDSCH scheduled by the DCI with the corresponding HARQ process that is HARQ feedback enabled is located and HARQ feedback timing.
40. The apparatus according to supplement 39, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information of the PDSCH scheduled by the DCI.
41. The apparatus according to supplement 39 or 40, wherein the DCI includes a first information field, the first information field being used to indicate the HARQ feedback timing, or the apparatus further includes:
a fifth receiving unit configured to receive higher-layer signaling, the higher-layer signaling being used to indicate the HARQ feedback timing.
42. An information feedback apparatus, applicable to a terminal equipment, characterized in that the apparatus includes:
a sixth receiving unit configured to receive a PDSCH, an HARQ process to which the PDSCH corresponds is feedback disabled;
a processing unit configured not to transmit an HARQ feedback codebook at a time domain position for transmitting an HARQ feedback codebook to which the PDSCH corresponds.
43. The apparatus according to supplement 42, wherein the time domain position corresponds only to the PDSCH.
44. The apparatus according to supplement 43, wherein that the time domain position corresponds only to the PDSCH includes: there existing no other downlink transmission corresponding to the time domain position before a predetermined time of the time domain position.
45. The apparatus according to supplement 42, wherein the processing unit determines that the time domain position corresponds only to the PDSCH according to C-DAI and/or T-DAI in the DCI, and/or determines that the time domain position corresponds only to the PDSCH according to SPS configuration and/or an active state.
46. The apparatus according to supplement 42 or 45, wherein the processing unit determines not to transmit the HARQ feedback codebook at the time domain position for transmitting an HARQ feedback codebook to which the PDSCH corresponds according to the C-DAI and/or T-DAI in the DCI, and/or determines not to transmit the HARQ feedback codebook at the time domain position for transmitting an HARQ feedback codebook to which the PDSCH corresponds according to SPS configuration and/or an active state.
47. The apparatus according to any one of supplements 42-46, wherein the processing unit does not generate an HARQ feedback codebook to which the PDSCH corresponds.
48. The apparatus according to any one of supplements 42-47, wherein the PDSCH includes a PDSCH scheduled by the DCI and/or an SPS PDSCH.
49. The apparatus according to any one of supplements 42-48, wherein the apparatus further includes:
a plurality of PDSCHs in the PDSCH are scheduled by the same DCI.
50. An information reception apparatus, applicable to a network device, characterized in that the apparatus includes:
a third transmitting configured to transmit at least one downlink control information (DCI) for scheduling a physical downlink shared channel (PDSCH) to a terminal equipment, the DCI scheduling one or a plurality of PDSCHs, wherein the one or the plurality of PDSCHs include at least one PDSCH with a corresponding HARQ process that is feedback enabled or feedback disabled; and
a seventh receiving unit configured to receive HARQ feedback information for one or a plurality of PDSCHs transmitted by the terminal equipment.
51. The apparatus according to supplement 50, wherein when the PDSCH scheduled by the DCI includes a second PDSCH with an HARQ process that is feedback disabled, HARQ feedback information to which the second PDSCH corresponds is not related to a decoding result of the second PDSCH, or HARQ feedback information to which the second PDSCH corresponds is related to a decoding result of the second PDSCH.
52. The apparatus according to supplement 51, wherein that HARQ feedback information to which the second PDSCH corresponds is not related to a decoding result of the second PDSCH includes that the HARQ feedback information to which the second PDSCH corresponds is NACK.
53. The apparatus according to supplement 50, wherein when the PDSCH scheduled by the DCI includes a first PDSCH with a corresponding HARQ process that is feedback enabled, HARQ feedback information to which the first PDSCH corresponds is related to a decoding result of the first PDSCH.
54. The apparatus according to any one of supplements 50-53, wherein when the terminal equipment is further configured or activated with SPS and an HARQ process to which a PDSCH of the SPS (SPS PDSCH) corresponds is HARQ feedback disabled, a mode of determining the HARQ feedback information to which the SPS PDSCH corresponds is identical to or different from a mode of determining the HARQ feedback information to which the second PDSCH corresponds.
55. The apparatus according to supplement 54, wherein that a mode of determining the HARQ feedback information to which the SPS PDSCH corresponds is identical to a mode of determining the HARQ feedback information to which the second PDSCH corresponds includes that the HARQ feedback information to which the SPS PDSCH corresponds is not related to a decoding result of the SPS PDSCH and the HARQ feedback information to which the second PDSCH corresponds is not related to the decoding result of the second PDSCH, or that the HARQ feedback information to which the SPS PDSCH corresponds is related to the decoding result of the SPS PDSCH and the HARQ feedback information to which the second PDSCH corresponds is related to the decoding result of the second PDSCH.
56. The apparatus according to supplement 54, wherein that a mode of determining the SPS PDSCH is different from a mode of determining the HARQ feedback information to which the second PDSCH corresponds includes that the HARQ feedback information to which the SPS PDSCH corresponds is related to a decoding result of the SPS PDSCH and the HARQ feedback information to which the second PDSCH corresponds is not related to the decoding result of the second PDSCH, or that the HARQ feedback information to which the SPS PDSCH corresponds is not related to the decoding result of the SPS PDSCH and the HARQ feedback information to which the second PDSCH corresponds is related to the decoding result of the second PDSCH.
57. The apparatus according to any one of supplements 49-56, wherein the seventh receiving unit receives the HARQ feedback information at a time domain position for transmitting HARQ feedback information to which the one or the plurality of PDSCHs correspond.
58. The apparatus according to any one of supplements 50-57, wherein feedback time domain positions of HARQ feedback information to which PDSCHs scheduled by at least two DCI correspond are identical, or a feedback time domain position of HARQ feedback information to which a PDSCH scheduled by at least one DCI corresponds and a feedback time domain position of HARQ feedback information to which the SPS PDSCH corresponds are identical.
59. The apparatus according to any one of supplements 51-58, wherein the first PDSCH and/or the second PDSCH is/are practically transmitted PDSCH(s), and/or the first PDSCH and/or the second PDSCH has/have corresponding HARQ process(es).
60. An information reception apparatus, applicable to a network device, characterized in that the apparatus includes:
a fourth transmitting unit configured to transmit fourth DCI to a terminal equipment, the fourth DCI including counter DAI information and/or total DAI information; and
an eighth receiving unit configured to receive HARQ feedback information determined according to the counter DAI information and/or the total DAI information transmitted by the terminal equipment.
61. The apparatus according to supplement 60, wherein the counter DAI information and/or the total DAI information is/are counted for DCI used for scheduling a PDSCH by taking DCI as a granularity and/or a PDSCH as a granularity.
62. The apparatus according to supplement 60 or 61, wherein, for the DCI used to schedule one or a plurality of PDSCH, the counter DAI information and/or the total DAI information only count(s) DCI scheduling PDSCHs containing at least one PDSCH with a corresponding HARQ process that is feedback enabled.
63. The apparatus according to any one of supplements 60-62, wherein the counter DAI information and/or the total DAI information do/does not count DCI scheduling PDSCHs only containing PDSCH with corresponding HARQ process that is feedback disabled.
64. The apparatus according to any one of supplements 60-62, wherein the PDSCH scheduled by the fourth DCI includes a fourth PDSCH with a corresponding HARQ process that is feedback enabled and a second PDSCH with a corresponding HARQ process that is feedback disabled, and the counter DAI information and/or the total DAI information count(s) the fourth DCI.
65. The apparatus according to supplement 64, wherein HARQ feedback information to which the fourth PDSCH with an HARQ process to the PDSCH scheduled by the fourth DCI corresponds that is feedback enabled corresponds is related to a decoding result of the fourth PDSCH, and HARQ feedback information to which the second PDSCH with an HARQ process to the PDSCH scheduled by the fourth DCI corresponds that is feedback disabled corresponds is related to or is not related to the decoding result of the second PDSCH.
66. The apparatus according to supplement 65, wherein that HARQ feedback information to which the second PDSCH with an HARQ process to the PDSCH scheduled by the fourth DCI corresponds that is feedback disabled corresponds is not related to the decoding result of the second PDSCH includes that the HARQ feedback information to which the second PDSCH with an HARQ process to the PDSCH scheduled by the fourth DCI corresponds that is feedback disabled corresponds is NACK.
67. The apparatus according to supplement 60 or 61, wherein the counter DAI information and/or the total DAI information for the PDSCH scheduled by DCI only count(s) PDSCHs with a corresponding HARQ process that is feedback enabled.
68. The apparatus according to supplement 60 or 61 or 67, wherein the counter DAI information and/or the total DAI information do/does not count PDSCHs with a corresponding HARQ process that is feedback disabled.
69. The apparatus according to supplement 67 or 68, wherein HARQ feedback information to which a first PDSCH with an HARQ process to the PDSCH scheduled by the fourth DCI corresponds that is feedback disabled corresponds is related to the decoding result of the first PDSCH.
70. The apparatus according to any one of supplements 60-69, wherein the eighth receiving unit receives the HARQ feedback information at a time domain position for transmitting HARQ feedback information to which the PDSCH corresponds.
71. The apparatus according to supplement 60, wherein the time domain position for transmitting the HARQ feedback information is determined according to the time domain position where the last PDSCH scheduled by the DCI with the corresponding HARQ process that is HARQ feedback enabled is located and HARQ feedback timing.
72. The apparatus according to supplement 60 or 71, wherein the time domain position for transmitting the HARQ feedback information is determined according to the time domain position where the last PDSCH scheduled by the DCI with the corresponding HARQ process that is HARQ feedback enabled is located and HARQ feedback timing.
73. The apparatus according to supplement 72, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
74. The apparatus according to supplement 72 or 73, wherein the fourth DCI includes a first information field, the first information field being used to indicate the HARQ feedback timing, or the apparatus further includes:
a fifth transmitting unit configured to transmit higher-layer signaling to the terminal equipment, the higher-layer signaling being used to indicate the HARQ feedback timing.
75. The apparatus according to any one of supplements 60-74, wherein the fourth DCI is used to schedule PDSCHs and/or PUSCHs.
76. The apparatus according to any one of supplements 60-75, wherein the fourth DCI is used to schedule PDSCHs, the PDSCHs scheduled by the DCI including PDSCHs with a corresponding HARQ process that is feedback enabled or feedback disabled.
77. The apparatus according to any one of supplements 60-74, wherein the fourth DCI does not schedule data transmission.
78. The apparatus according to supplement 76, wherein the fourth DCI schedules one or a plurality of PDSCHs, and a PDSCH time domain resource allocation table applied by the fourth DCI supports one DCI scheduling a plurality of PDSCHs.
79. An information reception apparatus, applicable to a network device, characterized in that the apparatus includes:
a sixth transmitting unit configured to transmit DCI for scheduling PDSCH; and
a seventh transmitting unit configured to, at a time domain position for transmitting the HARQ feedback information of the PDSCH scheduled by the DCI, receive HARQ feedback information of the PDSCH scheduled by the DCI transmitted by the terminal equipment, the time domain position being determined according to a time domain position where a last PDSCH scheduled by the DCI with a corresponding HARQ process that is HARQ feedback enabled is located.
80. The apparatus according to supplement 79, wherein the time domain position for transmitting the HARQ feedback information is determined according to the time domain position where the last PDSCH scheduled by the DCI with the corresponding HARQ process that is HARQ feedback enabled is located and HARQ feedback timing.
81. The apparatus according to supplement 79, wherein the HARQ feedback timing indicates a time domain offset between the time domain position where the last PDSCH scheduled by the DCI with the corresponding HARQ process that is HARQ feedback enabled is located and the time domain position for transmitting the HARQ feedback information.
82. The apparatus according to supplement 79 or 80, wherein the DCI includes a first information field, the first information field being used to indicate the HARQ feedback timing, or the apparatus further includes:
an eighth transmitting unit configured to transmit higher-layer signaling, the higher-layer signaling being used to indicate the HARQ feedback timing.
83. An information feedback method, applicable to terminal equipment, characterized in that the method includes:
receiving DCI scheduling PDSCHs by the terminal equipment;
receiving the PDSCHs by the terminal equipment; and
determining by the terminal equipment according to a C-DAI and/or a T-DAI in the DCI that it is needed to transmit an HARQ feedback codebook at a time domain position for transmitting HARQ feedback codebooks to which the PDSCHs correspond.
84. An information feedback apparatus, applicable to terminal equipment, characterized in that the apparatus includes:
a receiving unit configured to receive DCI scheduling PDSCHs and receive the PDSCHs; and
a determining unit configured to, according to a C-DAI and/or a T-DAI in the DCI, determine that it is needed to transmit an HARQ feedback codebook at a time domain position for transmitting HARQ feedback codebooks to which the PDSCHs correspond.

What is claimed is:

1. An information feedback apparatus, applicable to a terminal equipment, characterized in that the apparatus comprises:
a receiver configured to receive at least one downlink control information (DCI) used for scheduling a physical downlink shared channel (PDSCH), the at least one DCI scheduling one or a plurality of PDSCHs; and
a transmitter configured to transmit HARQ-ACK information for at least one PDSCH corresponding to a HARQ process with enabled HARQ feedback in the one or the plurality of PDSCHs.

2. The apparatus according to claim 1, wherein a DCI in the at least one DCI schedules one PDSCH or a plurality of PDSCHs.

3. The apparatus according to claim 1, wherein the HARQ-ACK information for the at least one PDSCH is related to a decoding outcome for transport block(s) of the at least one PDSCH.

4. The apparatus according to claim 1, wherein
the receiver is further configured to receive an indication information used for indicating HARQ feedback enabling and/or disabling in RRC signaling and/or DCI.

5. The apparatus according to claim 4, wherein the indication information in RRC signaling includes a bitmap, a bit in the bitmap corresponding to a HARQ process (ID) and bit(s) set to one identifying HARQ process(es) with disabled HARQ feedback and bit(s) set to zero identifying HARQ process(es) with enabled HARQ feedback.

6. The apparatus according to claim 5, wherein HARQ processes corresponding to the bitmap includes all configured HARQ processes of a cell.

7. The apparatus according to claim 4, further comprising
a processor configured to determine HARQ feedback enabling and/or disabling for PDSCH(s) scheduled by a DCI according to the indication information in RRC signaling and the indication information in the DCI.

8. The apparatus according to claim 1, wherein the HARQ-ACK information for the at least one PDSCH are multiplexed in a Type-1 HARQ-ACK codebook and the transmitter reports a NACK value for a HARQ-ACK information bit corresponding to a transport block of a PDSCH corresponding to a HARQ process with disabled HARQ feedback in the Type-1 HARQ-ACK codebook.

9. The apparatus according to claim 8, wherein, the PDSCH corresponding to a HARQ process with disabled HARQ feedback includes a PDSCH scheduled by a DCI or a SPS PDSCH.

10. The apparatus according to claim 1, wherein the HARQ-ACK information for the at least one PDSCH are multiplexed in a Type-2 HARQ-ACK codebook determined according to counter DAI and/or total DAI in a DCI.

11. The apparatus according to claim 10, wherein the DCI which carries the counter DAI and/or the total DAI schedules a PDSCH corresponding to a HARQ process with enabled HARQ feedback and/or a PDSCH corresponding to a HARQ process with disabled HARQ feedback, or schedules a PUSCH, or does not schedule PDSCH or PUSCH.

12. The apparatus according to claim 10, wherein the counter DAI and/or the total DAI do/does not count DCI scheduling PDSCH(s) only containing PDSCH(s) corresponding to HARQ process(es) with disabled HARQ feedback, or do/does not count PDSCH(s) corresponding to a HARQ process with disabled HARQ feedback.

13. The apparatus according to claim 1, wherein the transmitter does not provide an HARQ-ACK codebook when only PDSCH(s) associated with HARQ processes with disabled HARQ feedback is/are scheduled.

14. An information reception apparatus, applicable to a network device, characterized in that the apparatus includes:
a transmitter configured to transmit at least one downlink control information (DCI) used for scheduling physical downlink shared channel (PDSCH), the at least one DCI scheduling one or a plurality of PDSCHs; and
a receiver configured to receive HARQ-ACK information for at least one PDSCH corresponding to a HARQ process with enabled HARQ feedback in the one or the plurality of PDSCHs.

15. The apparatus according to claim 14, wherein the HARQ-ACK information for the at least one PDSCH is related to a decoding outcome for transport block(s) of the at least one PDSCH.

16. The apparatus according to claim 14, wherein
the transmitter is further configured to transmit an indication information used for indicating HARQ feedback enabling and/or disabling in RRC signaling and/or DCI.

17. The apparatus according to claim 16, wherein the indication information in RRC signaling includes a bitmap, a bit in the bitmap corresponding to a HARQ process (ID) and bit(s) set to one identifying HARQ process(es) with disabled HARQ feedback and bit(s) set to zero identifying HARQ process(es) with enabled HARQ feedback.

18. The apparatus according to claim 16, wherein HARQ feedback enabling and/or disabling for PDSCH(s) scheduled by a DCI being determined by the indication information in RRC signaling and the indication information in the DCI.

19. The apparatus according to claim 17, wherein HARQ processes corresponding to the bitmap includes all configured HARQ processes of a cell.

20. A communication system comprising:
a network device configured to transmit at least one downlink control information (DCI) used for scheduling physical downlink shared channel (PDSCH) transmitted by the network device, the at least one DCI scheduling one or a plurality of PDSCHs;
a terminal equipment configured to:
receive the at least one DCI, and
transmit HARQ-ACK information for at least one PDSCH corresponding to a HARQ process with enabled HARQ feedback in the one or the plurality of PDSCHs to the network device.
